(19) United States
(12) Patent Application Publication
(10) Pub. No.: US 2015/0304678 A1
(43) Pub. Date: Oct. 22, 2015

(54) IMAGE PROCESSING DEVICE AND METHOD

(71) Applicant: SONY CORPORATION, Minato-ku, Tokyo (JP)

(72) Inventor: KAZUSHI SATO, Kanagawa (JP)

(73) Assignee: SONY CORPORATION, TOKYO (JP)

(21) Appl. No.: 14/648,350

(22) PCT Filed: Dec. 16, 2013
(86) PCT No.: PCT/JP2013/083598

§ 371 Date: May 29, 2015

(30) Foreign Application Priority Data
Dec. 26, 2012 (JP) 2012-283613

(51) Int. Cl. H04N 19/513; H04N 19/187; H04N 19/44; H04N 19/176

(52) U.S. Cl. CPC H04N 19/513; H04N 19/176; H04N 19/187; H04N 19/44

(57) ABSTRACT

Provided is an image processing device including a receiving section configured to receive hierarchical image encoded data in which image data that is hierarchized into a plurality of layers is encoded and motion information encoded data in which motion information used in encoding of the image data is encoded, a motion information decoding section configured to decode, when motion information of a peripheral block in a same layer as a current block is unavailable, the motion information encoded data received by the receiving section using motion information of a peripheral block in a different layer from the current block, and a decoding section configured to decode the hierarchical image encoded data received by the receiving section using motion information obtained by the motion information decoding section decoding the motion information encoded data.

### TECHNICAL FIELD

The present disclosure relates to an image processing device and method, and particularly relates to an image processing device and method which can suppress a decrease in encoding efficiency.

### BACKGROUND ART

Recently, devices for compressing and encoding an image by adopting a encoding scheme of handling image information digitally and performing compression by an orthogonal transform such as a discrete cosine transform and motion compensation using image information-specific redundancy for the purpose of information transmission and accumulation with high efficiency when the image information is handled digitally have become widespread. Moving Picture Experts Group (MPEG) and the like are examples of such encoding schemes.

Particularly, MPEG-2 (ISO/IEC 13818-2) is a standard which is defined as a generic image encoding scheme, covering both of interlaced scanning images and non-interlaced scanning images, and standard resolution images and high definition images. For example, MPEG-2 is used in a wide range of applications for professionals and consumers at present. When the MPEG-2 compression scheme is used, for example, a coding amount (bit rate) of 4 to 8 Mbps is allocated to an interlaced scanning image with standard resolution of 720×480 pixels. In addition, when the MPEG-2 compression scheme is used, for example, a coding amount (bit rate) of 18 to 22 Mbps is allocated to an interlaced scanning image with high resolution of 1920×1088 pixels. Accordingly, a high compression rate and satisfactory image quality can be realized.

MPEG-2 targeted coding for high image quality which is mostly appropriate for broadcasting; however, it had a lower coding amount (bit rate) than MPEG-1, i.e., failed to respond to an encoding scheme of a higher compression rate. With the spread of mobile terminals, needs for such encoding schemes were expected to increase from then on, and therefore standardization of an MPEG-4 encoding scheme was performed. With respect to an image encoding scheme, the standard was approved as an international standard of ISO/IEC 14496-2 in December 1998.

Furthermore, initially, for the purpose of image encoding for television conferences, standardization of H.26L (International Telecommunication Union Telecommunication Standardization Sector (ITU-T) Q6/16 Video Coding Expert Group (VCEG)) was performed a few years ago. It is known that, while H.26L requires a larger amount of arithmetic operations in encoding and decoding than in existing encoding schemes such as MPEG-2 or MPEG-4, it realizes higher encoding efficiency. In addition, as a part of activities of the present MPEG-4, on the basis of H.26L, the standardization for realizing higher encoding efficiency also with adaptation of functions that are not supported in H.26L has been performed as Joint Model of Enhanced-Compression Video Coding.

According to the schedule of the standardization, it became an international standard in the name of H.264 and MPEG-4 Part 10 (Advanced Video Coding; hereinafter denoted as AVC) in March 2003.

Furthermore, as an extension of H.264/AVC, the standardization of Fidelity Range Extensions (FRExt), which include encoding tools with profiles of RGB, 4:2:2, and 4:4:4 that are necessary for professional works, 8×8 DCT prescribed in the MPEG-2, and quantization matrixes, was completed in February 2005. Accordingly, it had become an encoding scheme in which even film noise included in a video can be favorably expressed using H.264/AVC, and thus was used in a wide range of applications such as Blu-ray (a registered trademark) discs.

In recent years, however, needs for even higher compression rate encoding such as a desire to compress an image with about 4000×2000 pixels which is four times as many as a high-vision image, or a desire to distribute a high-vision image in an environment with a limited transmission capacity such as the Internet have been increasing. To this end, in the VCEG under the ITU-T described above, discussion of enhancement in encoding efficiency has continued.

Therefore, for the purpose of improving encoding efficiency compared to AVC, standardization of a encoding scheme referred to as high efficiency video coding (HEVC) by Joint Collaboration Team-Video Coding (JCTVC), which is a joint standardizing organization of International Telecommunication Union Telecommunication Standardization Sector (ITU-T) and International Organization for Standardization (ISO)/International Electrotechnical Commission (IEC), is currently in progress. With regard to the HEVC standard, a committee draft, the first draft specification, has been issued in February, 2012 (for example, refer to Non-Patent Literature 1).

Meanwhile, the existing image encoding schemes such as MPEG-2 and AVC have a scalability function of dividing an image into a plurality of layers and encoding the plurality of layers.

In other words, for example, for a terminal having a low processing capability such as a mobile phone, image compression information of only a base layer is transmitted, and a moving image of low spatial and temporal resolutions or a low quality is reproduced, and for a terminal having a high processing capability such as a television or a personal computer, image compression information of an enhancement layer as well as a base layer is transmitted, and a moving image of high spatial and temporal resolutions or a high quality is reproduced. That is, image compression information according to a capability of a terminal or a network can be transmitted from a server without performing the transcoding process.

In HEVC, however, two motion vector information encoding schemes of advanced motion vector prediction (AMVP) and merge are prescribed (for example, refer to Non-Patent Literature 2).

### CITATION LIST

### Non-Patent Literature

Non-Patent Literature 1: “High Efficiency Video Coding (HEVC) Text Specification Draft 9,” by Benjamin Bross, Woo-Jin Han, Jens-Rainer Ohm, Gary J. Sullivan, and Thomas Wiegand, JCTVC-H1003 v9, Joint Collaborative Team on Video Coding (JCT-VC) of ITU-T SG16 WP3 and ISO/IEC JTC1/SC29/WG11 11^{th} Meeting in Shanghai, CN, Oct. 10 to 19, 2012
Non-Patent Literature 2: “Parsing Robustness for Merge/AMVP,” by Toshiyasu Sugio and Takahiro Nishi, JCTVC-F470, Joint Collaborative Team on Video Coding (JCT-VC) of ITU-T SG16 WP3 and ISO/IEC JTC1/SC29/WG11 6^{th} Meeting in Torino, IT, Jul. 14 to 22, 2011

### SUMMARY OF INVENTION

### Technical Problem

In the methods of the past, however, when there are many pieces of temporal and spatial adjacent motion vector information which are unavailable in a current block which is a processing target (motion information of a peripheral block located in the periphery of the current block), there is concern of encoding efficiency decreasing.

The present disclosure takes the above circumstances into consideration, and aims to suppress a decrease in encoding efficiency.

### Solution to Problem

According to an aspect of the present technology, there is provided an image processing device including a receiving section configured to receive hierarchical image encoded data in which image data that is hierarchized into a plurality of layers is encoded and motion information encoded data in which motion information used in encoding of the image data is encoded, a motion information decoding section configured to decode, when motion information of a peripheral block in a same layer as a current block is unavailable, the motion information encoded data received by the receiving section using motion information of a peripheral block in a different layer from the current block, and a decoding section configured to decode the hierarchical image encoded data received by the receiving section using motion information obtained by the motion information decoding section decoding the motion information encoded data.

When the motion information of the peripheral block in the same layer as the current block is available, the motion information decoding section can reconstruct predictive motion information used in encoding of the motion information used in encoding of the image data using the motion information of the peripheral block, and decode the motion information encoded data using the reconstructed predictive motion information. When the motion information of the peripheral block in the same layer as the current block is unavailable, the motion information decoding section can reconstruct predictive motion information used in encoding of the motion information used in encoding of the image data using the motion information of the peripheral block in the different layer from the current block, and decode the motion information encoded data using the reconstructed predictive motion information.

The motion information decoding section can set available motion information of a peripheral block corresponding to the peripheral block in the different layer from the current block as a candidate for the predictive motion information, instead of the unavailable motion information of the peripheral block in the same layer as the current block in an advanced motion vector prediction (AMVP) mode.

The motion information decoding section can set available motion information, which is subject to a scaling process in a time axis direction, of the peripheral block corresponding to the peripheral block in the different layer from the current block as a candidate for the predictive motion information, instead of unavailable motion information, which is subject to the scaling process in the time axis direction, of the peripheral block in the same layer as the current block. The motion information decoding section can set available motion information, which is not subject to the scaling process in the time axis direction, of the peripheral block corresponding to the peripheral block in the different layer from the current block as a candidate for the predictive motion information, instead of unavailable motion information, which is not subject to the scaling process in the time axis direction, of the peripheral block in the same layer as the current block.

The motion information decoding section can perform a scaling process on the motion information of the peripheral block in the different layer from the current block in a space direction according to a resolution ratio between the layers.

The motion information decoding section can fill a missing number in a candidate list of the predictive motion information with available motion information of a peripheral block corresponding to the peripheral block in the different layer from the current block in a merge mode.

The receiving section can further receive control information for designating whether motion information of a block in the same layer as the current block is to be used in the candidate list and whether motion information of a block in the different layer from the current block is to be used in the candidate list.

When the motion information of the block in the same layer as the current block is used in the candidate list, the motion information decoding section can use the motion information of the block in the different layer from the current block to fill the missing number in the candidate list, based on the control information received by the receiving section. When the motion information of the block in the different layer from the current block is used in the candidate list, the motion information decoding section can use the motion information of the block in the same layer as the current block to fill the missing number in the candidate list, based on the control information received by the receiving section.

The motion information decoding section can fill the missing number in the candidate list with motion information of a block different from the peripheral block set as a co-located block in the different layer from the current block.

According to an aspect of the present technology, there is provided an image processing method including receiving hierarchical image encoded data in which image data that is hierarchized into a plurality of layers is encoded and motion information encoded data in which motion information used in encoding of the image data is encoded, decoding, when motion information of a peripheral block in a same layer as a current block is unavailable, the received motion information encoded data using motion information of a peripheral block in a different layer from the current block, and decoding the received hierarchical image encoded data using motion information obtained by decoding the motion information encoded data.

According to another aspect of the present technology, there is provided an image processing device including an encoding section configured to encode image data that is hierarchized into a plurality of layers using motion information, a motion information encoding section configured to encode, when motion information of a peripheral block in a same layer as a current block is unavailable, the motion information used by the encoding section in encoding of the image data using motion information of a peripheral block in a different layer from the current block, and a transmitting section configured to transmit hierarchical image encoded data obtained by the encoding section encoding the image data and motion information encoded data obtained by the motion information encoding section encoding the motion information.

When the motion information of the peripheral block in the same layer as the current block is available, the motion information encoding section can generate predictive motion information using the motion information of the peripheral block and encode the motion information using the generated predictive motion information. When the motion information of the peripheral block in the same layer as the current block is unavailable, the motion information encoding section can generate predictive motion information using the motion information of the peripheral block in the different layer from the current block and encode the motion information using the generated predictive motion information.

The motion information encoding section can set available motion information of a peripheral block corresponding to the peripheral block in the different layer from the current block as a candidate for the predictive motion information, instead of the unavailable motion information of the peripheral block in the same layer as the current block in an advanced motion vector prediction (AMVP) mode.

The motion information encoding section can set available motion information, which is subject to a scaling process in a time axis direction, of the peripheral block corresponding to the peripheral block in the different layer from the current block as a candidate for the predictive motion information, instead of unavailable motion information, which is subject to the scaling process in the time axis direction, of the peripheral block in the same layer as the current block. The motion information encoding section can set available motion information, which is not subject to the scaling process in the time axis direction, of the peripheral block corresponding to the peripheral block in the different layer from the current block as a candidate for the predictive motion information, instead of unavailable motion information, which is not subject to the scaling process in the time axis direction, of the peripheral block in the same layer as the current block.

The motion information encoding section can perform a scaling process on the motion information of the peripheral block in the different layer from the current block in a space direction according to a resolution ratio between the layers.

The motion information encoding section can fill a missing number in a candidate list of the predictive motion information with available motion information of a peripheral block corresponding to the peripheral block in the different layer from the current block in a merge mode.

The transmitting section can further transmit control information for designating whether motion information of a block in the same layer as the current block is to be used in the candidate list and whether motion information of a block in the different layer from the current block is to be used in the candidate list.

When the motion information of the block in the same layer as the current block is used in the candidate list, the motion information encoding section can use the motion information of the block in the different layer from the current block to fill the missing number in the candidate list. When the motion information of the block in the different layer from the current block is used in the candidate list, the motion information encoding section can use the motion information of the block in the same layer as the current block to fill the missing number in the candidate list.

The motion information encoding section can fill the missing number in the candidate list with motion information of a block different from the peripheral block set as a co-located block in the different layer from the current block.

According to another aspect of the present technology, there is provided an image processing method including encoding image data that is hierarchized into a plurality of layers using motion information, encoding, when motion information of a peripheral block in a same layer as a current block is unavailable, the motion information used in encoding of the image data using motion information of a peripheral block in a different layer from the current block, and transmitting hierarchical image encoded data obtained by encoding the image data and motion information encoded data obtained by encoding the motion information.

According to an aspect of the present technology, when hierarchical image encoded data obtained by encoding image data in which a plurality of pieces of hierarchized image data are encoded and motion information encoded data in which motion information used in encoding of the image data is encoded are received and motion information of a peripheral block in the same layer as a current block is unavailable, motion information of a peripheral block in a different layer from the current block is used to decode the received motion information encoded data, and motion information obtained by decoding the motion information encoded data is used to decode the received hierarchical image encoded data.

According to another aspect of the present technology, when image data which is hierarchized into a plurality of layers is encoded using motion information and motion information of a peripheral block in the same layer as a current layer is unavailable, motion information of a peripheral block in a different layer from the current block is used to encode the motion information used in encoding of the image data, and thus hierarchical image encoded data obtained by encoding the image data and motion information encoded data obtained by encoding the motion information are transmitted.

### Advantageous Effects of Invention

According to the present disclosure, images can be encoded and decoded. Particularly, a decrease in encoding efficiency can be suppressed.

### BRIEF DESCRIPTION OF DRAWINGS

FIG. 1 is a diagram for describing an example of a configuration of a coding unit.

FIG. 2 is a diagram for describing an example of spatial scalable video coding.

FIG. 3 is a diagram for describing an example of temporal scalable video coding.

FIG. 4 is a diagram for describing an example of scalable video coding of a signal to noise ratio.

FIG. 5 is a diagram for describing AMVP.

FIG. 6 is a diagram for describing merge.

FIG. 7 is a diagram for describing encoding of IDs on a candidate list.

FIG. 8 is a diagram for describing filling of a missing number list.

FIG. 9 is a diagram for describing a case of cropping.

FIG. 10 is a diagram for describing use of motion information of a base layer.

FIG. 11 is a diagram illustrating an example of syntax of a sequence parameter set.

FIG. 12 is a continuation of the diagram from FIG. 11 illustrating the example of syntax of the sequence parameter set.

FIG. 13 is a diagram illustrating an example of a slice header.

FIG. 14 is a continuation of the diagram from FIG. 13 illustrating the example of the slice header.

FIG. 15 is a continuation of the diagram from FIG. 14 illustrating the example of the slice header.

FIG. 16 is a block diagram illustrating an example of a main configuration of a scalable encoding device.

FIG. 17 is a block diagram illustrating a main configuration example of a base layer image encoding section.

FIG. 18 is a block diagram illustrating an example of a main configuration of an enhancement layer image encoding section.

FIG. 19 is a block diagram illustrating a main configuration example of a motion information encoding section.

FIG. 20 is a flowchart for describing an example of a flow of an encoding process.

FIG. 21 is a flow chart describing an example of the flow of a base layer encoding process.

FIG. 22 is a flow chart describing an example of the flow of an enhancement layer encoding process.

FIG. 23 is a flow chart describing an example of the flow of a motion prediction and compensation process.

FIG. 24 is a flow chart describing an example of the flow of a motion information encoding process.

FIG. 25 is a flow chart describing an example of the flow of an AMVP process.

FIG. 26 is a flow chart describing an example of the flow of a spatial predictive motion information search process.

FIG. 27 is a continuation of the flow chart from FIG. 26 describing an example of the flow of the spatial predictive motion information search process.

FIG. 28 is a flow chart describing another example of the flow of the spatial predictive motion information search process.

FIG. 29 is a continuation of the flow chart from FIG. 28 describing another example of the flow of the spatial predictive motion information search process.

FIG. 30 is a flow chart describing an example of the flow of a temporal predictive motion information search process.

FIG. 31 is a flow chart describing an example of the flow of a merge process.

FIG. 32 is a flow chart describing an example of the flow of a base layer motion information selection process.

FIG. 33 is a flow chart describing an example of the flow of a layer control process.

FIG. 34 is a block diagram illustrating an example of a main configuration of a scalable decoding device.

FIG. 35 is a block diagram illustrating a main configuration example of a base layer image decoding section.

FIG. 36 is a block diagram illustrating an example of a main configuration of an enhancement layer image decoding section.

FIG. 37 is a block diagram illustrating a main configuration example of a motion information decoding section.

FIG. 38 is a flow chart describing an example of the flow of a decoding process.

FIG. 39 is a flow chart describing an example of the flow of a base layer decoding process.

FIG. 40 is a flow chart describing an example of the flow of an enhancement layer decoding process.

FIG. 41 is a flow chart describing an example of the flow of a prediction process.

FIG. 42 is a flow chart describing an example of the flow of a motion information decoding process.

FIG. 43 is a diagram illustrating an example of a hierarchical image encoding scheme.

FIG. 44 is a diagram illustrating an example of a multi-view image encoding scheme.

FIG. 45 is a block diagram illustrating an example of a main configuration of a computer.

FIG. 46 is a block diagram illustrating an example of a schematic configuration of a television device.

FIG. 47 is a block diagram illustrating an example of a schematic configuration of a mobile phone.

FIG. 48 is a block diagram illustrating an example of a schematic configuration of a recording/reproduction device.

FIG. 49 is a block diagram illustrating an example of a schematic configuration of an image capturing device.

FIG. 50 is a block diagram illustrating an example of using scalable video coding.

FIG. 51 is a block diagram illustrating another example of using scalable video coding.

FIG. 52 is a block diagram illustrating another example of using scalable video coding.

### DESCRIPTION OF EMBODIMENTS

Hereinafter, modes (hereinafter referred to as “embodiments”) for carrying out the present disclosure will be described. The description will proceed in the following order:

0. Overview

1. First embodiment (image encoding device)

2. Second embodiment (image decoding device)

3. Other

4. Third embodiment (computer)

5. Applications

6. Applications of scalable video coding

### 0. Overview

<Encoding Scheme>

Hereinafter, the present technology will be described in connection with an application to image encoding and decoding of a High Efficiency Video Coding (HEVC) scheme.

<Coding Unit>

In an Advanced Video Coding (AVC) scheme, a hierarchical structure based on a macroblock and a sub macroblock is defined. However, a macroblock of 16×16 pixels is not optimal for a large image frame such as a Ultra High Definition (UHD) (4000×2000 pixels) serving as a target of a next generation encoding scheme.

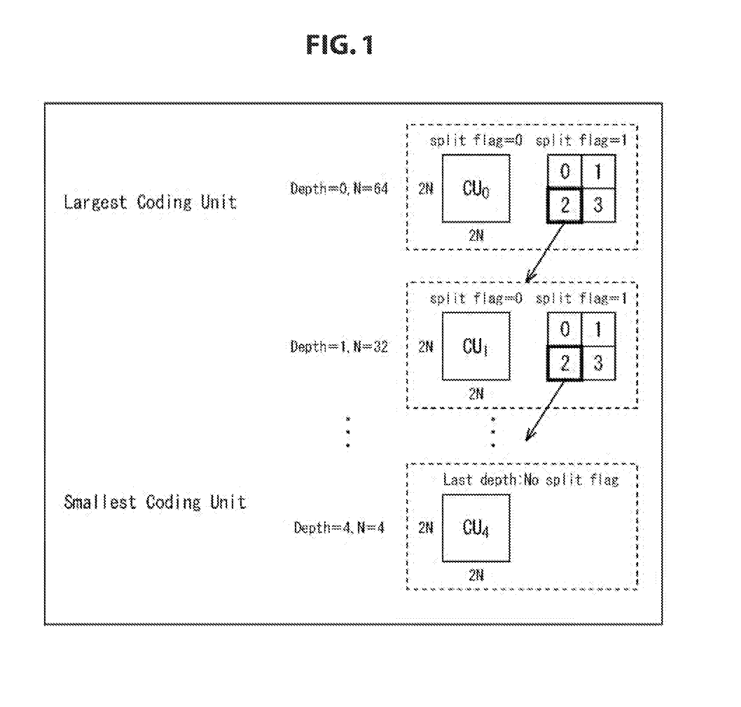

On the other hand, in the HEVC scheme, a coding unit (CU) is defined as illustrated in FIG. 1.

A CU is also referred to as a coding tree block (CTB), and serves as a partial area of an image of a picture unit undertaking the same role of a macroblock in the AVC scheme. The latter is fixed to a size of 16×16 pixels, but the former is not fixed to a certain size but designated in image compression information in each sequence.

For example, a largest coding unit (LCU) and a smallest coding unit (SCU) of a CU are specified in a sequence parameter set (SPS) included in encoded data to be output.

As split-flag=1 is set in a range in which each LCU is not smaller than an SCU, a coding unit can be divided into CUs having a smaller size. In the example of FIG. 1, a size of an LCU is 128, and a largest scalable depth is 5. A CU of a size of 2N×2N is divided into CUs having a size of N×N serving as a layer that is one-level lower when a value of split_flag is 1.

Further, a CU is divided in prediction units (PUs) that are areas (partial areas of an image of a picture unit) serving as processing units of intra or inter prediction, and divided into transform units (TUs) that are areas (partial areas of an image of a picture unit) serving as processing units of orthogonal transform. Currently, in the HEVC scheme, in addition to 4×4 and 8×8, orthogonal transform of 16×16 and 32×32 can be used.

As in the HEVC scheme, in the case of an encoding scheme in which a CU is defined and various kinds of processes are performed in units of CUs, in the AVC scheme, a macroblock can be considered to correspond to an LCU, and a block (sub block) can be considered to correspond to a CU. Further, in the AVC scheme, a motion compensation block can be considered to correspond to a PU. Here, since a CU has a hierarchical structure, a size of an LCU of a topmost layer is commonly set to be larger than a macroblock in the AVC scheme, for example, such as 128×128 pixels.

Thus, hereinafter, an LCU is assumed to include a macroblock in the AVC scheme, and a CU is assumed to include a block (sub block) in the AVC scheme. In other words, a “block” used in the following description indicates an arbitrary partial area in a picture, and, for example, a size, a shape, and characteristics thereof are not limited. In other words, a “block” includes an arbitrary area (a processing unit) such as a TU, a PU, an SCU, a CU, an LCU, a sub block, a macroblock, or a slice. Of course, a “block” includes other partial areas (processing units) as well. When it is necessary to limit a size, a processing unit, or the like, it will be appropriately described.

<Mode Selection>

Meanwhile, in the AVC and HEVC encoding schemes, in order to achieve high encoding efficiency, it is important to select an appropriate prediction mode.

As an example of such a selection method, there is a method implemented in reference software (found at http://iphome.hhi.de/suehring/tml/index.htm) of H.264/MPEG-4 AVC called a joint model (JM).

In the JM, as will be described later, it is possible to select two mode determination methods, that is, a high complexity mode and a low complexity mode. In both modes, cost function values related to respective prediction modes are calculated, and a prediction mode having a smaller cost function value is selected as an optimal mode for a corresponding block or macroblock.

A cost function in the high complexity mode is represented as in the following Formula (1):

Cost(ModeεΩ)=D+λ*R (1)

Here, Ω indicates a universal set of candidate modes for encoding a corresponding block or macroblock, and D indicates differential energy between a decoded image and an input image when encoding is performed in a corresponding prediction mode. λ indicates Lagrange's undetermined multiplier given as a function of a quantization parameter. R indicates a total coding amount including an orthogonal transform coefficient when encoding is performed in a corresponding mode.

In other words, in order to perform encoding in the high complexity mode, it is necessary to perform a temporary encoding process once by all candidate modes in order to calculate the parameters D and R, and thus a large computation amount is required.

A cost function in the low complexity mode is represented by the following Formula (2):

Cost(ModeεΩ)=D+QP2Quant(QP)*HeaderBit (2)

Here, D is different from that of the high complexity mode and indicates differential energy between a prediction image and an input image. QP2Quant(QP) is given as a function of a quantization parameter QP, and HeaderBit indicates a coding amount related to information belonging to a header such as a motion vector or a mode including no orthogonal transform coefficient.

In other words, in the low complexity mode, it is necessary to perform a prediction process for respective candidate modes, but since a decoded image is not necessary, it is unnecessary to perform an encoding process. Thus, it is possible to implement a computation amount smaller than that in the high complexity mode.

<Scalable Video Coding>

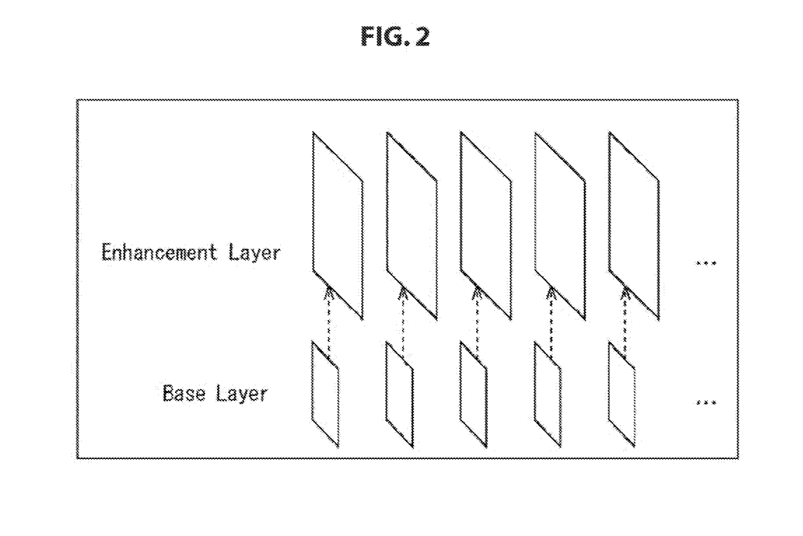

Meanwhile, the existing image encoding schemes such as MPEG-2 and AVC have a scalability function as illustrated in FIGS. 2 to 4. Scalable video coding refers to a scheme of dividing (hierarchizing) an image into a plurality of layers and performing encoding for each layer.

In hierarchization of an image, one image is divided into a plurality of images (layers) based on a certain parameter. Basically, each layer is configured with differential data so that redundancy is reduced. For example, when one image is hierarchized into two layers, that is, a base layer and an enhancement layer, an image of a lower quality than an original image is obtained using only data of the base layer, and an original image (that is, a high-quality image) is obtained by combining data of the base layer with data of the enhancement layer.

As an image is hierarchized as described above, it is possible to obtain images of various qualities according to the situation. For example, for a terminal having a low processing capability such as a mobile phone, image compression information of only a base layer is transmitted, and a moving image of low spatial and temporal resolutions or a low quality is reproduced, and for a terminal having a high processing capability such as a television or a personal computer, image compression information of an enhancement layer as well as a base layer is transmitted, and a moving image of high spatial and temporal resolutions or a high quality is reproduced. In other words, image compression information according to a capability of a terminal or a network can be transmitted from a server without performing the transcoding process.

As a parameter having scalability, for example, there is spatial resolution (spatial scalability) as illustrated in FIG. 2. When the spatial scalability differs, respective layers have different resolutions. In other words, each picture is hierarchized into two layers, that is, a base layer of a resolution spatially lower than that of an original image and an enhancement layer that is combined with an image of the base layer to obtain an original image (an original spatial resolution) as illustrated in FIG. 2. Of course, the number of layers is an example, and each picture can be hierarchized into an arbitrary number of layers.

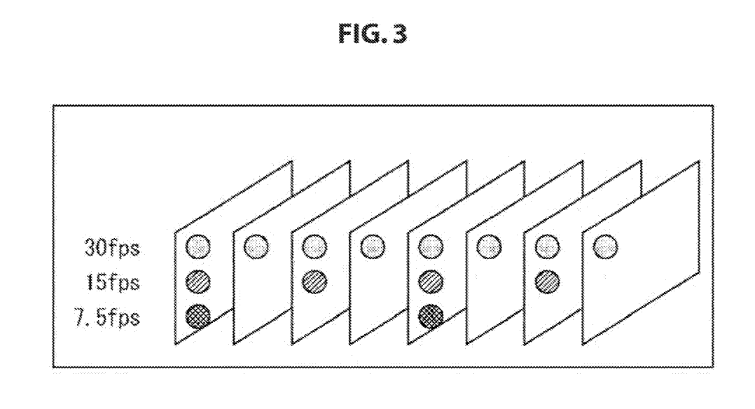

As another parameter having such scalability, for example, there is a temporal resolution (temporal scalability) as illustrated in FIG. 3. In the case of the temporal scalability, respective layers have different frame rates. In other words, in this case, each picture is hierarchized into layers having different frame rates, a moving image of a high frame rate can be obtained by combining a layer of a high frame rate with a layer of a low frame rate, and an original moving image (an original frame rate) can be obtained by combining all the layers as illustrated in FIG. 3. The number of layers is an example, and each picture can be hierarchized into an arbitrary number of layers.

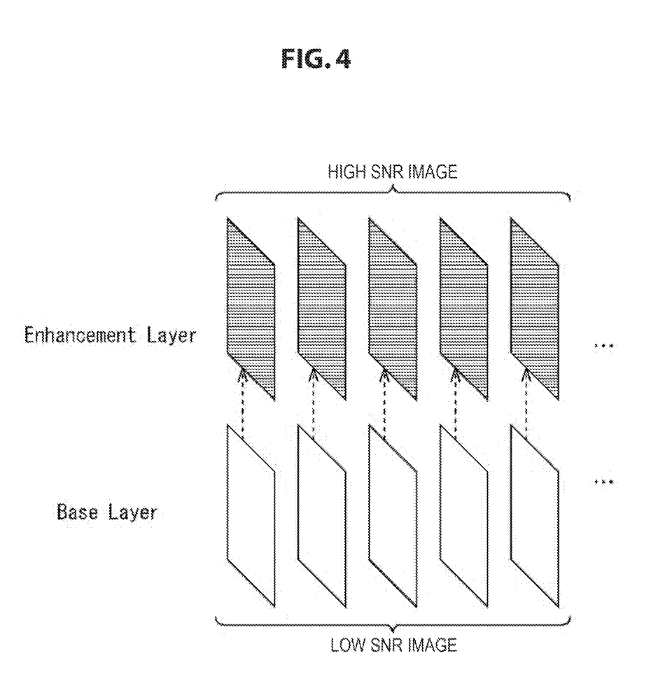

Further, as another parameter having such scalability, for example, there is a signal-to-noise ratio (SNR) (SNR scalability). In the case of the SNR scalability, respective layers having different SNRs. In other words, in this case, each picture is hierarchized into two layers, that is, a base layer of an SNR lower than that of an original image and an enhancement layer that is combined with an image of the base layer to obtain an original SNR as illustrated in FIG. 4. In other words, for base layer image compression information, information related to an image of a low PSNR is transmitted, and a high PSNR image can be reconstructed by combining the information with the enhancement layer image compression information. Of course, the number of layers is an example, and each picture can be hierarchized into an arbitrary number of layers.

A parameter other than the above-described examples may be applied as a parameter having scalability. For example, there is bit-depth scalability in which the base layer includes an 8-bit image, and a 10-bit image can be obtained by adding the enhancement layer to the base layer.

Further, there is chroma scalability in which the base layer includes a component image of a 4:2:0 format, and a component image of a 4:2:2 format can be obtained by adding the enhancement layer to the base layer.

<Encoding of Motion Information>

An encoding scheme of motion information defined in the HEVC will be described.

In the HEVC, inter-screen prediction (inter prediction) is employed as one generation method of a prediction image; however, as encoding schemes of motion information (information including motion vectors) generated in that case, two schemes of advanced motion vector prediction (AMVP) and merge are defined.

Both generate a prediction value of motion information of a current block (also referred to as predictive motion information) from the motion information of a peripheral block (peripheral PU) located in the periphery of a current block (PU) that is a processing target. In an AMVP mode, the differential value between the predictive motion information and the motion information of the current block is computed, and the difference value is included in a bit stream of image data and transmitted as an encoding result of the motion information. In addition, in a merge mode, the predictive motion information generated from the peripheral block serves as the motion information of the current block. Then, index information indicating the predictive motion information is included in a bit stream of image data and transmitted.

The predictive motion information is generated using motion information of a time-peripheral block that is a block located in the periphery of a time direction (also referred to as time direction peripheral motion information) and motion information of a space-peripheral block that is a block located in the periphery of a space direction (also referred to as space direction peripheral motion information) of the current block.

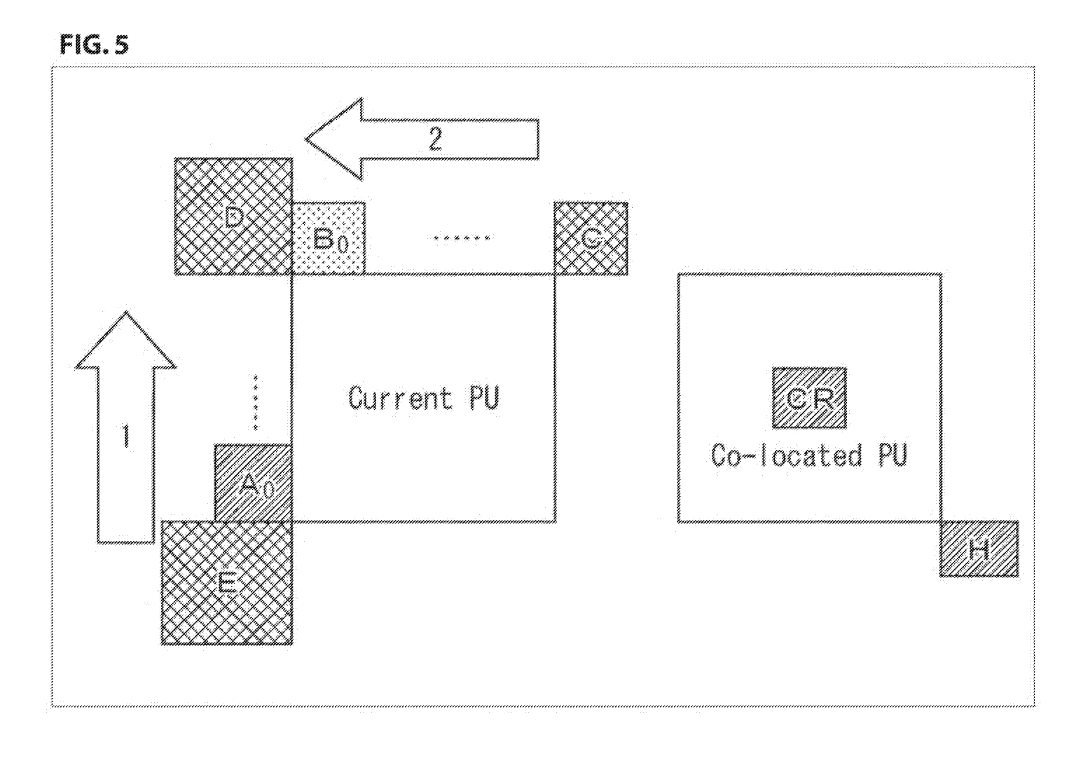

In the AMVP mode, the space direction peripheral motion information is each piece of motion information of a peripheral block A0, a peripheral block B0, a peripheral block C, a peripheral block D, and a peripheral block E with respect to, for example, a current block (Current PU) of FIG. 5. In addition, the time direction peripheral motion information is a peripheral block CR and a peripheral block H of a picture of a co-located block (Co-located PU) with respect to, for example, the current block (Current PU) of FIG. 5.

In this AMVP mode, when candidates for the predictive motion information are generated from the space direction peripheral motion information, one is selected from the peripheral block A0 and the peripheral block E of FIG. 5 as the candidate for the predictive motion information, and further, one is selected from the peripheral block C, the peripheral block B0, and the peripheral block D.

Hereinbelow, VEC1 is set as motion information having the same ref_idx and a list as motion information of the current block, VEC2 is set as motion information having the same ref_idx as and a different list from the motion information of the current block, VEC3 is set as motion information having a different ref_idx from and the same list as the motion information of the current block, and VEC4 is set as motion information having a different ref_idx and list from the motion information of the current block.

Candidates for the space direction peripheral motion information are searched for (scanned) in the following order.

(1) Perform scanning of the VEC1 of the peripheral block E and the peripheral block A0

(2) Perform scanning of the VEC2, 3, and 4 of the peripheral block E and the peripheral block A0

(3) Perform scanning of the VEC1 of the peripheral block C, the peripheral block B0, and the peripheral block D

(4) Perform scanning of the VEC2, 3, and 4 of the peripheral block C, the peripheral block B0, and the peripheral block D

The scanning processes described above end when corresponding motion information is detected.

Note that, for the VEC3 and 4, a scaling process as shown in the following expression (3) is performed.

mvLXZ=ClipMv(Sign(DistScaleFactor*mvLZ)*((Abs(DistScaleFactor*mvLXZ)+127))>>8)) (3)

In addition, when candidates of predictive motion information are generated from the time direction peripheral motion information, and motion information of the peripheral block H of FIG. 5 is unavailable, motion information of the peripheral block CR is used as a candidate for the predictive motion information.

Next, an encoding scheme of motion information in the merge mode will be described.

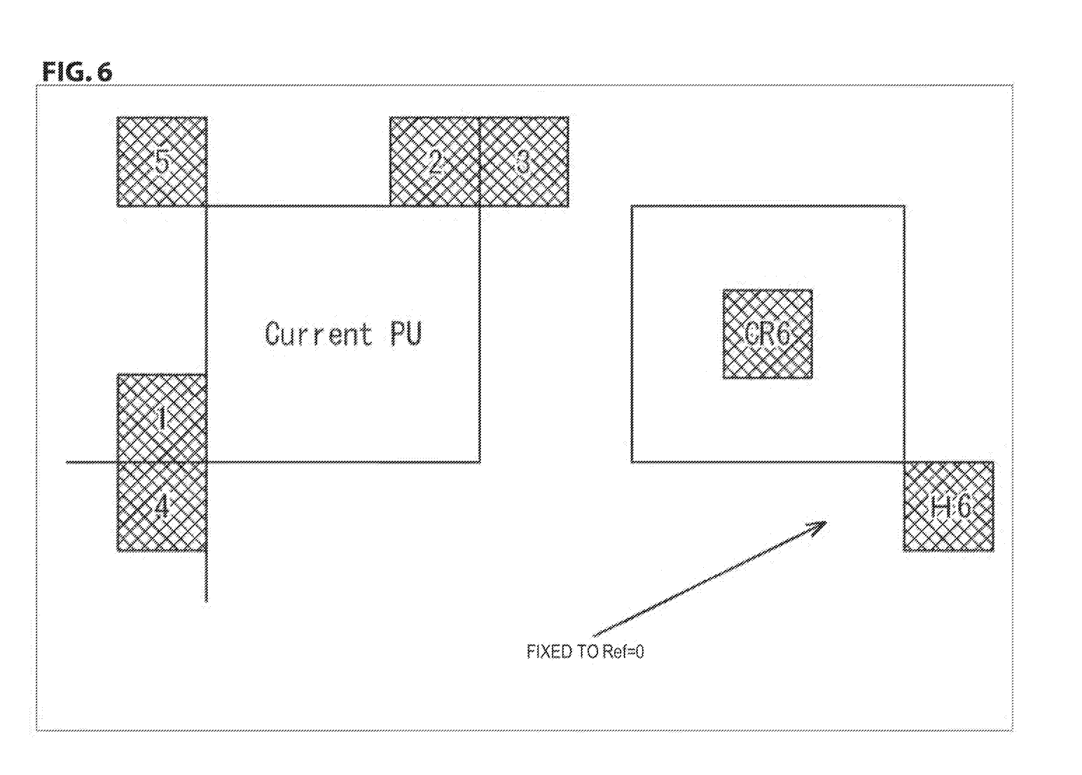

In the merge mode, the space direction peripheral motion information is each piece of motion information of a peripheral block 1 to a peripheral block 5 with respect to, for example, a current block (Current PU) of FIG. 6. In addition, with respect to the current block (Current PU) of FIG. 6, for example, time direction peripheral motion information is a peripheral block CR6 and a peripheral block H6 of a picture of a co-located block (Co-located PU).

In this merge mode, when candidates for predictive motion information are generated from the space direction peripheral motion information, motion information of the peripheral block 1 to the peripheral block 4 of FIG. 6 is used as the candidates for the predictive motion information, and then a candidate list is generated. When there is any one unavailable piece in the motion information of the peripheral block 1 to the peripheral block 4, motion information of the peripheral block 5 is used.

In addition, when candidates for the predictive motion information are generated from the time direction peripheral motion information, and motion information of the peripheral block H6 of FIG. 6 is unavailable, motion information of the peripheral block CR6 is used.

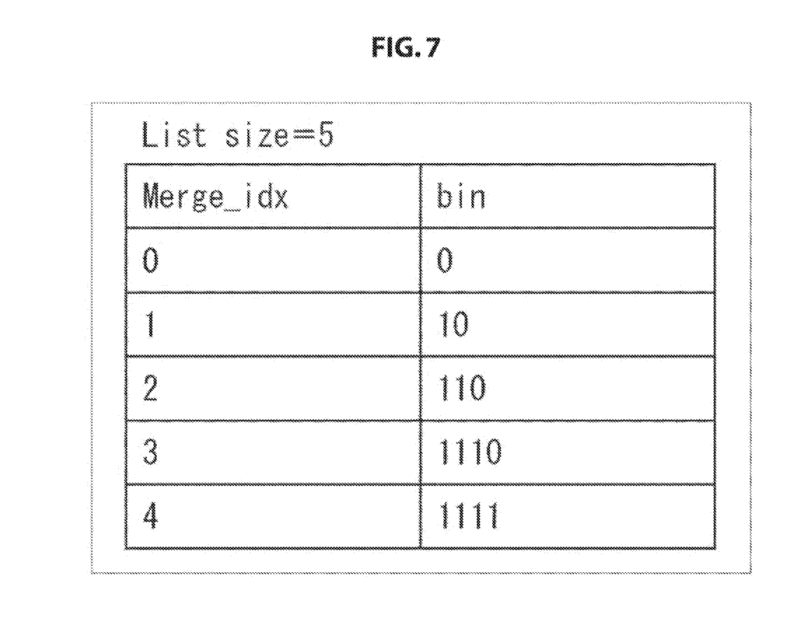

In this manner, the number of candidates for the predictive motion information in the merge mode (the size of a candidate list) is fixed to 5 at all times. In other words, the list size of an index (Merge_idx) is fixed to 5 as illustrated in FIG. 7. Accordingly, CABAC and motion prediction can be processed independently.

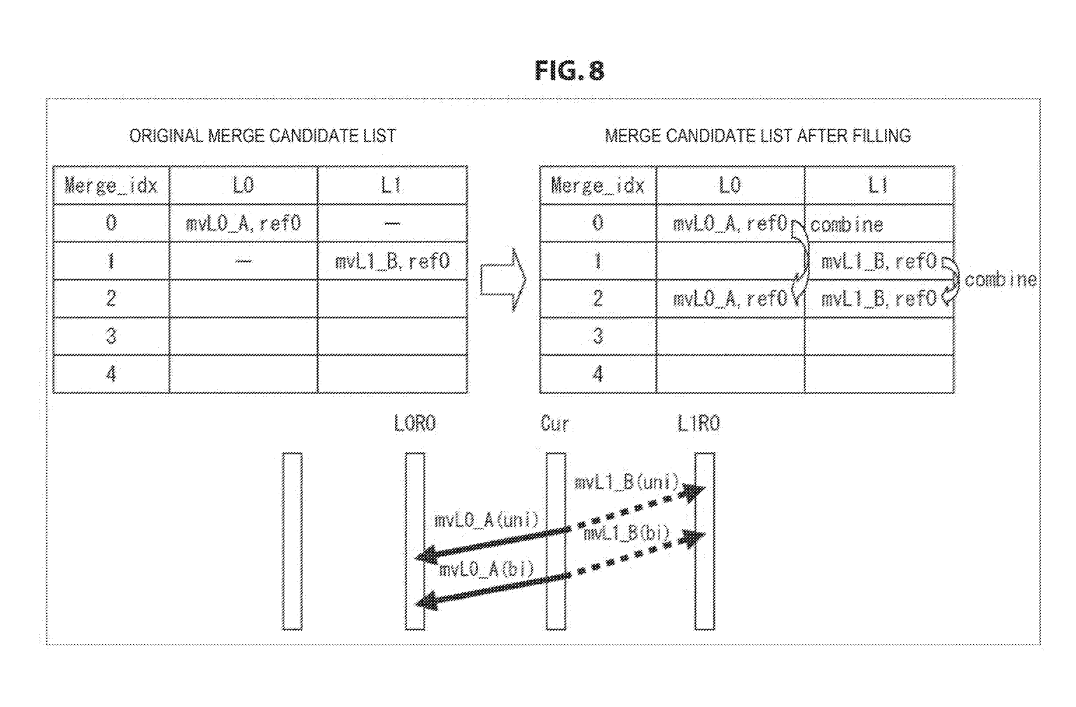

Note that, when there is unavailable peripheral motion information, there is concern of a missing number appearing in the candidate list. There is concern of the appearance of a missing number on the candidate list lowering encoding efficiency. Thus, in order to prevent a missing number from appearing on the candidate list, there are filling methods, for example, combined merge (combined bi-directional merge) and zero vector merge as illustrated in FIG. 8.

The combined merge is a method for generating a new candidate using motion information which has already been used on a candidate list for filling. The zero vector merge is a method for generating a new candidate using a zero vector for filling.

In the combined merge, however, it is not generally possible to expect enhancement in prediction accuracy with respect to predictive motion information because, regardless of a correlation with motion information of a current block, filling is performed simply with motion information of a peripheral block and even with motion information employed as a candidate for other use. In the zero vector merge, it is not possible to expect enhancement in prediction accuracy with respect to predictive motion information due to a low correlation with motion information of a current block.

Thus, when predictive motion information is generated using such a filling method, there is concern of encoding efficiency decreasing.

Particularly, in hierarchical encoding and hierarchical decoding for encoding and decoding hierarchized image data (scalable encoding and scalable decoding), a part of an entire image can be cropped (cropping) and encoded in an enhancement layer which refers to information of a base layer for encoding.

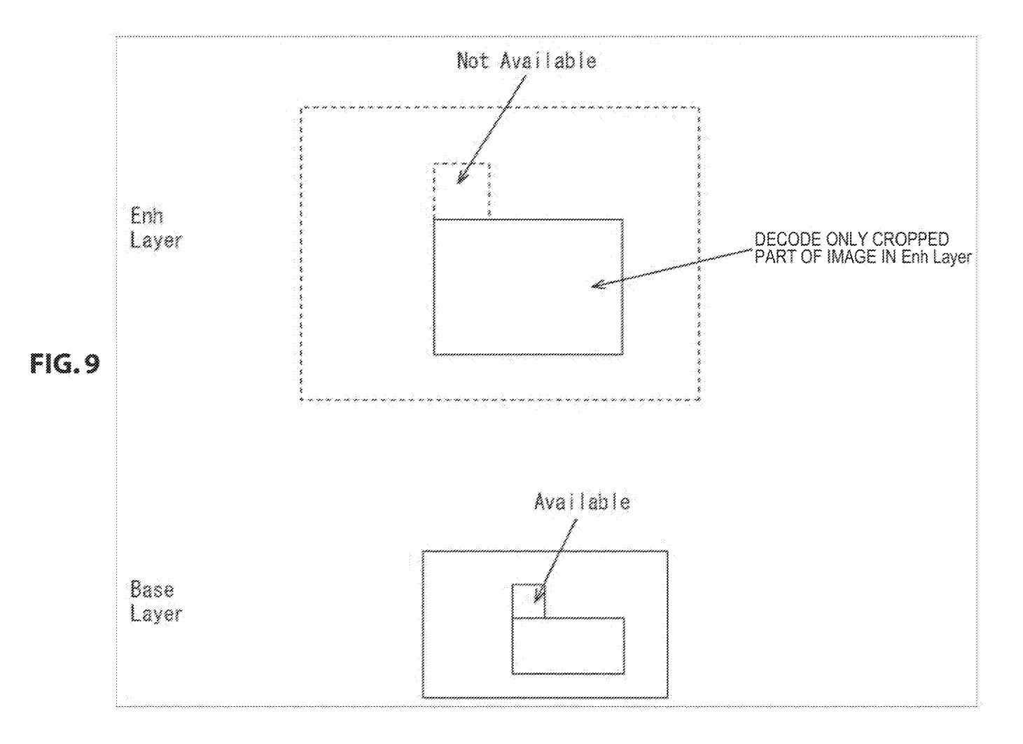

When such cropping is performed, a case in which motion information of a peripheral block which is available in the base layer becomes unavailable (also referred to as “not available”) in the enhancement layer as illustrated in FIG. 9 can be considered.

<Use of Motion Information of a Base Layer>

In scalable encoding and scalable decoding, however, a base layer and an enhancement layer generally have a high degree of a correlation in terms of motion information.

Thus, for encoding and decoding of motion information in scalable encoding and scalable decoding, instead of unavailable peripheral motion information of the enhancement layer, available peripheral motion information of the base layer is used.

<AMVP Mode>

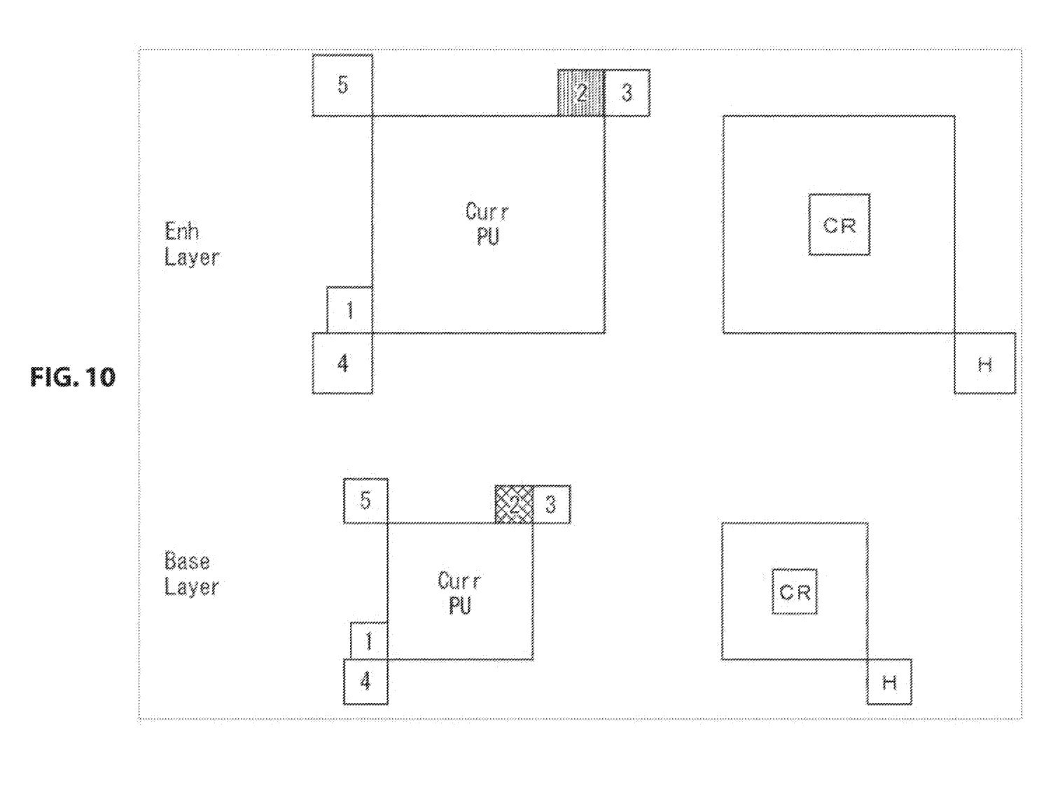

FIG. 10 illustrates blocks of an enhancement layer in the upper part and blocks of a base layer in the lower part.

The large block (Curr PU) on the upper left side of FIG. 10 represents a current block (a block to be processed) of the enhancement layer, and peripheral blocks thereof with numbers represent peripheral blocks of the current block of the enhancement layer in the space direction. The large block on the upper right side of FIG. 10 represents a block which is of a different picture from and at the same position as the current block of the enhancement layer, and the block with CR and the block with H are blocks which can be peripheral blocks (co-located blocks) of the current block of the enhancement layer in the time direction.

The large block (Curr PU) on the lower left side of FIG. 10 represents a current block of the base layer. In other words, this block is a block which is located at the same position as the current block of the enhancement layer, corresponding thereto.

In addition, the peripheral blocks with numbers are peripheral blocks of the current block of the base layer in the space direction. The large block on the lower right side of FIG. 10 represents a block which is of a different picture from and at the same position as the current block of the base layer, and the block with CR and the block with H are blocks which can be peripheral blocks (co-located blocks) of the current block of the base layer in the time direction.

In the AMVP mode, it is assumed in FIG. 10 that, for example, while the block 2 of the enhancement layer is unavailable, the block 2 of the base layer (Base layer) corresponding to the block is available.

In this case, the motion information of the block 2 of the base layer is applied as substitute information for the motion information of the block 2 of the enhancement layer.

When the base layer and the enhancement layer have different resolutions in the space direction in that case, in other words, when spatial scalability is applied, the motion information of the base layer to be applied instead of the motion information of the enhancement layer may be subject to a scaling process according to a scalability ratio (resolution ratio) between the base layer and the enhancement layer.

Note that, with regard to the motion information of the base layer to be applied instead of the motion information of the enhancement layer, a scaling process in the time axis direction may also be performed when it has a different reference index from the motion information of the current block as in the case of the motion information of the enhancement layer.

In addition, as substitute information for unscaled motion information of the enhancement layer, unscaled motion information of the base layer may be set to be used, and as substitute information for scaled motion information of the enhancement layer, scaled motion information of the base layer may be set to be used.

<Merge Mode>

In addition, in the merge mode, when there is a missing number in the candidate list of the predictive motion information of the enhancement layer, the candidate list is filled with available motion information of the base layer. In other words, when there is a missing number in the candidate list, the candidate list is filled with the motion information of the current block of the base layer which corresponds to the current block of the enhancement layer.

Note that, when the peripheral block CR6 of FIG. 6 is set as a co-located block and motion information thereof is used as collocated motion information in the base layer, a filling process is performed using the motion information of the peripheral block H6, and when the motion information of the peripheral block H6 is used as co-located motion information in the base layer, a filling process may be set to be performed using the motion information of the peripheral block CR6.

When a current picture is a P-picture, it is not possible to apply a filling process using combined merge, and only filling using zero vector merge can be applied. For this reason, particularly when a current picture is a P-picture, there is concern in filling methods of the related art that it is not possible to enhance encoding efficiency.

In the filling method using the motion information of the base layer described above, filling can be performed if the motion information of the base layer is available even when the current picture of the enhancement layer is a P-picture. For this reason, even when a current picture is a P-picture, encoding efficiency can be enhanced.

Note that this filling method may be used in conjunction with other filling methods such as combined merge (also referred to as a combined merge candidate) and zero vector merge (also referred to as a zero merge candidate).

In addition, instead of a temporal predictor of HEVC of a single layer, a base layer predictor may be used in the candidate list. In other words, the motion information of the base layer is not used in filling of a missing number, but the motion information of the base layer may be set to be used when the candidate list is generated, rather than the motion information of a peripheral block in the time direction.

When the temporal predictor is designated as co-located motion information in that case, the base layer predictor may be set to be used to fill a missing number list. In addition, when the base layer predictor is designated as co-located motion information, the temporal predictor may be set to be used to fill the missing number list.

Furthermore, information for designating which of the temporal predictor and the base layer predictor will be set as co-located motion information (for example, a flag) may be set to be transmitted in the slice header of encoded data that is obtained by encoding image data. For example, such information may be set to be transmitted as information for designating a predictor to be used in a candidate flag (for example, an indicator).

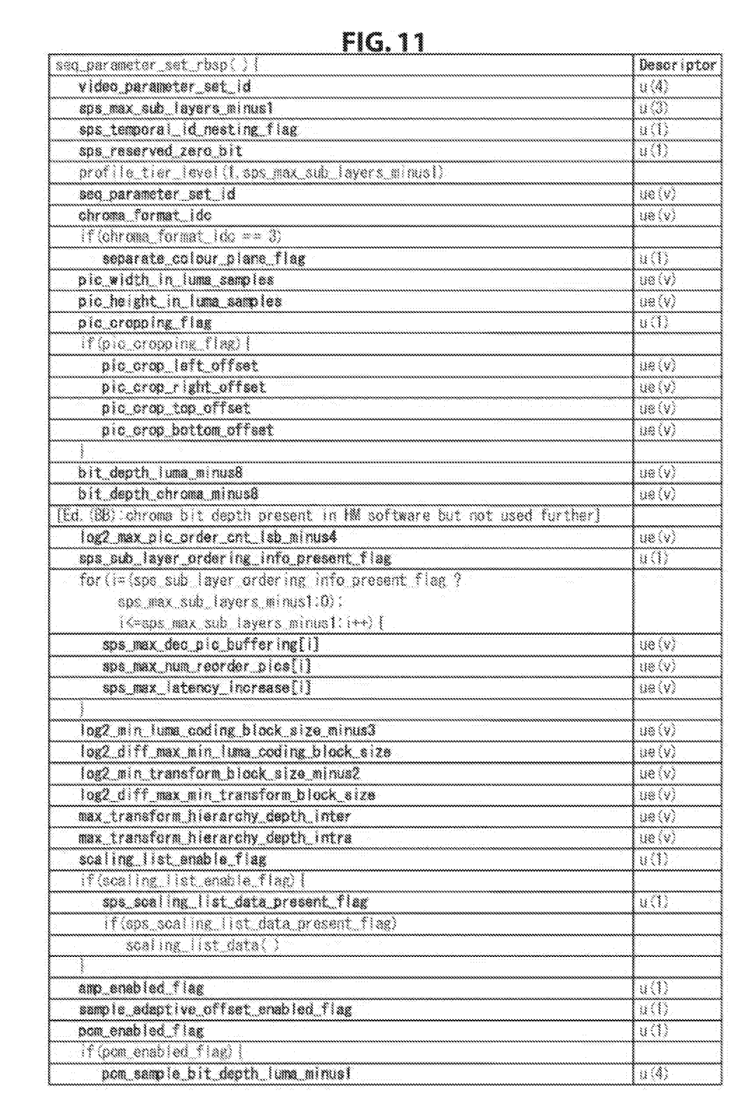

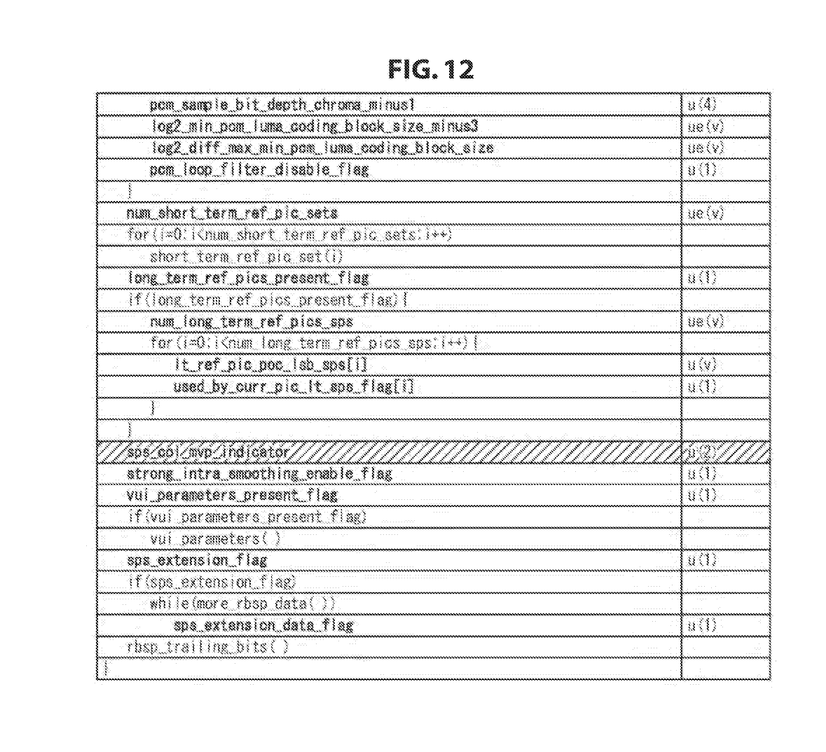

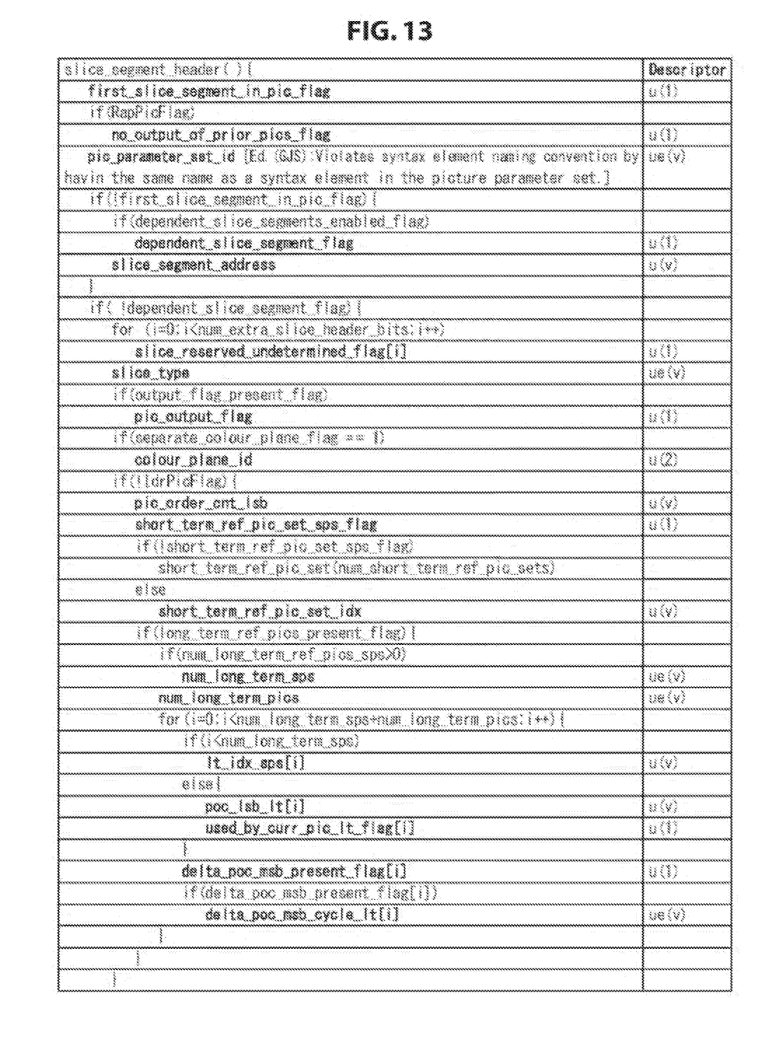

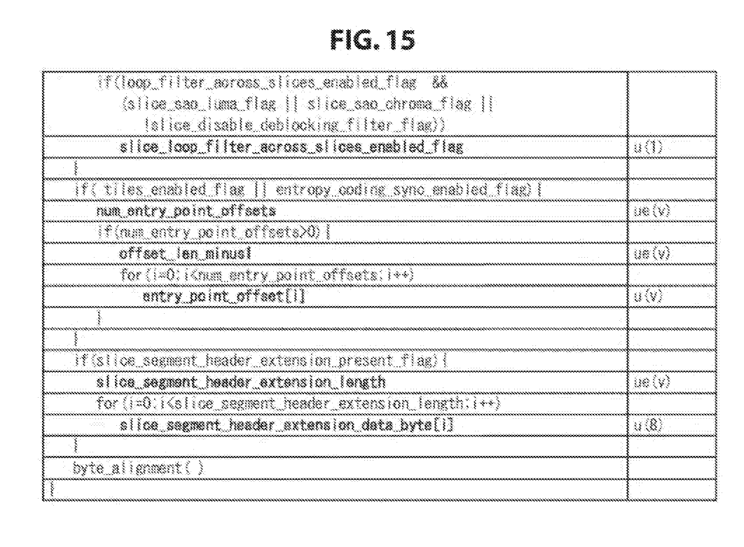

FIGS. 11 to 15 illustrate a specific example of syntax when such an indicator is transmitted. FIGS. 11 and 12 are diagrams illustrating an example of syntax of a sequence parameter set. FIGS. 13 to 15 are diagrams illustrating an example of syntax of a slice segment header.

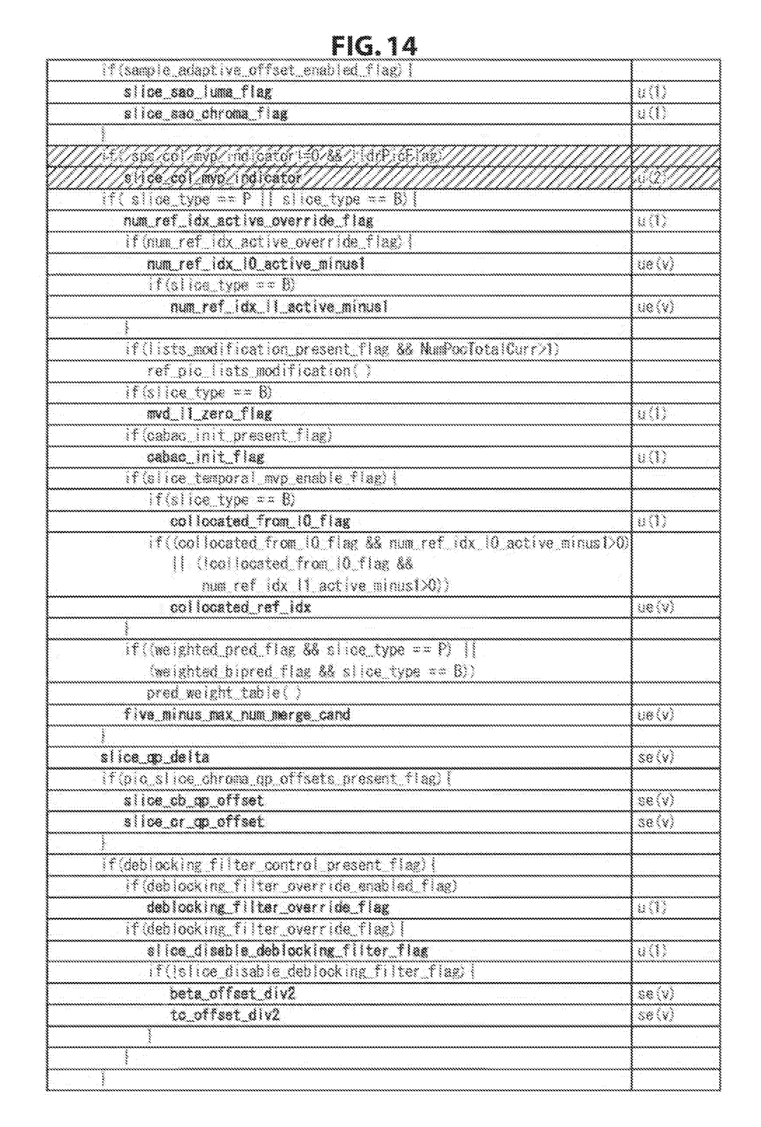

In the sequence parameter set, a parameter sps_col_mvp indicator for designating a predictor to be used in a candidate list for a current sequence to be processed as illustrated in FIG. 12 is transmitted. In addition, when the value of the parameter sps_col_mvp indicator is not “0” (sps_col_mvp indicator !=0) and a current picture to be processed is not an IDR picture (!IdrPicFlag) as illustrated in FIG. 14, a parameter slice_col_mvp indicator for designating a predictor to be used in the candidate list for a current slice to be processed is transmitted.

Note that, when the value of the parameter sps_col_mvp indicator is “0,” the candidate list is created using only a spatial predictor that is motion information of a peripheral block in the space direction. In addition, when the value of the parameter sps_col_mvp indicator is “1,” the candidate list is created using only the spatial predictor and the motion information of the base layer (col_baselayer_mv). Further, when the value of the parameter sps_col_mvp indicator is “2,” the candidate list is created using the spatial predictor and the motion information of the peripheral block in the time direction (col_tmvp). In addition, when the value of the parameter sps_col_mvp indicator is “3,” the candidate list is created using the spatial predictor, the motion information of the base layer (col_baselayer_mv), and the motion information of the peripheral block in the time direction (col_tmvp).

The same also applies to a parameter slice_col_mvp indicator.

Note that image encoding and decoding of the base layer may be based on an AVC encoding scheme.

With performance of the process described above, encoding efficiency in the enhancement layer can be enhanced.

Next, application examples of the present technology described above to specific devices will be described.

### 1. First Embodiment

### Scalable Encoding Device

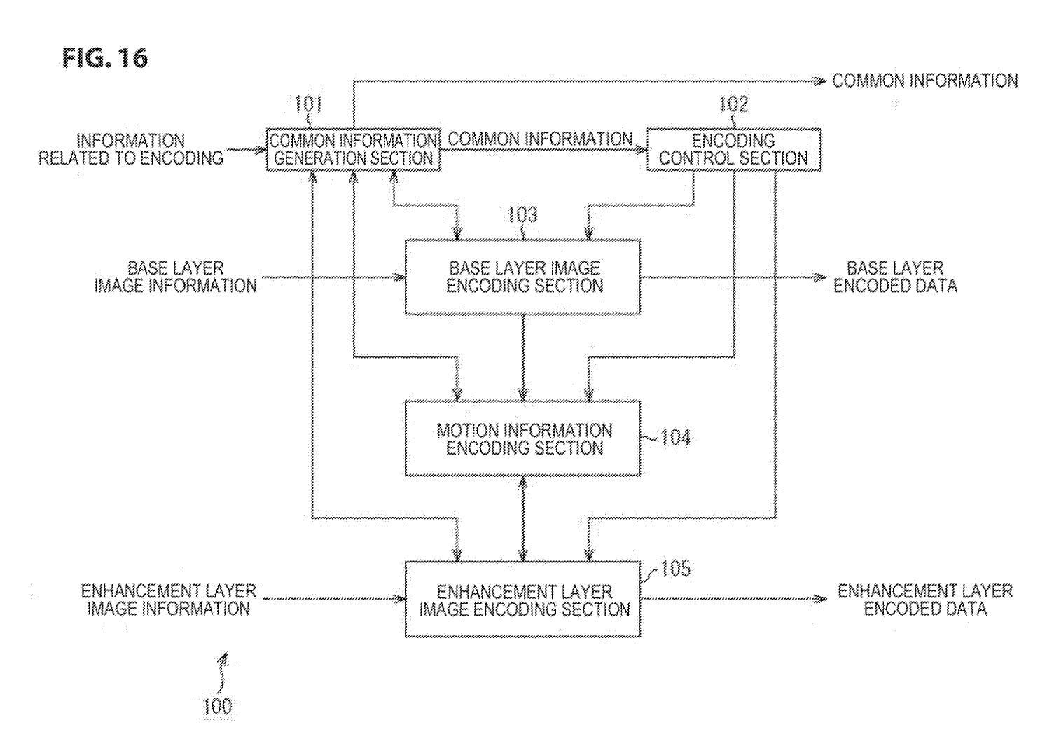

FIG. 16 is a block diagram illustrating a main configuration example of a scalable encoding device.

The scalable encoding device 100 illustrated in FIG. 16 is an image information processing device which performs scalable encoding on image data, and encodes each layer of image data hierarchized into a base layer and an enhancement layer. A parameter used as a reference of the hierarchization (a parameter that brings scalability) is arbitrary. The scalable encoding device 100 has a common information generation section 101, an encoding control section 102, a base layer image encoding section 103, a motion information encoding section 104, and an enhancement layer image encoding section 105.

The common information generation section 101 acquires information related to encoding of image data that is, for example, stored in an NAL unit. In addition, the common information generation section 101 acquires necessary information from the base layer image encoding section 103, the motion information encoding section 104, the enhancement layer image encoding section 105, and the like when necessary. The common information generation section 101 generates common information that is information related to all layers on the basis of the aforementioned information. Common information includes, for example, a video parameter set, and the like. The common information generation section 101 outputs the generated common information to the outside of the scalable encoding device 100 as, for example, an NAL unit. Note that the common information generation section 101 also supplies the generated common information to the encoding control section 102. Furthermore, the common information generation section 101 also supplies part or all of the generated common information to the base layer image encoding section 103 to the enhancement layer image encoding section 105 when necessary.

The encoding control section 102 controls the base layer image encoding section 103 to the enhancement layer image encoding section 105 based on the common information supplied from the common information generation section 101 to control encoding of each layer.

The base layer image encoding section 103 acquires image information of the base layer (base layer image information). The base layer image encoding section 103 encodes the base layer image information without using information of other layers, generates encoded data of the base layer (base layer encoded data), and outputs the data. In addition, the base layer image encoding section 103 supplies motion information obtained in the encoding to the motion information encoding section 104.

The motion information encoding section 104 encodes the motion information obtained through motion prediction by the enhancement layer image encoding section 105. The motion information encoding section 104 uses motion information of a peripheral block located in the periphery of a current block to be processed as peripheral motion information to generate predictive motion information that is the prediction value of the motion information of the current block. During the generation of the predictive motion information, the motion information encoding section 104 uses the motion information acquired from the enhancement layer image encoding section 105 as the peripheral motion information. However, when the motion information is unavailable, the motion information encoding section 104 uses available motion information acquired from the base layer image encoding section 103 as peripheral motion information instead of the unavailable motion information. The motion information encoding section 104 encodes the motion information of the current block using the predictive motion information generated as described above, and returns the encoding result to the enhancement layer image encoding section 105.

The enhancement layer image encoding section 105 acquires image information of the enhancement layer (enhancement layer image information). The enhancement layer image encoding section 105 encodes the enhancement layer image information. Note that, in order to encode motion information of a current block, the enhancement layer image encoding section 105 supplies the motion information of the current block to the motion information encoding section 104. Furthermore, the enhancement layer image encoding section 105 acquires the result of encoding of the motion information of the current block from the motion information encoding section 104. The enhancement layer image encoding section 105 generates encoded data of the enhancement layer (enhancement layer encoded data) through the encoding, and outputs the data.

<Base Layer Image Encoding Section>

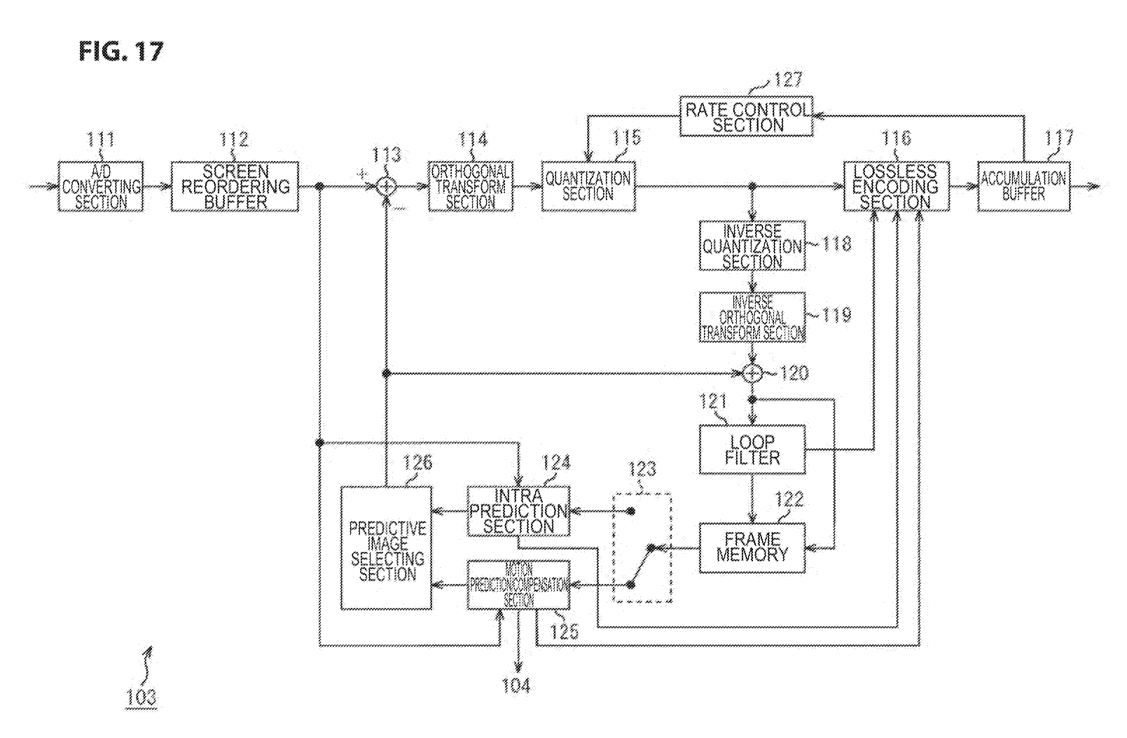

FIG. 17 is a block diagram illustrating an example of a main configuration of the base layer image encoding section 103 of FIG. 16. As illustrated in FIG. 17, the base layer image encoding section 103 includes an A/D converting section 111, a screen reordering buffer 112, an operation section 113, an orthogonal transform section 114, a quantization section 115, a lossless encoding section 116, an accumulation buffer 117, an inverse quantization section 118, and an inverse orthogonal transform section 119. The base layer image encoding section 103 further includes an operation section 120, a loop filter 121, a frame memory 122, a selecting section 123, an intra prediction section 124, a motion prediction/compensation section 125, a predictive image selecting section 126, and a rate control section 127.

The A/D converting section 111 performs A/D conversion on input image data (the base layer image information), and supplies the converted image data (digital data) to be stored in the screen reordering buffer 112. The screen reordering buffer 112 reorders images of frames stored in a display order in a frame order for encoding according to a Group Of Pictures (GOP), and supplies the images in which the frame order is reordered to the operation section 113. The screen reordering buffer 112 also supplies the images in which the frame order is reordered to the intra prediction section 124 and the motion prediction/compensation section 125.

The operation section 113 subtracts a predictive image supplied from the intra prediction section 124 or the motion prediction/compensation section 125 via the predictive image selecting section 126 from an image read from the screen reordering buffer 112, and outputs differential information thereof to the orthogonal transform section 114. For example, in the case of an image that has been subjected to intra coding, the operation section 113 subtracts the predictive image supplied from the intra prediction section 124 from the image read from the screen reordering buffer 112. Further, for example, in the case of an image that has been subjected to inter coding, the operation section 113 subtracts the predictive image supplied from the motion prediction/compensation section 125 from the image read from the screen reordering buffer 112.

The orthogonal transform section 114 performs an orthogonal transform such as a discrete cosine transform or a Karhunen-Loève Transform on the differential information supplied from the operation section 113. The orthogonal transform section 114 supplies transform coefficients to the quantization section 115.

The quantization section 115 quantizes the transform coefficients supplied from the orthogonal transform section 114. The quantization section 115 sets a quantization parameter based on information related to a target value of a coding amount supplied from the rate control section 127, and performs the quantizing. The quantization section 115 supplies the quantized transform coefficients to the lossless encoding section 116.

The lossless encoding section 116 encodes the transform coefficients quantized in the quantization section 115 according to an arbitrary encoding scheme. Since coefficient data is quantized under control of the rate control section 127, the coding amount becomes a target value (or approaches a target value) set by the rate control section 127.

The lossless encoding section 116 acquires information indicating an intra prediction mode or the like from the intra prediction section 124, and acquires information indicating an inter prediction mode, differential motion vector information, or the like from the motion prediction/compensation section 125. Further, the lossless encoding section 116 appropriately generates an NAL unit of the base layer including a sequence parameter set (SPS), a picture parameter set (PPS), and the like.

The lossless encoding section 116 encodes various kinds of information according to an arbitrary encoding scheme, and sets (multiplexes) the encoded information as part of encoded data (also referred to as an “encoded stream”). The lossless encoding section 116 supplies the encoded data obtained by the encoding to be accumulated in the accumulation buffer 117.

Examples of the encoding scheme of the lossless encoding section 116 include variable length coding and arithmetic coding. As the variable length coding, for example, there is Context-Adaptive Variable Length Coding (CAVLC) defined in the H.264/AVC scheme. As the arithmetic coding, for example, there is Context-Adaptive Binary Arithmetic Coding (CABAC).

The accumulation buffer 117 temporarily holds the encoded data (base layer encoded data) supplied from the lossless encoding section 116. The accumulation buffer 117 outputs the held base layer encoded data to a recording device (recording medium), a transmission path, or the like (not illustrated) at a subsequent stage at a certain timing. In other words, the accumulation buffer 117 serves as a transmitting section that transmits the encoded data as well.

The transform coefficients quantized by the quantization section 115 are also supplied to the inverse quantization section 118. The inverse quantization section 118 inversely quantizes the quantized transform coefficients according to a method corresponding to the quantization performed by the quantization section 115. The inverse quantization section 118 supplies the obtained transform coefficients to the inverse orthogonal transform section 119.

The inverse orthogonal transform section 119 performs an inverse orthogonal transform on the transform coefficients supplied from the inverse quantization section 118 according to a method corresponding to the orthogonal transform process performed by the orthogonal transform section 114. An output (restored differential information) that has been subjected to the inverse orthogonal transform is supplied to the operation section 120.

The operation section 120 obtains a locally decoded image (a decoded image) by adding the predictive image supplied from the intra prediction section 124 or the motion prediction/compensation section 125 via the predictive image selecting section 126 to the restored differential information serving as an inverse orthogonal transform result supplied from the inverse orthogonal transform section 119. The decoded image is supplied to the loop filter 121 or the frame memory 122.

The loop filter 121 includes a deblock filter, an adaptive loop filter, or the like, and appropriately performs a filter process on the reconstructed image supplied from the operation section 120. For example, the loop filter 121 performs the deblock filter process on the reconstructed image, and removes block distortion of the reconstructed image. Further, for example, the loop filter 121 improves the image quality by performing the loop filter process on the deblock filter process result (the reconstructed image from which the block distortion has been removed) using a Wiener filter. The loop filter 121 supplies the filter process result (hereinafter referred to as a “decoded image”) to the frame memory 122.

The loop filter 121 may further perform any other arbitrary filter process on the reconstructed image. The loop filter 121 may supply information used in the filter process such as a filter coefficient to the lossless encoding section 116 as necessary so that the information can be encoded.

The frame memory 122 stores the reconstructed image supplied from the operation section 120 and the decoded image supplied from the loop filter 121. The frame memory 122 supplies the stored reconstructed image to the intra prediction section 124 via the selecting section 123 at a certain timing or based on an external request, for example, from the intra prediction section 124. Further, the frame memory 122 supplies the stored decoded image to the motion prediction/compensation section 125 via the selecting section 123 at a certain timing or based on an external request, for example, from the motion prediction/compensation section 125.

The frame memory 122 stores the supplied decoded image, and supplies the stored decoded image to the selecting section 123 as a reference image at a certain timing.

The selecting section 123 selects a supply destination of the reference image supplied from the frame memory 122. For example, in the case of the intra prediction, the selecting section 123 supplies the reference image (a pixel value of a current picture) supplied from the frame memory 122 to the motion prediction/compensation section 125. Further, for example, in the case of the inter prediction, the selecting section 123 supplies the reference image supplied from the frame memory 122 to the motion prediction/compensation section 125.

The intra prediction section 124 performs the intra prediction (intra-screen prediction) for generating the predictive image using the pixel value of the current picture serving as the reference image supplied from the frame memory 122 via the selecting section 123. The intra prediction section 124 performs the intra prediction in a plurality of intra prediction modes that are prepared in advance.

The intra prediction section 124 generates predictive images in all the intra prediction modes serving as the candidates, evaluates cost function values of the predictive images using the input image supplied from the screen reordering buffer 112, and selects an optimal mode. When the optimal intra prediction mode is selected, the intra prediction section 124 supplies the predictive image generated in the optimal mode to the predictive image selecting section 126.

As described above, the intra prediction section 124 appropriately supplies, for example, the intra prediction mode information indicating the employed intra prediction mode to the lossless encoding section 116 so that the information is encoded.

The motion prediction/compensation section 125 performs the motion prediction (the inter prediction) using the input image supplied from the screen reordering buffer 112 and the reference image supplied from the frame memory 122 via the selecting section 123. The motion prediction/compensation section 125 performs a motion compensation process according to a detected motion vector, and generates a predictive image (inter-predictive image information). The motion prediction/compensation section 125 performs the inter prediction in a plurality of inter prediction modes that are prepared in advance.

The motion prediction/compensation section 125 generates predictive images in all the inter prediction modes serving as a candidate. The motion prediction/compensation section 125 evaluates cost function values of the predictive images using the input image supplied from the screen reordering buffer 112, information of the generated differential motion vector, and the like, and selects an optimal mode. When the optimal inter prediction mode is selected, the motion prediction/compensation section 125 supplies the predictive image generated in the optimal mode to the predictive image selecting section 126.

The motion prediction/compensation section 125 supplies information indicating the employed inter prediction mode, information necessary for performing processing in the inter prediction mode when the encoded data is decoded, and the like to the lossless encoding section 116 so that the information is encoded. For example, as the necessary information, there is information of a generated differential motion vector, and as prediction motion vector information, there is a flag indicating an index of a prediction motion vector.

The predictive image selecting section 126 selects a supply source of the prediction image to be supplied to the operation section 113 and the operation section 120. For example, in the case of the intra coding, the predictive image selecting section 126 selects the intra prediction section 124 as the supply source of the predictive image, and supplies the predictive image supplied from the intra prediction section 124 to the operation section 113 and the operation section 120. For example, in the case of the inter coding, the predictive image selecting section 126 selects the motion prediction/compensation section 125 as the supply source of the predictive image, and supplies the predictive image supplied from the motion prediction/compensation section 125 to the operation section 113 and the operation section 120.

The rate control section 127 controls a rate of a quantization operation of the quantization section 115 based on the coding amount of the encoded data accumulated in the accumulation buffer 117 such that no overflow or underflow occurs.

The motion prediction/compensation section 125 supplies the motion information of the current block detected through motion prediction in each of the modes to the motion information encoding section 104 as the motion information of the base layer.

<Enhancement Layer Image Encoding Section>

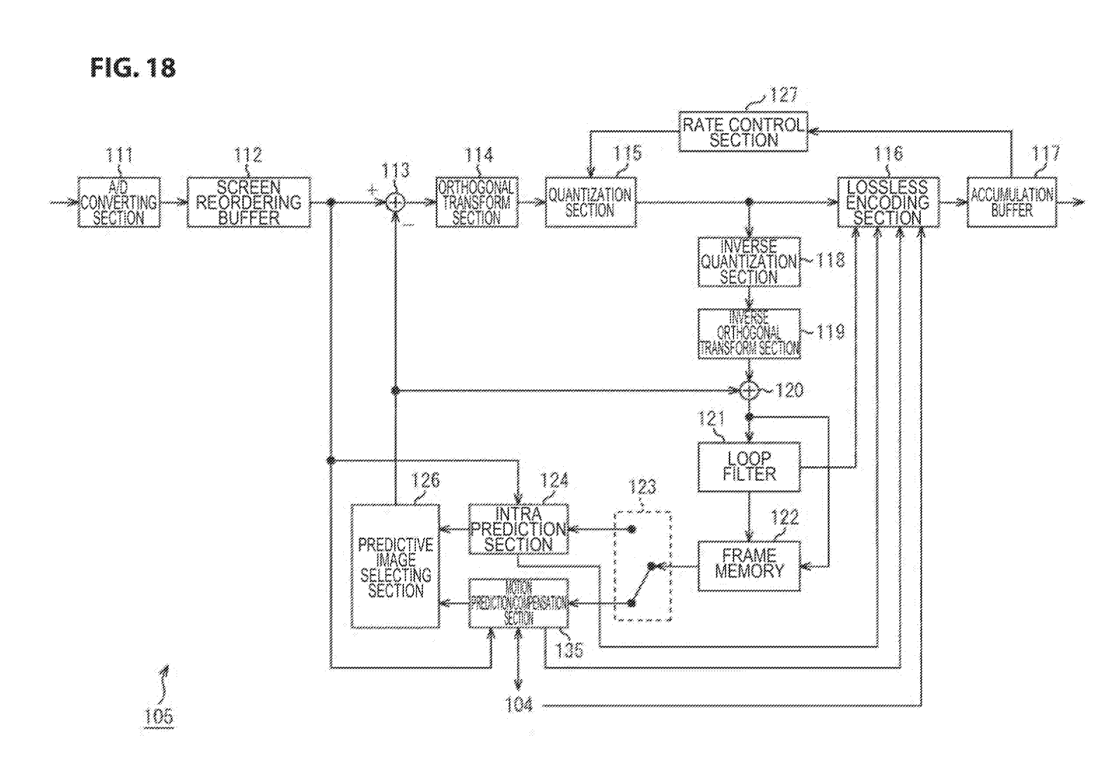

FIG. 18 is a block diagram illustrating a main configuration example of the enhancement layer image encoding section 105 of FIG. 16. As illustrated in FIG. 18, the enhancement layer image encoding section 105 basically has the same configuration as the base layer image encoding section 103 of FIG. 17.

Each section of the enhancement layer image encoding section 105, however, performs a process related to encoding of enhancement layer image information, rather than the base layer. In other words, the A/D converting section 111 of the enhancement layer image encoding section 105 performs A/D conversion on enhancement layer image information, and the accumulation buffer 117 of the enhancement layer image encoding section 105 outputs enhancement layer encoded data to, for example, a recording device (recording medium) provided in the later stage not illustrated, a transmission path, or the like.

In addition, the enhancement layer image encoding section 105 has a motion prediction/compensation section 135, instead of the motion prediction/compensation section 125.

The motion prediction/compensation section 135 encodes motion information using the motion information encoding section 104. In other words, while the motion prediction/compensation section 125 encodes motion information of a current block using only peripheral motion information of the base layer, the motion prediction/compensation section 135 can encode motion information of a current block using not only peripheral motion information of the enhancement layer but also peripheral motion information of the base layer.

The motion prediction/compensation section 135 supplies the motion information of the current block detected through motion prediction to the motion information encoding section 104 as motion information of the enhancement layer in each mode. In addition, the motion prediction/compensation section 135 acquires an encoding result with respect to each piece of the supplied motion information. The motion prediction/compensation section 135 computes a cost function value using the encoding result, and decides an optimal inter prediction mode.

<Motion Information Encoding Section>

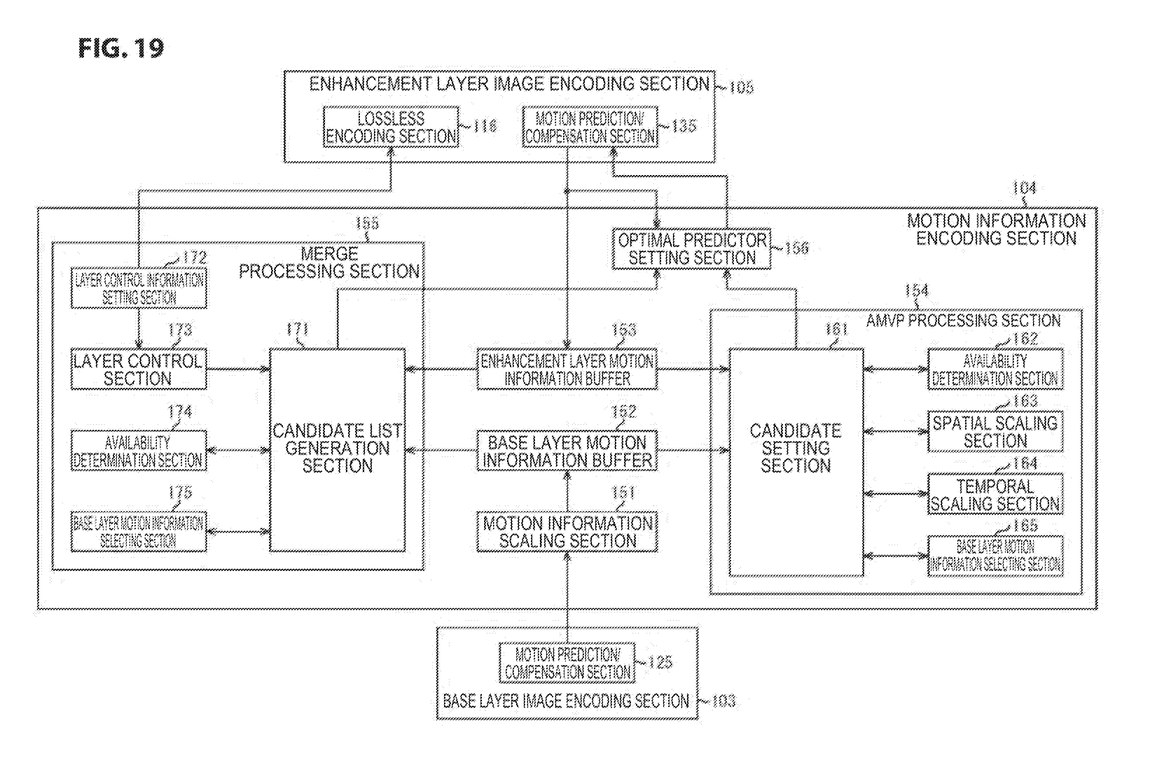

FIG. 19 is a block diagram illustrating a main configuration example of the motion information encoding section 104 of FIG. 16.

The motion information encoding section 104 has a motion information scaling section 151, a base layer motion information buffer 152, an enhancement layer motion information buffer 153, an AMVP processing section 154, a merge processing section 155, and an optimal predictor setting section 156 as illustrated in FIG. 19.

The motion information scaling section 151 acquires the motion information of the base layer from the motion prediction/compensation section 125 of the base layer image encoding section 103, and performs a scaling process (conversion process (for enlargement or reduction)) on the motion information according to a scaling ratio (for example, a resolution ratio) between the base layer and the enhancement layer in the space direction. The motion information scaling section 151 supplies the scaling-processed motion information to the base layer motion information buffer 152.

The base layer motion information buffer 152 stores the scaling-processed motion information of the base layer supplied from the motion information scaling section 151. The base layer motion information buffer 152 appropriately supplies the stored motion information of the base layer to the AMVP processing section 154 (a candidate setting section 161) or the merge processing section 155 (a candidate list generation section 171) as the motion information of the base layer.

The enhancement layer motion information buffer 153 acquires and stores the motion information of the current block supplied from the motion prediction/compensation section 135 of the enhancement layer image encoding section 105. The enhancement layer motion information buffer 153 appropriately supplies the stored motion information of the enhancement layer to the AMVP processing section 154 (the candidate setting section 161) or the merge processing section 155 (the candidate list generation section 171) as the peripheral motion information of the enhancement layer.

The AMVP processing section 154 sets predictive motion information candidates for the motion information of the current block of the enhancement layer in the AMVP mode. At this time, the AMVP processing section 154 acquires the motion information of the enhancement layer stored in the enhancement layer motion information buffer 153 when necessary. In addition, the AMVP processing section 154 acquires the motion information of the base layer stored in the base layer motion information buffer 152 as peripheral motion information when necessary. The AMVP processing section 154 sets predictive motion information using the peripheral motion information. The AMVP processing section 154 supplies the set candidates for the predictive motion information to the optimal predictor setting section 156.

The merge processing section 155 generates a candidate list of the predictive motion information corresponding to the motion information of the current block of the enhancement layer in the merge mode. At this time, the merge processing section 155 acquires the motion information of the enhancement layer stored in the enhancement layer motion information buffer 153 as peripheral motion information when necessary. In addition, the merge processing section 155 acquires the motion information of the base layer stored in the base layer motion information buffer 152 as peripheral motion information when necessary. The merge processing section 155 generates a candidate list using the pieces of peripheral motion information. The merge processing section 155 supplies the generated candidate list to the optimal predictor setting section 156.

The optimal predictor setting section 156 sets an optimal predictor with respect to the motion information of the current block of the enhancement layer supplied from the motion prediction/compensation section 135 of the enhancement layer image encoding section 105 using the candidates for the predictive motion information supplied from the AMVP processing section 154 and the candidate list supplied from the merge processing section 155. In other words, the optimal predictor setting section 156 computes a cost function value of an encoding result for each obtained candidate, and selects a candidate that has the smallest value as an optimal predictor. The optimal predictor setting section 156 encodes the motion information of the current block supplied from the motion prediction/compensation section 135 using the optimal predictor. To be more specific, the optimal predictor setting section 156 obtains the difference between the motion information and the predictive motion information (differential motion information). The optimal predictor setting section 156 obtains such encoding results (differential motion information) of each of the modes, and supplies the obtained encoding results to the motion prediction/compensation section 135.

As illustrated in FIG. 19, the AMVP processing section 154 has the candidate setting section 161, an availability determination section 162, a spatial scaling section 163, a temporal scaling section 164, and a base layer motion information selecting section 165.

The candidate setting section 161 sets candidates for the predictive motion information of the motion information of the current block obtained by the motion prediction/compensation section 135 for encoding of the enhancement layer by the enhancement layer image encoding section 105. The candidate setting section 161 acquires the peripheral motion information of the enhancement layer from the enhancement layer motion information buffer 153, and sets a candidate for the peripheral motion information as predictive motion information.

The candidate setting section 161 supplies the peripheral motion information of the enhancement layer to the availability determination section 162 to cause the availability of the peripheral motion information to be determined, and thereby acquires the result of the determination. When the peripheral motion information of the enhancement layer is unavailable, the candidate setting section 161 acquires the peripheral motion information of the base layer from the base layer motion information buffer 152, and sets the peripheral motion information of the base layer as predictive motion information, instead of the motion information of the enhancement layer.

When a scaling process in the space direction is necessary, the candidate setting section 161 supplies the peripheral motion information to the spatial scaling section 163 to cause the scaling process in the space direction to be performed, and thereby acquires scaling-processed peripheral motion information.

When a scaling process in the time direction is necessary, the candidate setting section 161 supplies the peripheral motion information to the temporal scaling section 164 to cause the scaling process in the time direction to be performed, and thereby acquires scaling-processed peripheral motion information.

When the motion information of the base layer is used for co-located motion information instead of the motion information of the enhancement layer, the candidate setting section 161 uses the motion information of the base layer selected by the base layer motion information selecting section 165.

The candidate setting section 161 supplies the set candidate for the predictive motion information to the optimal predictor setting section 156.

The availability determination section 162 determines the availability of the motion information supplied from the candidate setting section 161, and supplies the result of the determination to the candidate setting section 161.

The spatial scaling section 163 performs a scaling process on the motion information supplied from the candidate setting section 161 in the space direction, and supplies the scaling-processed motion information to the candidate setting section 161.

The temporal scaling section 164 performs a scaling process on the motion information supplied from the candidate setting section 161 in the time direction, and supplies the scaling-processed motion information to the candidate setting section 161.

The base layer motion information selecting section 165 selects the motion information of the base layer used by the candidate setting section 161 as the co-located motion information according to the encoding result of the base layer performed by the base layer image encoding section 103. To be more specific, the base layer motion information selecting section 165 selects the motion information of the base layer not being used as co-located motion information in the encoding of the base layer as co-located motion information of the enhancement layer. For example, when motion information of the peripheral block CR6 of the base layer has been used as co-located motion information in the encoding of the base layer, the base layer motion information selecting section 165 selects the motion information of the peripheral block H6 of the base layer as co-located motion information in encoding of the enhancement layer. In addition, for example, when the motion information of the peripheral block H6 of the base layer has been used as co-located motion information in the encoding of the base layer, the base layer motion information selecting section 165 selects the motion information of the peripheral block CR6 of the base layer as co-located motion information in encoding of the enhancement layer.

When the motion information of the base layer is used instead of the motion information of the enhancement layer as co-located motion information in the encoding of the enhancement layer as described above, the candidate setting section 161 uses the motion information of the base layer selected by the base layer motion information selecting section 165 as described above.

In addition, the merge processing section 155 has the candidate list generation section 171, a layer control information setting section 172, a layer control section 173, an availability determination section 174, and a base layer motion information selecting section 175 as illustrated in FIG. 19.

The candidate list generation section 171 generates a candidate list in the merge mode for obtaining predictive motion information of the motion information of the current block obtained by the motion prediction/compensation section 135 for encoding of the enhancement layer performed by the enhancement layer image encoding section 105. The number of candidates (the length of the candidate list) is arbitrary, but a pre-determined number is desirable so that CABAC and motion prediction can be processed independently. In the following description, the number of candidates is set to 5.

The candidate list generation section 171 acquires the peripheral motion information of the enhancement layer from the enhancement layer motion information buffer 153, and generates a candidate list using the peripheral motion information.

When being controlled by the layer control section 173 to generate a candidate list using the motion information of the base layer, the candidate list generation section 171 acquires the peripheral motion information of the base layer from the base layer motion information buffer 152, and generates a candidate list using the peripheral motion information. For example, when the candidate list generation section 171 generates a candidate list using a base layer predictor rather than a temporal predictor under control of the layer control section 173, it acquires the peripheral motion information of the base layer from the base layer motion information buffer 152.

The candidate list generation section 171 supplies the peripheral motion information of the enhancement layer to the availability determination section 174 to cause the availability of the peripheral motion information to be determined, and thereby acquires the result of the determination. When the peripheral motion information of the enhancement layer is unavailable, the candidate list generation section 171 acquires the peripheral motion information of the base layer from the base layer motion information buffer 152 and fills a missing number in the candidate list with the peripheral motion information of the base layer.

When the motion information of the base layer is used instead of the motion information of the enhancement layer for co-located motion information, the candidate list generation section 171 uses the motion information of the base layer selected by the base layer motion information selecting section 175.

The candidate list generation section 171 supplies the generated candidate list to the optimal predictor setting section 156.

The layer control information setting section 172 sets information for selecting a predictor to be used in generation of the candidate list (layer control information). For example, the layer control information setting section 172 sets layer control information for selecting whether a temporal predictor is to be used and whether a base layer predictor is to be used (for example, sps_col_mvp indicator, slice_col_mvp indicator, or the like). The layer control information setting section 172 supplies the layer control information set in this manner to the layer control section 173. In addition, the layer control information setting section 172 supplies the layer control information set as above to the lossless encoding section 116 of the enhancement layer image encoding section 105 to cause it to be transmitted on the decoding side.

The layer control section 173 controls a layer of the peripheral motion information used by the candidate list generation section 171 to generate the candidate list based on the layer control information acquired from the layer control information setting section 172. To be more specific, the layer control section 173 controls whether the peripheral motion information of the enhancement layer is to be used or the peripheral motion information of the base layer is to be used in the generation of the candidate list. As described above, the candidate list generation section 171 acquires the peripheral motion information under control of the layer control section 173.

The availability determination section 174 determines the availability of the motion information supplied from the candidate list generation section 171 and supplies the result of the determination to the candidate list generation section 171.

The base layer motion information selecting section 175 selects the motion information of the base layer used by the candidate list generation section 171 as co-located motion information according to the result of encoding of the base layer performed by the base layer image encoding section 103. To be more specific, the base layer motion information selecting section 175 selects the motion information of the base layer which has not been used as co-located motion information in the encoding of the base layer as co-located motion information of the enhancement layer. For example, when the motion information of the peripheral block CR6 of the base layer has been used as co-located motion information in the encoding of the base layer, the base layer motion information selecting section 175 selects the motion information of the peripheral block H6 of the base layer as co-located motion information in encoding of the enhancement layer. In addition, when the motion information of the peripheral block H6 of the base layer has been used as co-located motion information in the encoding of the base layer, the base layer motion information selecting section 175 selects the motion information of the peripheral block CR6 of the base layer as co-located motion information in encoding of the enhancement layer.

As described above, when the motion information of the base layer is used instead of the motion information of the enhancement layer as co-located motion information in encoding of the enhancement layer, the candidate list generation section 171 uses the motion information of the base layer selected by the base layer motion information selecting section 175 as above.

In this manner, when the peripheral motion information of the enhancement layer is unavailable in encoding of motion information of the enhancement layer, the scalable encoding device 100 obtains predictive motion information using the peripheral motion information of the base layer instead of the motion information of the enhancement layer, and thus can suppress deterioration in prediction accuracy, and suppress a decrease in encoding efficiency. Accordingly, the scalable encoding device 100 can suppress deterioration in image quality resulting from encoding and decoding.

<Flow of the Encoding Process>

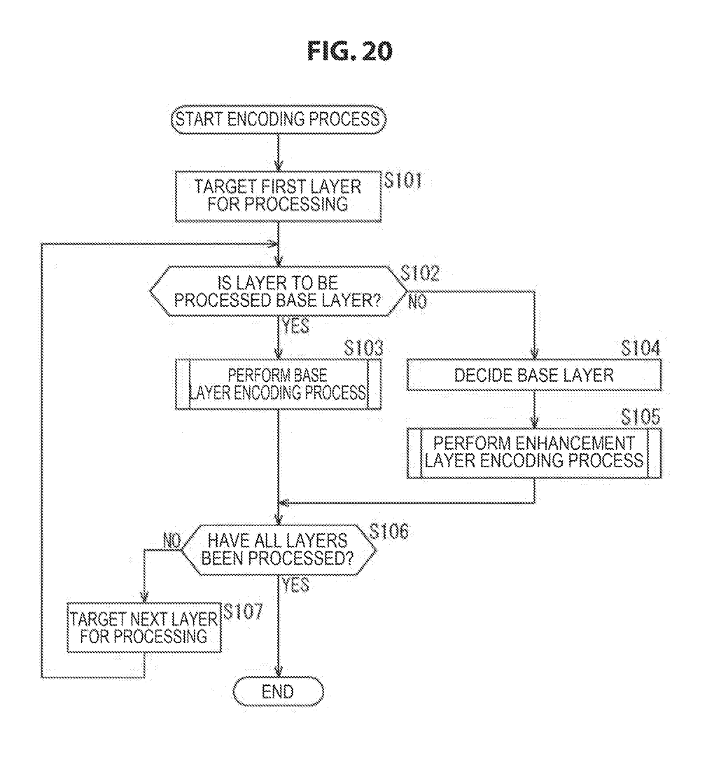

Next, the flow of each process executed by the scalable encoding device 100 as described above will be described. First, an example of the flow of the encoding process will be described with reference to the flow chart of FIG. 20. The scalable encoding device 100 executes this encoding process for each picture.

When the encoding process starts, the encoding control section 102 of the scalable encoding device 100 targets a first layer for processing in Step S101.

In Step S102, the encoding control section 102 determines whether or not the current layer that is the processing target is the base layer. When the current layer is determined to be the base layer, the process proceeds to Step S103.

In Step S103, the base layer image encoding section 103 performs a base layer encoding process. When the process of Step S103 ends, the process proceeds to Step S106.

In addition, when the current layer is determined to be an enhancement layer in Step S102, the process proceeds to Step S104. In Step S104, the encoding control section 102 decides a base layer corresponding to the current layer (in other words, as a reference destination).

In Step S105, the enhancement layer image encoding section 105 performs an enhancement layer encoding process. When the process of Step S105 ends, the process proceeds to Step S106.

In step S106, the encoding control section 102 determines whether or not all the layers have been processed. When it is determined that there is a non-processed layer, the process proceeds to step S107.

In step S107, the encoding control section 102 sets a next non-processed layer as a processing target (current layer). When the process of step S107 ends, the process returns to step S102. The process of steps S102 to S107 is repeatedly performed to encode the layers.

Then, when all the layers are determined to have been processed in step S106, the encoding process ends.

<Flow of Base Layer Encoding Process>

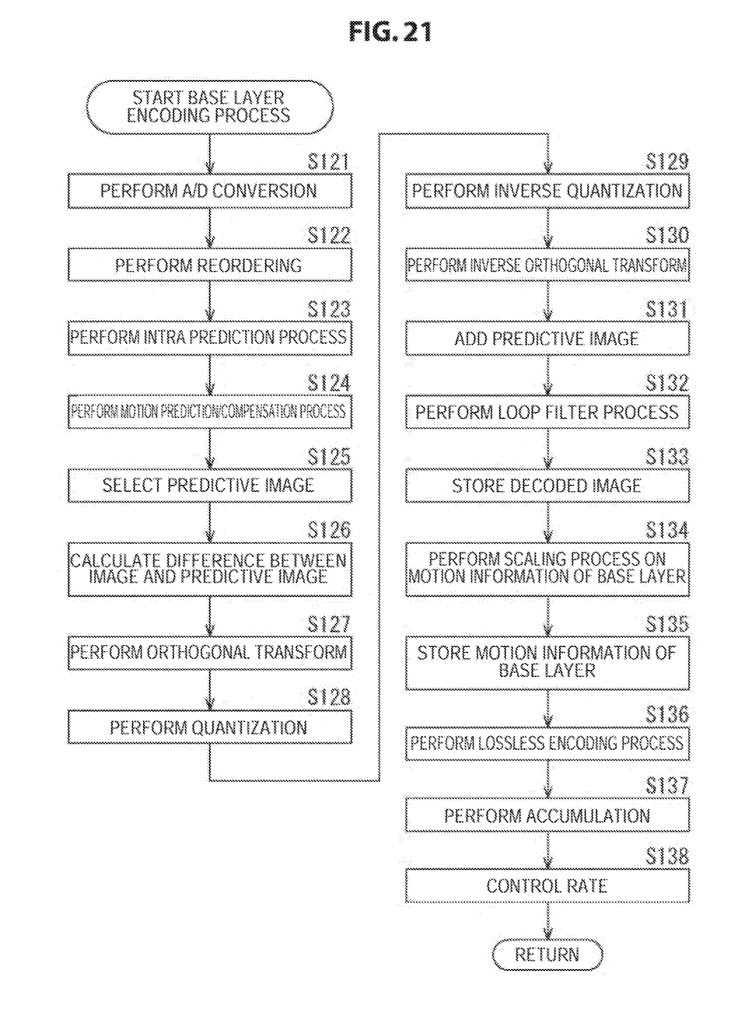

Next, an example of the flow of the base layer encoding process executed in step S103 of FIG. 20 will be described with reference to a flowchart of FIG. 21.

In step S121, the A/D converting section 111 of the base layer image encoding section 103 performs A/D conversion on input image information (image data) of the base layer. In step S122, the screen reordering buffer 112 stores image information (digital data) of the base layer that has been subjected to the A/D conversion, and reorders the pictures arranged in the display order in the encoding order.

In step S123, the intra prediction section 124 performs the intra prediction process in the intra prediction mode. In step S124, the motion prediction/compensation section 125 performs a motion prediction/compensation process in which motion prediction and motion compensation in the inter prediction mode are performed. In step S125, the predictive image selecting section 126 decides an optimal mode based on the cost function values output from the intra prediction section 124 and the motion prediction/compensation section 125. In other words, the predictive image selecting section 126 selects either of the predictive image generated by the intra prediction section 124 and the predictive image generated by the motion prediction/compensation section 125. In step S126, the operation section 113 calculates a difference between the image reordered in the process of step S122 and the predictive image selected in the process of step S125. The differential data is smaller in a data amount than the original image data. Thus, it is possible to compress a data amount to be smaller than when an image is encoded without change.

In step S127, the orthogonal transform section 114 performs the orthogonal transform process on the differential information generated in the process of step S126. In step S128, the quantization section 115 quantizes the orthogonal transform coefficients obtained in the process of step S127 using the quantization parameter calculated by the rate control section 127.

The differential information quantized in the process of step S128 is locally decoded as follows. In other words, in step S129, the inverse quantization section 118 performs inverse quantization on the quantized coefficients (which are also referred to as “quantization coefficients”) quantized in the process of step S128 according to characteristics corresponding to characteristics of the quantization section 115. In step S130, the inverse orthogonal transform section 119 performs the inverse orthogonal transform on the orthogonal transform coefficients obtained in the process of step S127. In step S131, the operation section 120 generates a locally decoded image (an image corresponding to an input of the operation section 113) by adding the predictive image to the locally decoded differential information.

In step S132, the loop filter 121 performs filtering on the image generated in the process of step S131. As a result, for example, block distortion is removed. In step S133, the frame memory 122 stores the image in which, for example, the block distortion has been deleted in the process of step S132. The image that is not subjected to the filter process performed by the loop filter 121 is also supplied from the operation section 120 and stored in the frame memory 122. The image stored in the frame memory 122 is used in the process of step S123 or the process of step S124.

In Step S134, the motion information scaling section 151 of the motion information encoding section 104 performs a scaling process on the motion information of the base layer obtained from the process of Step S124 according to a scaling ratio between the base layer and the enhancement layer in the space direction.

In Step S135, the base layer motion information buffer 152 of the motion information encoding section 104 stores the motion information of the base layer scaling-processed in Step S134.

In step S136, the lossless encoding section 116 of the base layer image encoding section 103 encodes the coefficients quantized in the process of step S128. In other words, lossless coding such as variable length coding or arithmetic coding is performed on data corresponding to the differential image.

At this time, the lossless encoding section 116 encodes information related to the prediction mode of the predictive image selected in the process of step S125, and adds the encoded information to the encoded data obtained by encoding the differential image. In other words, the lossless encoding section 116 also encodes, for example, information according to the optimal intra prediction mode information supplied from the intra prediction section 124 or the optimal inter prediction mode supplied from the motion prediction/compensation section 125, and adds the encoded information to the encoded data.

In step S137, the accumulation buffer 117 accumulates the base layer encoded data obtained in the process of step S136. The base layer encoded data accumulated in the accumulation buffer 117 is appropriately read and transmitted to the decoding side via a transmission path or a recording medium.

In step S138, the rate control section 127 controls the quantization operation of the quantization section 115 based on the coding amount (the generated coding amount) of the encoded data accumulated in the accumulation buffer 117 in step S137 so that no overflow or underflow occurs.

When the process of Step S138 ends, the base layer encoding process ends, and the process returns to the process of FIG. 20. The base layer encoding process is executed in units of, for example, pictures. In other words, the base layer encoding process is executed on each picture of a current layer. However, each process included in the enhancement layer encoding process is performed in the processing unit thereof.

<Flow of the Enhancement Layer Encoding Process>

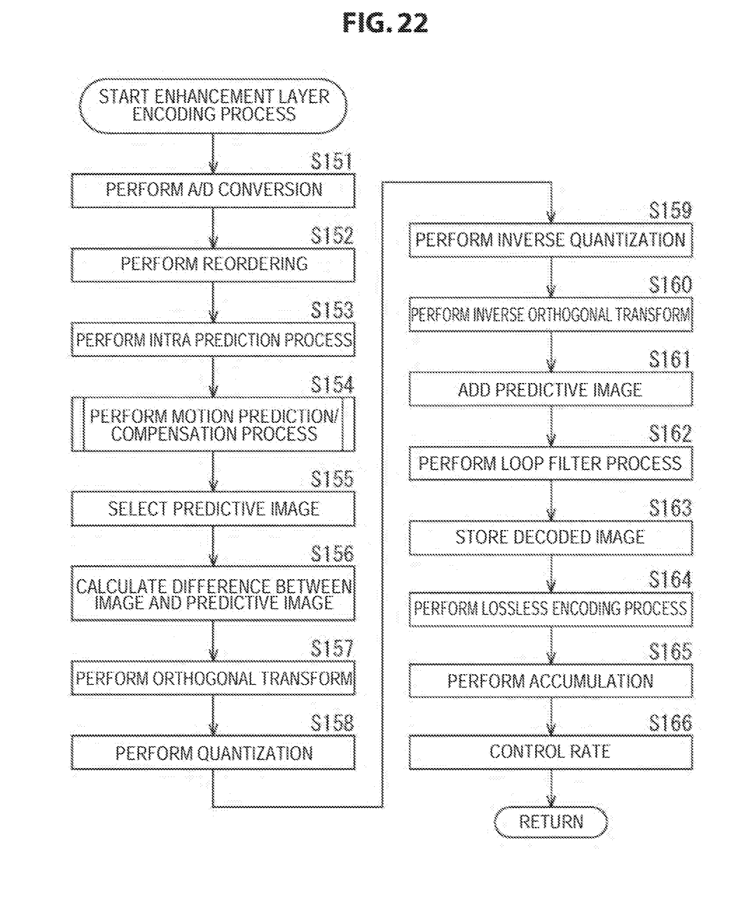

Next, an example of the flow of the enhancement layer encoding process performed in Step S105 of FIG. 20 will be described with reference to the flow chart of FIG. 22.

The processes of Steps S151 to S153 and Steps S155 to S166 of the enhancement layer encoding process are executed in the same manner as the processes of Steps S121 to S123, Steps S125 to S133, and Steps S136 to S138 of the base layer encoding process of FIG. 21. However, the processes of the enhancement layer encoding process are performed on enhancement layer image information by each processing section of the enhancement layer image encoding section 105.

Note that, in Step S154, the motion prediction/compensation section 135 of the enhancement layer image encoding section 105 performs a motion prediction/compensation process on the enhancement layer image information. Details of this motion prediction/compensation process will be described later.

When the process of Step S166 ends, the enhancement layer encoding process ends, and the process returns to the process of FIG. 20. The enhancement layer encoding process is executed in, for example, units of pictures. In other words, the enhancement layer encoding process is executed for each picture of a current layer. However, each process included in the enhancement layer encoding process is performed in the processing unit thereof.

<Flow of the Motion Prediction/Compensation Process>

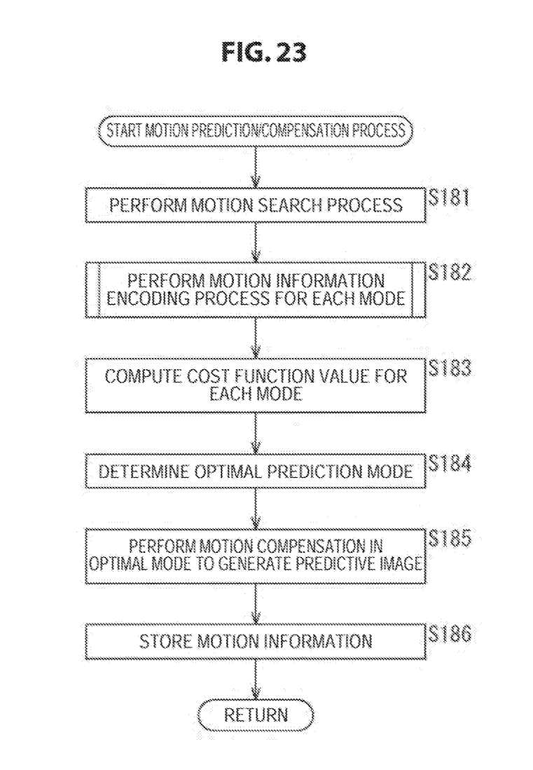

Next, an example of the flow of the motion prediction/compensation process executed in Step S154 of FIG. 22 will be described with reference to the flow chart of FIG. 23.

When the motion prediction/compensation process of the enhancement layer starts, the motion prediction/compensation section 135 of the enhancement layer image encoding section 105 performs a motion search process in each mode in Step S181.

In Step S182, the motion prediction/compensation section 135 performs a motion information encoding process on the motion information for each mode obtained from the process of Step S181. Details of this motion information encoding process will be described later.

In Step S183, the motion prediction/compensation section 135 calculates a cost function value for each mode based on the results of the processes of Step S181 and S182.

In Step S184, the motion prediction/compensation section 135 determines an optimal inter prediction mode based on the cost function value of each mode computed in Step S183.

In Step S185, the motion prediction/compensation section 135 performs motion compensation in the optimal inter prediction mode selected in Step S184 to generate a predictive image. The generated predictive image is supplied to the predictive image selecting section 126 along with information related to the optimal inter prediction mode and the like.

In Step S186, the enhancement layer motion information buffer 153 of the motion information encoding section 104 stores the motion information of the current block of the optimal inter prediction mode selected in Step S184 as motion information of the enhancement layer.

When the process of Step S186 ends, the motion prediction/compensation process ends, and the process returns to the process of FIG. 22.

<Flow of the Motion Information Encoding Process>

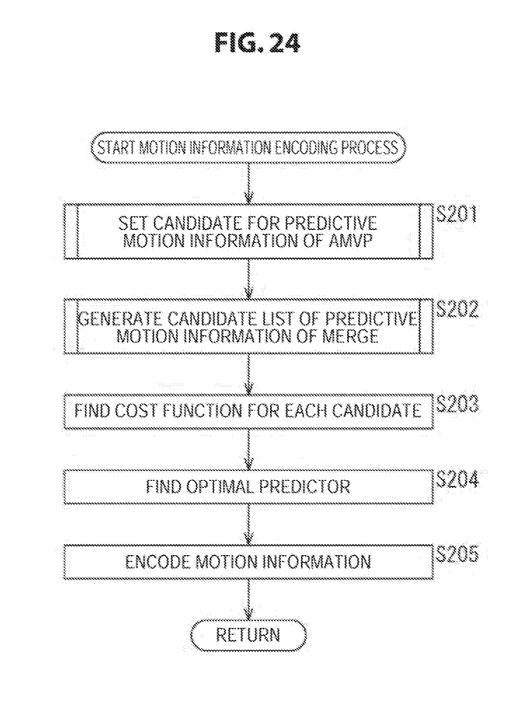

Next, an example of the flow of the motion information encoding process executed in Step S182 of FIG. 23 will be described with reference to the flow chart of FIG. 24.

When the motion information encoding process starts, the AMVP processing section 154 of the motion information encoding section 104 performs an AMVP process to set candidates for the predictive motion information of the AMVP mode in Step S201. Details of the AMVP process will be described later.

In Step S202, the merge processing section 155 of the motion information encoding section 104 performs a merge process to generate a candidate list of the predictive motion information of the merge mode. Details of the merge process will be described later.

In Step S203, the optimal predictor setting section 156 of the motion information encoding section 104 computes cost function values for the respective candidates for the predictive motion information set in Steps S201 and S202.

In Step S204, the optimal predictor setting section 156 finds an optimal predictor based on the cost function values found in Step S203.

In Step S205, the optimal predictor setting section 156 encodes the motion information of the current block of the enhancement layer using the optimal predictor found in Step S204. The optimal predictor setting section 156 supplies the result of the encoding of the motion information (the difference between the motion information and the predictive motion information) to the motion prediction/compensation section 135.

When the process of Step S205 ends, the motion information encoding process ends, and the process returns to the process of FIG. 23.

<Flow of the AMVP Process>

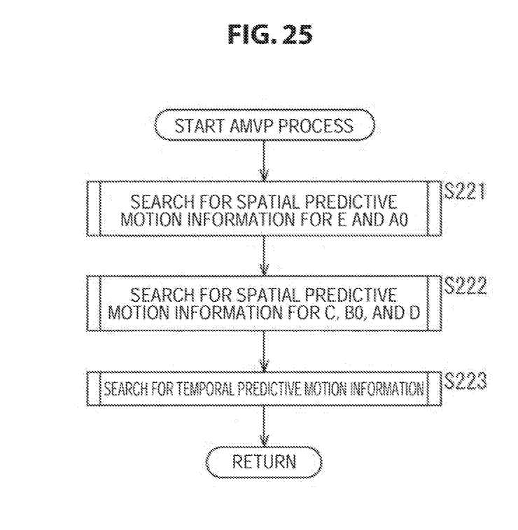

Next, an example of the flow of the AMVP process executed in Step S201 of FIG. 24 will be described with reference to the flow chart of FIG. 25.

When the AMVP process starts, the AMVP processing section 154 searches for spatial predictive motion information that is predictive motion information that uses the motion information of peripheral blocks in the space direction for the peripheral block E and the peripheral block A0 in Step S221.

In Step S222, the AMVP processing section 154 searches for spatial predictive motion information for the peripheral block C, the peripheral block B0, and the peripheral block D. This process is the same process as Step S221 except that the blocks to be processed are different.

In Step S223, the AMVP processing section 154 searches for temporal predictive motion information that is predictive motion information that uses motion information of the peripheral blocks in the time direction.

When the process of Step S223 ends, the AMVP process ends, and the process returns to the process of FIG. 24.

<Flow of the Spatial Predictive Motion Information Search Process>

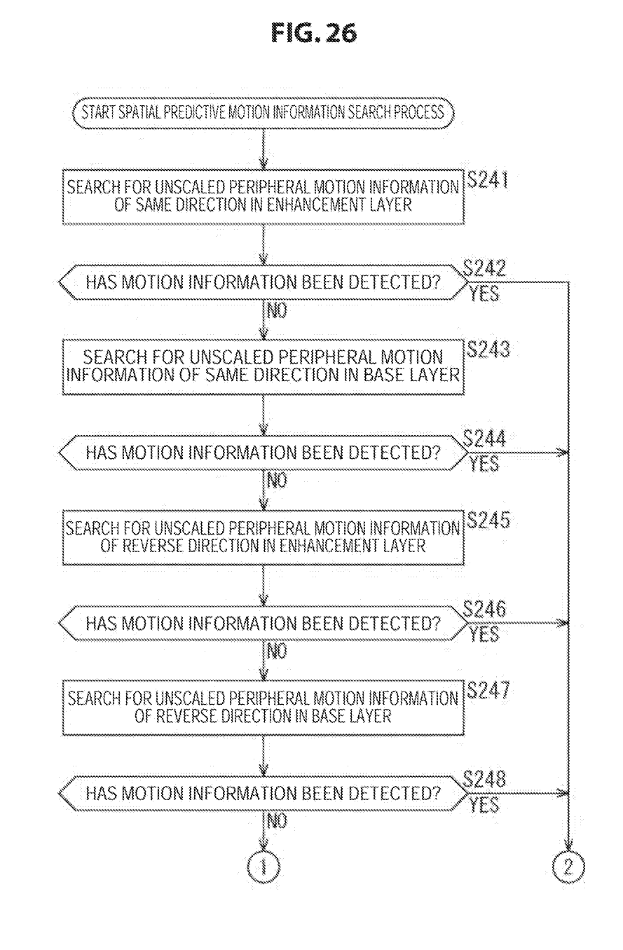

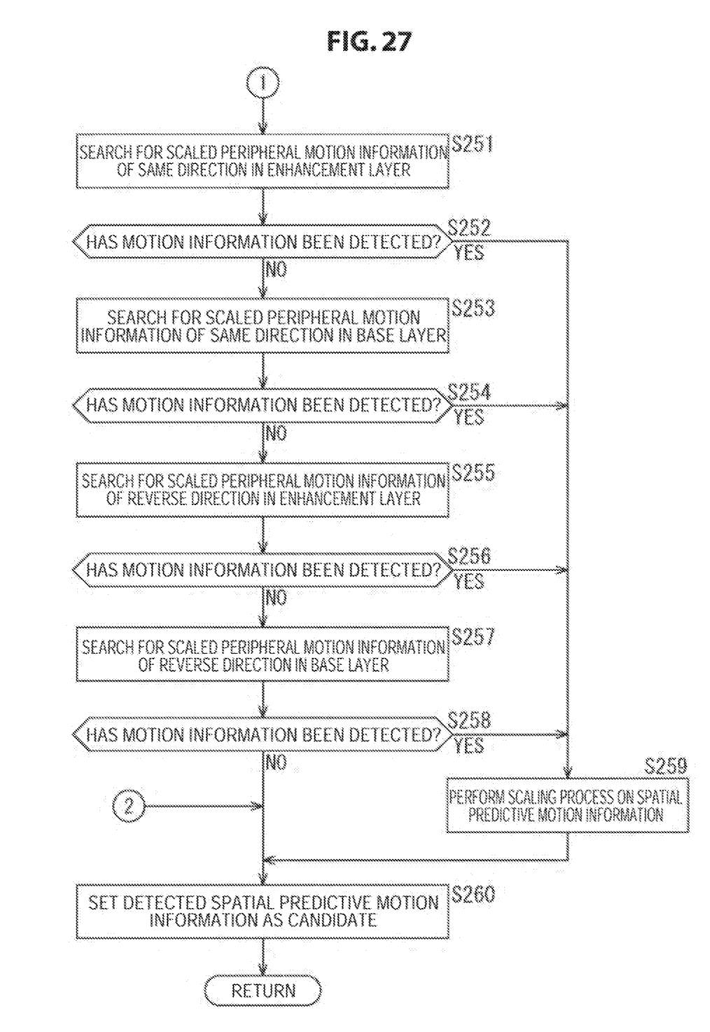

Next, an example of the flow of the spatial predictive motion information search process executed in Steps S221 and S222 of FIG. 25 will be described with reference to the flowchart of FIGS. 26 and 27.

When the spatial predictive motion information search process starts, the candidate setting section 161 of the AMVP processing section 154 acquires the peripheral motion information of the enhancement layer which has the same ref_idx and list as the motion information of the current block from the enhancement layer motion information buffer 153 and causes the availability determination section 162 to determine the availability thereof to search for unscaled peripheral motion information (VEC1) of the same direction in the enhancement layer in Step S241 of FIG. 26.

In Step S242, the candidate setting section 161 determines whether or not the motion information has been detected from the search of Step S241. When the unscaled peripheral motion information (VEC1) of the same direction is determined not to have been detected in the enhancement layer, the process proceeds to Step S243.

In Step S243, the candidate setting section 161 acquires the peripheral motion information of the base layer which has the same ref_idx and list as the motion information of the current block from the base layer motion information buffer 152 and causes the availability determination section 162 to determine the availability thereof to search for unscaled peripheral motion information (VEC1) of the same direction in the base layer.

In Step S244, the candidate setting section 161 determines whether or not the motion information has been detected from the search of Step S243. When the unscaled peripheral motion information (VEC1) of the same direction is determined not to have been detected in the base layer, the process proceeds to Step S245.

In Step S245, the candidate setting section 161 acquires the peripheral motion information of the enhancement layer which has the same ref_idx as and a different list from the motion information of the current block from the enhancement layer motion information buffer 153 and causes the availability determination section 162 to determine the availability thereof to search for scaled peripheral motion information (VEC2) of the reverse direction in the enhancement layer.

In Step S246, the candidate setting section 161 determines whether or not the motion information has been detected from the search of Step S245. When the scaled peripheral motion information (VEC2) of the reverse direction is determined not to have been detected in the enhancement layer, the process proceeds to Step S247.

In Step S247, the candidate setting section 161 acquires the peripheral motion information of the base layer which has the same ref_idx as and a different list from the motion information of the current block from the base layer motion information buffer 152 and causes the availability determination section 162 to determine the availability thereof to search for scaled peripheral motion information (VEC2) of the reverse direction in the base layer.

In Step S248, the candidate setting section 161 determines whether or not the motion information has been detected from the search of Step S247. When the scaled peripheral motion information (VEC2) of the reverse direction is determined not to have been detected in the base layer, the process proceeds to Step S251 of FIG. 27.

In Step S251 of FIG. 27, the candidate setting section 161 acquires the peripheral motion information of the enhancement layer which has a different ref_idx from and the same list as the motion information of the current block from the enhancement layer motion information buffer 153 and causes the availability determination section 162 to determine the availability thereof to search for scaled peripheral motion information (VEC3) of the same direction in the enhancement layer.

In Step S252, the candidate setting section 161 determines whether or not the motion information has been detected from the search of Step S251. When the scaled peripheral motion information (VEC3) of the same direction is determined not to have been detected in the enhancement layer, the process proceeds to Step S253.

In Step S253, the candidate setting section 161 acquires the peripheral motion information of the base layer which has a different ref_idx from and the same list as the motion information of the current block from the base layer motion information buffer 152 and causes the availability determination section 162 to determine the availability thereof to search for scaled peripheral motion information (VEC3) of the same direction in the base layer.

In Step S254, the candidate setting section 161 determines whether or not the motion information has been detected from the search of Step S253. When the scaled peripheral motion information (VEC3) of the same direction is determined not to have been detected in the base layer, the process proceeds to Step S255.

In Step S255, the candidate setting section 161 acquires the peripheral motion information of the enhancement layer which has a different ref_idx and list from the motion information of the current block from the enhancement layer motion information buffer 153 and causes the availability determination section 162 to determine the availability thereof to search for scaled peripheral motion information (VEC4) of the reverse direction in the enhancement layer.

In Step S256, the candidate setting section 161 determines whether or not the motion information has been detected from the search of Step S255. When the scaled peripheral motion information (VEC4) of the reverse direction is determined not to have been detected in the enhancement layer, the process proceeds to Step S257.

In Step S257, the candidate setting section 161 acquires the peripheral motion information of the base layer which has a different ref_idx and list from the motion information of the current block from the base layer motion information buffer 152 and causes the availability determination section 162 to determine the availability thereof to search for scaled peripheral motion information (VEC4) of the reverse direction in the base layer.

In Step S258, the candidate setting section 161 determines whether or not the motion information has been detected from the search of Step S257. When the scaled peripheral motion information (VEC4) of the reverse direction is determined not to have been detected in the base layer, the process proceeds to Step S260.

In addition, when the unscaled peripheral motion information (VEC1) of the same direction is determined to have been detected in the enhancement layer in Step S242 of FIG. 26, when the unscaled peripheral motion information (VEC1) of the same direction is determined to have been detected in the base layer in Step S244 of FIG. 26, when the unscaled peripheral motion information (VEC2) of the reverse direction is determined to have been detected in the enhancement layer in Step S246 of FIG. 26, and when the unscaled peripheral motion information (VEC2) of the reverse direction is determined to have been detected in the base layer in Step S248 of FIG. 26, the process proceeds to Step S260 of FIG. 27.

In addition, when the scaled peripheral motion information (VEC3) of the same direction is determined to have been detected in the enhancement layer in Step S252 of FIG. 27, when the scaled peripheral motion information (VEC3) of the same direction is determined to have been detected in the base layer in Step S254 of FIG. 27, when the scaled peripheral motion information (VEC4) of the reverse direction is determined to have been detected in the enhancement layer in Step S256 of FIG. 27, and when the scaled peripheral motion information (VEC4) of the reverse direction is determined to have been detected in the base layer in Step S258 of FIG. 27, the process proceeds to Step S259 of FIG. 27.

In Step S259, the temporal scaling section 164 performs a scaling process on the detected spatial predictive motion information in the time direction. When the process of Step S259 ends, the process proceeds to Step S260.

In Step S260, the candidate setting section 161 sets the spatial predictive motion information detected as above as a predictor candidate of the AMVP mode, and supplies the information to the optimal predictor setting section 156.

When the process of Step S260 ends, the spatial predictive motion information search process ends, and the process returns to the process of FIG. 25.

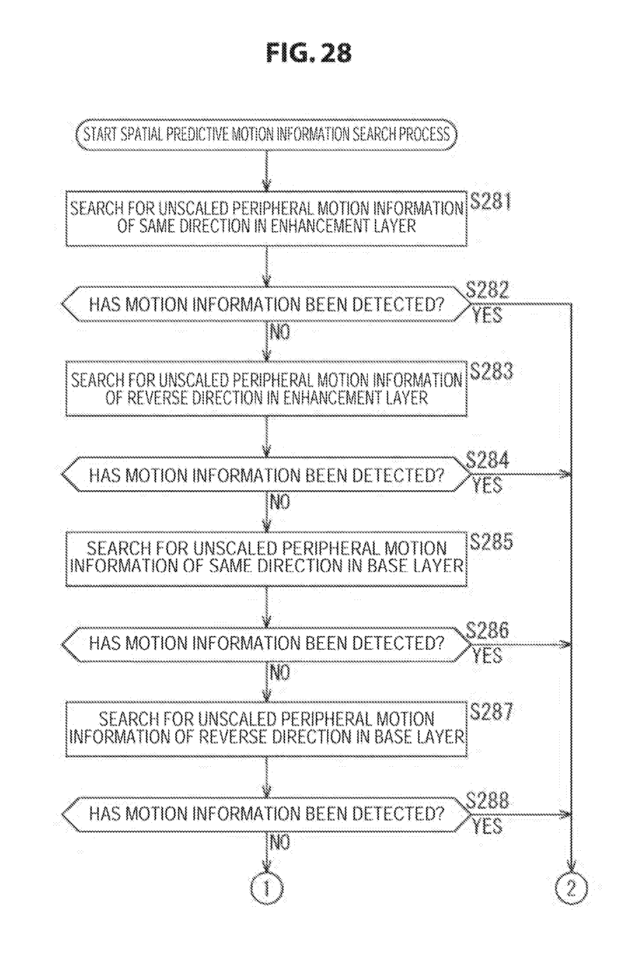

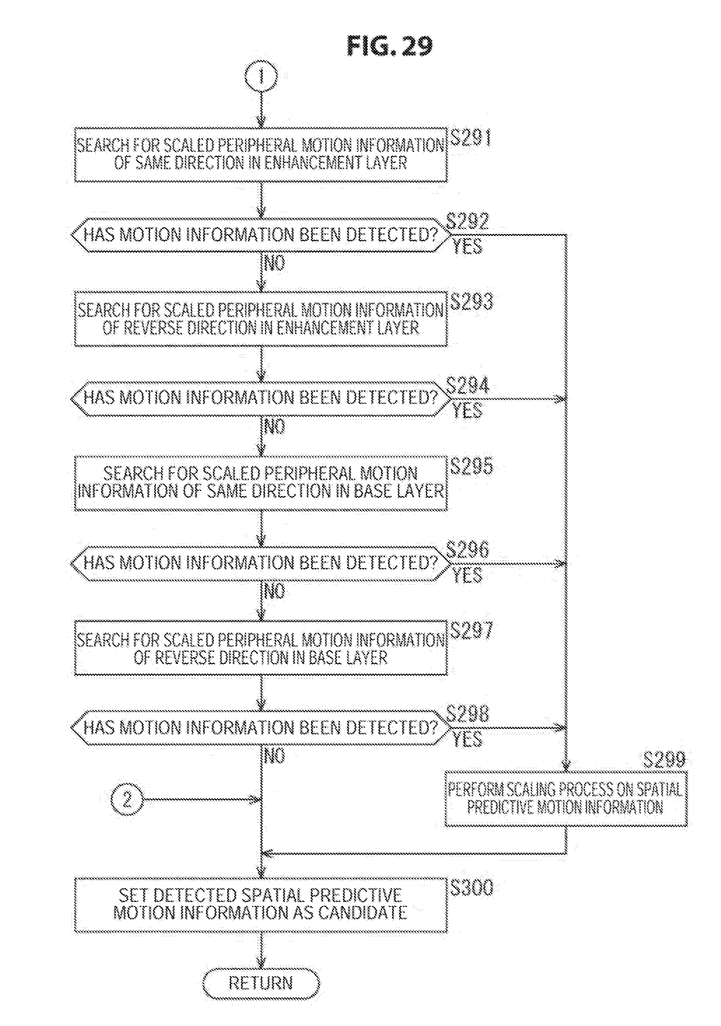

Note that the order of searching for each piece of peripheral motion information may be changed into, for example, the orders shown in the flow chart of FIGS. 28 and 29. In other words, unscaled peripheral motion information (VEC1 and VEC2) for the enhancement layer may be searched for (Steps S281 and S283 of FIG. 28), unscaled peripheral motion information (VEC1 and VEC2) for the base layer may be searched for (Steps S285 and S287 of FIG. 28), scaled peripheral motion information (VEC3 and VEC4) for the enhancement layer may be searched for (Steps S291 and S293 of FIG. 29), and scaled peripheral motion information (VEC3 and VEC4) for the base layer may be searched for (Steps S295 and S297 of FIG. 29).

The temporal predictive motion information search process shown in the flow chart of FIGS. 28 and 29 is executed as in the example shown in the flow chart of FIGS. 26 and 27 except for the order of searching for peripheral motion information.

<Flow of the Temporal Predictive Motion Information Search Process>

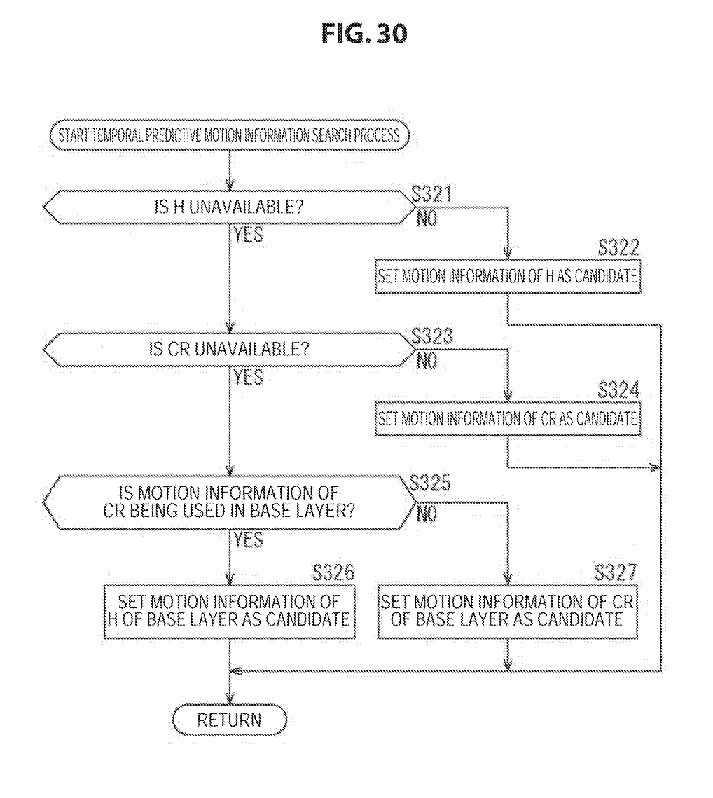

Next, an example of the flow of the temporal predictive motion information search process executed in Step S223 of FIG. 25 will be described with reference to the flow chart of FIG. 30.

When the temporal predictive motion information search process starts, the candidate setting section 161 acquires the motion information of the peripheral block H of the enhancement layer from the enhancement layer motion information buffer 153, and causes the availability determination section 162 to determine the availability thereof to determine whether or not the motion information of the peripheral block H is unavailable in Step S321. When the motion information of the peripheral block H is determined to be available, the process proceeds to Step S322.

In Step S322, the candidate setting section 161 sets the motion information of the peripheral block H as a predictor candidate of the AMVP mode, and supplies the information to the optimal predictor setting section 156. When the process of Step S322 ends, the temporal predictive motion information search process ends, and the process returns to the process of FIG. 25.

In addition, when the motion information of the peripheral block H is determined to be unavailable in Step S321 of FIG. 30, the process proceeds to Step S323.

In Step S323, the candidate setting section 161 acquires the motion information of the peripheral block CR of the enhancement layer from the enhancement layer motion information buffer 153, and causes the availability determination section 162 to determine the availability thereof to determine whether or not the motion information of the peripheral block CR is unavailable. When the motion information of the peripheral block CR is determined to be available, the process proceeds to Step S324.

In Step S324, the candidate setting section 161 sets the motion information of the peripheral block CR as a predictor candidate of the AMVP mode, and supplies the information to the optimal predictor setting section 156. When the process of Step S324 ends, the temporal predictive motion information search process ends, and the process returns to the process of FIG. 25.

In addition, when the motion information of the peripheral block CR is determined to be unavailable in Step S323 of FIG. 30, the process proceeds to Step S325.

In Step S325, the base layer motion information selecting section 165 determines whether or not the motion information of the peripheral block CR is being used as co-located motion information in the base layer. When it is determined that the motion information of the peripheral block CR is being used as co-located motion information in the base layer, the process proceeds to Step S326.

In Step S326, the base layer motion information selecting section 165 selects the peripheral block H of the base layer. The candidate setting section 161 sets the motion information of H of the base layer as a predictor candidate of the AMVP mode based on the selection, and supplies the information to the optimal predictor setting section 156. When the process of Step S326 ends, the temporal predictive motion information search process ends, and the process returns to the process of FIG. 25.

In addition, when it is determined that the motion information of the peripheral block H is being used as co-located motion information in the base layer in Step S325 of FIG. 30, the process proceeds to Step S327.

In Step S327, the base layer motion information selecting section 165 selects the peripheral block CR of the base layer. The candidate setting section 161 sets the motion information of CR of the base layer as a predictor candidate of the AMVP mode based on the selection, and supplies the information to the optimal predictor setting section 156. When the process of Step S327 ends, the temporal predictive motion information search process ends, and the process returns to the process of FIG. 25.

<Flow of the Merge Process>

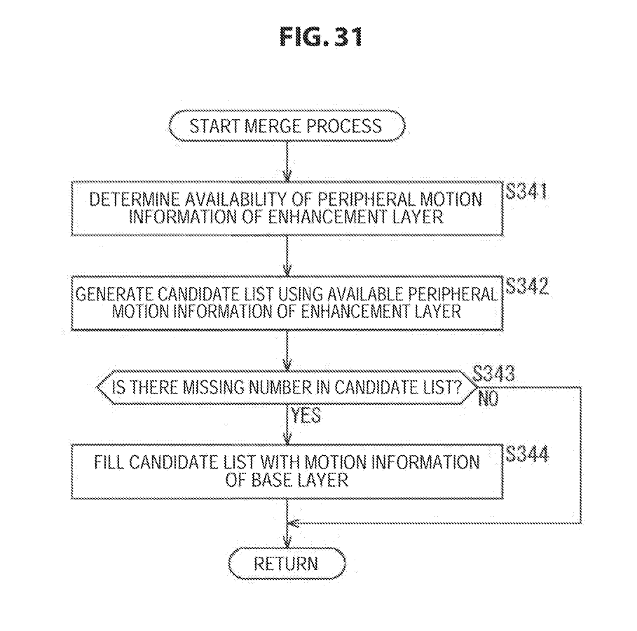

Next, an example of the flow of the merge process executed in Step S202 of FIG. 24 will be described with reference to the flow chart of FIG. 31.

When the merge process starts, the availability determination section 162 of the merge processing section 155 determines the availability of the peripheral motion information of the enhancement layer read by the candidate list generation section 171 from the enhancement layer motion information buffer 153 in Step S341.

In Step S342, the candidate list generation section 171 generates a candidate list of the merge mode using the peripheral motion information of the enhancement layer determined to be available in Step S341.

In Step S343, the candidate list generation section 171 determines whether or not there is a missing number on the candidate list generated as described above. When there is one, the process proceeds to Step S344.

In Step S344, the candidate list generation section 171 reads the peripheral motion information of the base layer from the base layer motion information buffer 152 to cause the availability determination section 174 to determine the availability thereof, and thereby the candidate list is filled with the peripheral motion information of the available base layer.

When the process of Step S344 ends, the merge process ends, and the process returns to the process of FIG. 24. In addition, when no missing number is determined to be on the candidate list in Step S343 of FIG. 31, the process of Step S344 is skipped, then the merge process ends, and the process returns to the process of FIG. 24.

By executing the processes as described above, the scalable encoding device 100 can suppress a decrease in encoding efficiency and deterioration in image quality resulting from encoding and decoding.

<Flow of the Base Layer Motion Information Selection Process>

Note that, when the peripheral block CR6 of FIG. 6 is set as a co-located block and the motion information thereof is used as collocated motion information in the base layer as described above, a filling process is performed using the motion information of the peripheral block H6, and when the motion information of the peripheral block H6 is used as co-located motion information in the base layer, the filling process is performed using the motion information of the peripheral block CR6.

In this case, the base layer motion information selecting section 175 performs a base layer motion information selection process.

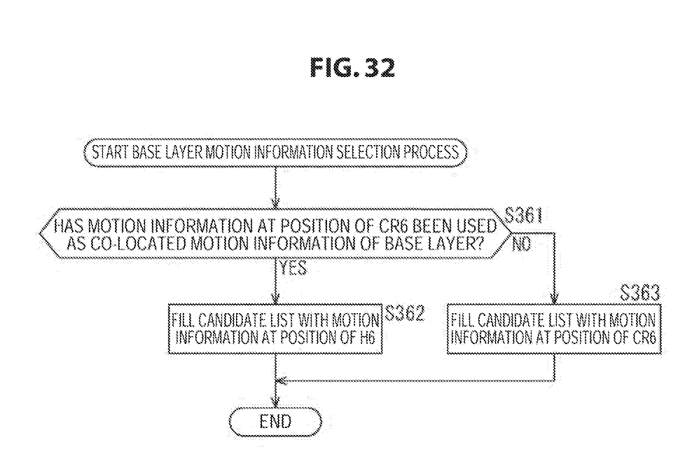

An example of the flow of the base layer motion information selection process will be described with reference to FIG. 32.

When the base layer motion information selection process starts, the base layer motion information selecting section 175 determines whether or not the motion information of the peripheral block CR6 has been used as co-located motion information of the base layer in Step S361. When the motion information of the peripheral block CR6 is determined to have been used as co-located motion information in encoding of the base layer, the process proceeds to Step S362.

When the candidate list generation section 171 uses the peripheral motion information of the base layer in the time direction as a filling, the base layer motion information selecting section 175 sets the candidate list to be filled with the motion information of the peripheral block H6 in Step S362. When the process of Step S362 ends, the base layer motion information selection process ends.

In addition, in Step S361, when the motion information of the peripheral block H6 is determined to have been used in co-located motion information in encoding of the base layer, the process proceeds to Step S363.

In Step S363, when the candidate list generation section 171 performs filling with the peripheral motion information of the base layer in the time direction, the base layer motion information selecting section 175 sets the candidate list to be filled with the motion information of the peripheral block CR6. When the process of Step S363 ends, the base layer motion information selection process ends.

When filling the candidate list with the peripheral motion information of the base layer in the time direction in Step S344 of the merge process of FIG. 31, the candidate list generation section 171 fills the list with the motion information of the peripheral block CR6 or the peripheral block H6 that is set in Step S362 or Step S363 of the base layer motion information selection process.

With the operation as described above, the scalable encoding device 100 can suppress a decrease in encoding efficiency and deterioration in image quality resulting from encoding and decoding.

<Flow of the Layer Control Process>

In addition, a base layer predictor may be set to be used in the candidate list as described above, instead of a temporal prediction of HEVC of a single layer.

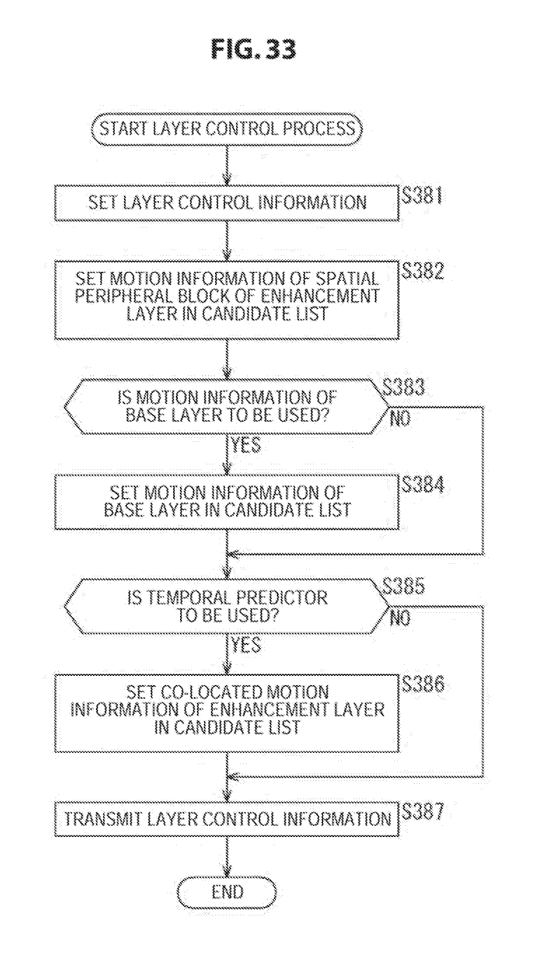

An example of the flow of the layer control process executed to control whether a temporal predictor is to be used or a base layer predictor is to be used in generation of the candidate list will be described with reference to the flow chart of FIG. 33.

When the layer control process starts, the layer control information setting section 172 sets layer control information for controlling whether a temporal predictor is to be used or a base layer predictor is to be used in generation of the candidate list in Step S381.

In Step S382, the candidate list generation section 171 sets motion information of a spatial peripheral block of the enhancement layer in the candidate list. At this time, the candidate list generation section 171 sets the motion information of the spatial peripheral block in the candidate list by performing, for example, the merge process as described with reference to the flow chart of FIG. 31.

In Step S383, the layer control section 173 determines whether or not the candidate list will be generated using the motion information of the base layer instead of a temporal predictor based on the layer control information set in Step S381. For example, when the value of the parameter sps_col_mvp indicator and the parameter slice_col_mvp indicator is “1” or “3” and it is determined to generate the candidate list using the motion information of the base layer, the process proceeds to Step S384.

In Step S384, the candidate list generation section 171 sets the motion information of the base layer in the candidate list as co-located motion information. Note that when the motion information of the base layer is unavailable, a temporal predictor may be set to be used to fill a missing number list.

When the process of Step S384 ends, the process proceeds to Step S385. In addition, when it is determined to generate the candidate list without using the motion information of the base layer in Step S383, the process proceeds to Step S385.

In Step S385, the layer control section 173 determines whether or not the candidate list will be generated using the temporal predictor based on the layer control information set in Step S381. For example, when the value of the parameter sps_col_mvp indicator and the parameter slice_col_mvp indicator is “2” or “3” and it is determined to generate the candidate list using the temporal predictor, the process proceeds to Step S386.

In Step S386, the candidate list generation section 171 sets the temporal predictor in the candidate list as co-located motion information. Note that when the temporal predictor is unavailable, the motion information of the base layer may be set to be used to fill a missing number list.

When the process of Step S386 ends, the process proceeds to Step S387. In addition, when it is determined to generate the candidate list without using the temporal predictor in Step S385, the process proceeds to Step S387.

In Step S387, the layer control information setting section 172 supplies the layer control information set in Step S381 to the lossless encoding section 116 of the enhancement layer image encoding section 105 to cause the information to be transmitted to the decoding side.

When the process of Step S387 ends, the layer control process ends.

With the operation performed as described above, the scalable encoding device 100 can suppress a decrease in encoding efficiency and deterioration in image quality resulting from encoding and decoding.

### 2. Second Embodiment

### Scalable Decoding Device

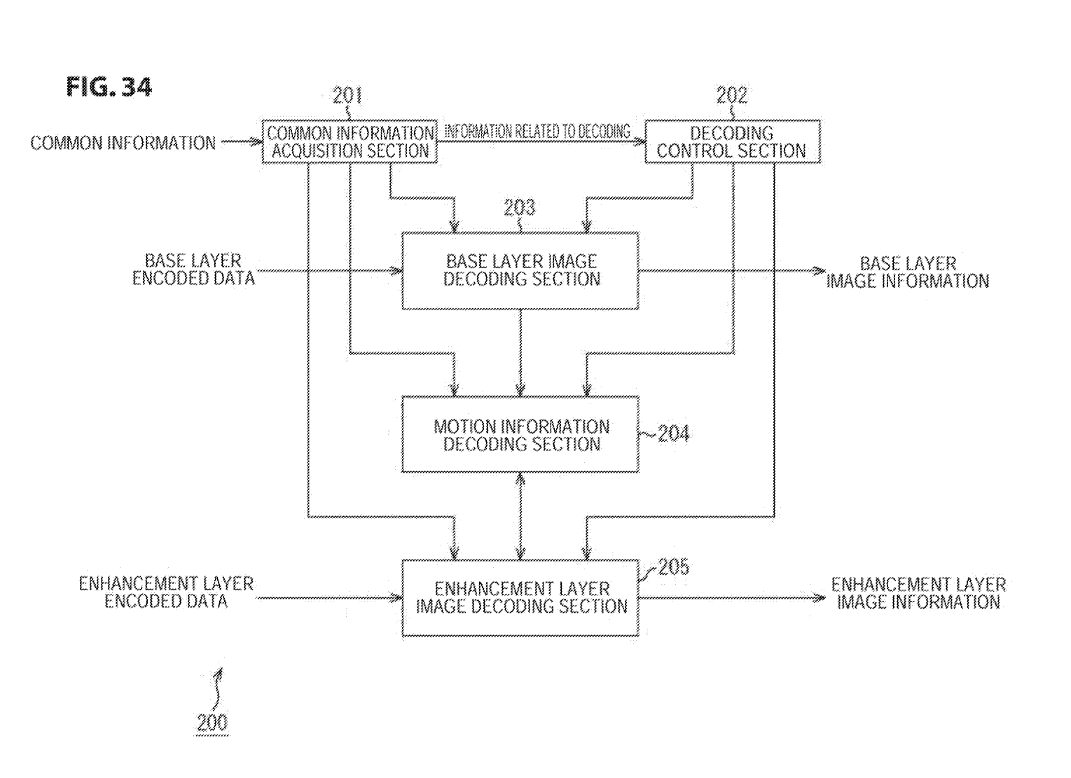

Next, decoding of the encoded data (bitstream) that has been subjected to the scalable video coding as described above will be described. FIG. 34 is a block diagram illustrating an example of a main configuration of a scalable decoding device corresponding to the scalable encoding device 100 of FIG. 16. For example, a scalable decoding device 200 illustrated in FIG. 34 performs scalable decoding on the encoded data obtained by performing the scalable encoding on the image data through the scalable encoding device 100 according to a method corresponding to the encoding method.

As illustrated in FIG. 34, the scalable decoding device 200 has a common information acquisition section 201, a decoding control section 202, a base layer image decoding section 203, a motion information decoding section 204, and an enhancement layer image decoding section 205.

The common information acquisition section 201 acquires common information transmitted from the encoding side (for example, a video parameter set (VPS)). The common information acquisition section 201 extracts information related to decoding from the acquired common information and supplies the information to the decoding control section 202. In addition, the common information acquisition section 201 appropriately supplies part or all of the common information to the base layer image decoding section 203 to the enhancement layer image decoding section 205.

The decoding control section 202 acquires the information related to decoding supplied from the common information acquisition section 201, and controls decoding of each layer by controlling the base layer image decoding section 203 to the enhancement layer image decoding section 205 based on the information.

The base layer image decoding section 203 is an image decoding section which corresponds to the base layer image encoding section 103, and acquires base layer encoded data obtained by, for example, the base layer image encoding section 103 encoding base layer image information. The base layer image decoding section 203 decodes the base layer encoded data to reconstruct the base layer image information without using information of another layer and outputs the data. In addition, the base layer image decoding section 203 supplies motion information obtained in the decoding to the motion information decoding section 204.

The motion information decoding section 204 decodes the motion information transmitted from the encoding side that is used in a motion compensation process in the enhancement layer image decoding section 205. The difference between the motion information and predictive motion information is transmitted from the encoding side. The motion information decoding section 204 generates the predictive motion information using peripheral motion information, and acquires the motion information from the difference transmitted from the encoding side using the predictive motion information. When generating the predictive motion information, the motion information decoding section 204 uses the motion information acquired from the enhancement layer image decoding section 205 as peripheral motion information. However, when the motion information is unavailable, the motion information decoding section 204 uses available motion information acquired from the base layer image decoding section 203 as peripheral motion information instead of the unavailable motion information. The motion information decoding section 204 decodes motion information of a current block using the predictive motion information generated as described above, and returns the result of the encoding to the enhancement layer image decoding section 205.

The enhancement layer image decoding section 205 is an image decoding section corresponding to the enhancement layer image encoding section 105, and acquires, for example, the enhancement layer encoded data obtained by encoding the enhancement layer image information through the enhancement layer image encoding section 105. The enhancement layer image decoding section 205 decodes the enhancement layer encoded data. At this time, the enhancement layer image decoding section 205 causes the motion information decoding section 204 to decode the encoded data of the motion information transmitted from the encoding side (the difference between the motion information and the predictive motion information). The enhancement layer image decoding section 205 performs motion compensation using the motion information obtained from the decoding to generate a predictive image, reconstructs enhancement layer image information using the predictive image, and outputs the information.

<Base Layer Image Decoding Section>

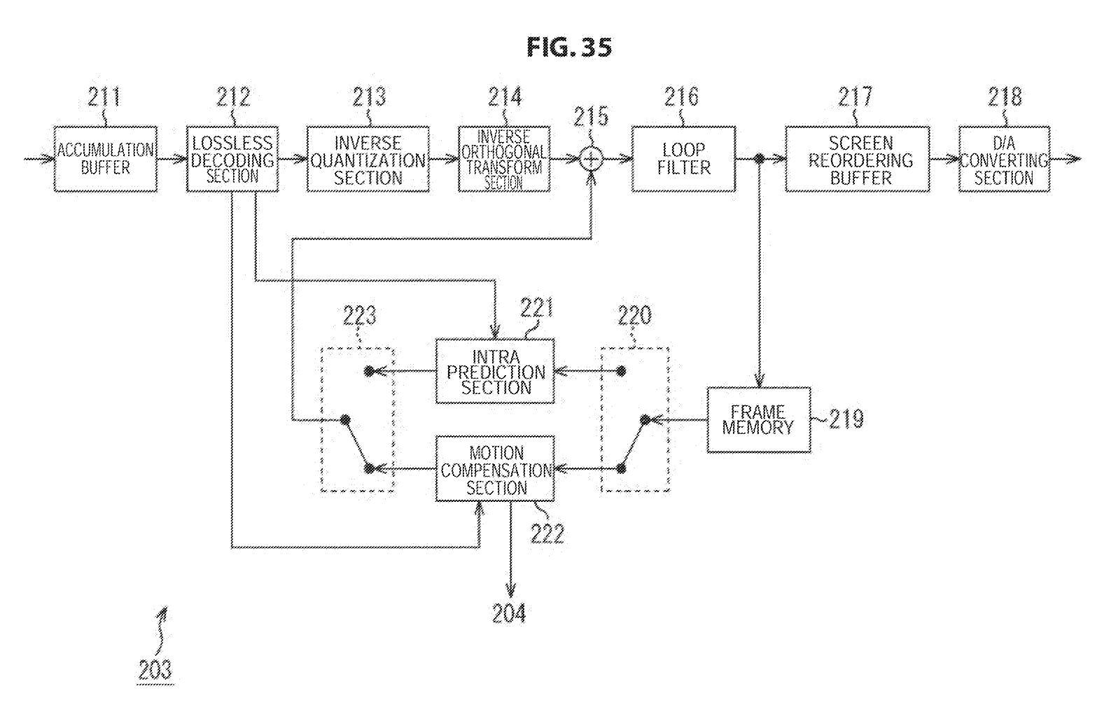

FIG. 35 is a block diagram illustrating an example of a main configuration of the base layer image decoding section 203 of FIG. 34. As illustrated in FIG. 35, the base layer image decoding section 203 includes an accumulation buffer 211, a lossless decoding section 212, an inverse quantization section 213, an inverse orthogonal transform section 214, an operation section 215, a loop filter 216, a screen reordering buffer 217, and a D/A converting section 218. The base layer image decoding section 203 further includes a frame memory 219, a selecting section 220, an intra prediction section 221, a motion compensation section 222, and a selecting section 223.

The accumulation buffer 211 is a receiving section that receives the transmitted base layer encoded data. The accumulation buffer 211 receives and accumulates the transmitted base layer encoded data, and supplies the encoded data to the lossless decoding section 212 at a certain timing. Information necessary for decoding of the prediction mode information or the like is added to the base layer encoded data.

The lossless decoding section 212 decodes the information that has been encoded by the lossless encoding section 116 and supplied from the accumulation buffer 211 according to a scheme corresponding to the encoding scheme of the lossless encoding section 116. The lossless decoding section 212 supplies quantized coefficient data of a differential image obtained by the decoding to the inverse quantization section 213.

Further, the lossless decoding section 212 appropriately extracts and acquires the NAL unit including the video parameter set (VPS), the sequence parameter set (SPS), the picture parameter set (PPS), and the like which are included in the base layer encoded data. The lossless decoding section 212 extracts the information related to the optimal prediction mode from the information, determines which of the intra prediction mode and the inter prediction mode has been selected as the optimal prediction mode based on the information, and supplies the information related to the optimal prediction mode to one of the intra prediction section 221 and the motion compensation section 222 that corresponds to the mode determined to have been selected. In other words, for example, in the base layer image encoding section 103, when the intra prediction mode is selected as the optimal prediction mode, the information related to the optimal prediction mode is supplied to the intra prediction section 221. Further, for example, in the base layer image encoding section 103, when the inter prediction mode is selected as the optimal prediction mode, the information related to the optimal prediction mode is supplied to the motion compensation section 222.

Further, the lossless decoding section 212 extracts information necessary for inverse quantization such as the quantization matrix or the quantization parameter from the NAL unit, and supplies the extracted information to the inverse quantization section 213.

The inverse quantization section 213 inversely quantizes the quantized coefficient data obtained through the decoding performed by the lossless decoding section 212 according to a scheme corresponding to the quantization scheme of the quantization section 115. The inverse quantization section 213 is the same processing section as the inverse quantization section 118. In other words, the description of the inverse quantization section 213 can be applied to the inverse quantization section 118 as well. Here, it is necessary to appropriately change and read a data input/output destination or the like according to a device. The inverse quantization section 213 supplies the obtained coefficient data to the inverse orthogonal transform section 214.

The inverse orthogonal transform section 214 performs the inverse orthogonal transform on the coefficient data supplied from the inverse quantization section 213 according to a scheme corresponding to the orthogonal transform scheme of the orthogonal transform section 114. The inverse orthogonal transform section 214 is the same processing section as the inverse orthogonal transform section 119. In other words, the description of the inverse orthogonal transform section 214 can be applied to the inverse orthogonal transform section 119 as well. Here, it is necessary to appropriately change and read a data input/output destination or the like according to a device

The inverse orthogonal transform section 214 obtains decoded residual data corresponding to residual data that is not subjected to the orthogonal transform in the orthogonal transform section 114 through the inverse orthogonal transform process. The decoded residual data obtained through the inverse orthogonal transform is supplied to the operation section 215. Further, the predictive image is supplied from the intra prediction section 221 or the motion compensation section 222 to the operation section 215 via the selecting section 223.

The operation section 215 adds the decoded residual data and the predictive image, and obtains decoded image data corresponding to the image data from which the predictive image is not subtracted by the operation section 113. The operation section 215 supplies the decoded image data to the loop filter 216.

The loop filter 216 appropriately performs the filter process such as the deblock filter or the adaptive loop filter on the supplied decoded image, and supplies the resultant image to the screen reordering buffer 217 and the frame memory 219. For example, the loop filter 216 removes the block distortion of the decoded image by performing the deblock filter process on the decoded image. Further, for example, the loop filter 216 improves the image quality by performing the loop filter process on the deblock filter process result (the decoded image from which the block distortion has been removed) using the Wiener filter. The loop filter 216 is the same processing section as the loop filter 121.

Further, the decoded image output from the operation section 215 can be supplied to the screen reordering buffer 217 or the frame memory 219 without intervention of the loop filter 216. In other words, part or all of the filter process performed by the loop filter 216 can be omitted.

The screen reordering buffer 217 reorders the decoded image. In other words, the order of the frames reordered in the encoding order by the screen reordering buffer 112 is reordered in the original display order. The D/A converting section 218 performs D/A conversion on the image supplied from the screen reordering buffer 217, and outputs the converted image to be displayed on a display (not illustrated).

The frame memory 219 stores the supplied decoded image, and supplies the stored decoded image to the selecting section 220 as the reference image at a certain timing or based on an external request, for example, from the intra prediction section 221, the motion compensation section 222, or the like.

The selecting section 220 selects the supply destination of the reference image supplied from the frame memory 219. When an image encoded by the intra coding is decoded, the selecting section 220 supplies the reference image supplied from the frame memory 219 to the intra prediction section 221. Further, when an image encoded by the inter coding is decoded, the selecting section 220 supplies the reference image supplied from the frame memory 219 to the motion compensation section 222.

For example, the information indicating the intra prediction mode obtained by decoding the header information is appropriately supplied from the lossless decoding section 212 to the intra prediction section 221. The intra prediction section 221 generates the predictive image by performing the intra prediction using the reference image acquired from the frame memory 219 in the intra prediction mode used in the intra prediction section 124. The intra prediction section 221 supplies the generated predictive image to the selecting section 223.

The motion compensation section 222 acquires information (optimal prediction mode information, reference image information, and the like) obtained by decoding the header information from the lossless decoding section 212.

The motion compensation section 222 generates the predictive image by performing the motion compensation using the reference image acquired from the frame memory 219 in the inter prediction mode indicated by the optimal prediction mode information acquired from the lossless decoding section 212.

The motion compensation section 222 supplies the generated predictive image to the selecting section 223. In addition, the motion compensation section 222 supplies motion information of a current block used in generation of the predictive image (motion compensation) to the motion information decoding section 204.

The selecting section 223 supplies the predictive image supplied from the intra prediction section 221 or the predictive image supplied from the motion compensation section 222 to the operation section 215. Then, the operation section 215 adds the predictive image generated using the motion vector to the decoded residual data (the differential image information) supplied from the inverse orthogonal transform section 214 to decode the original image.

<Enhancement Layer Image Encoding Section>

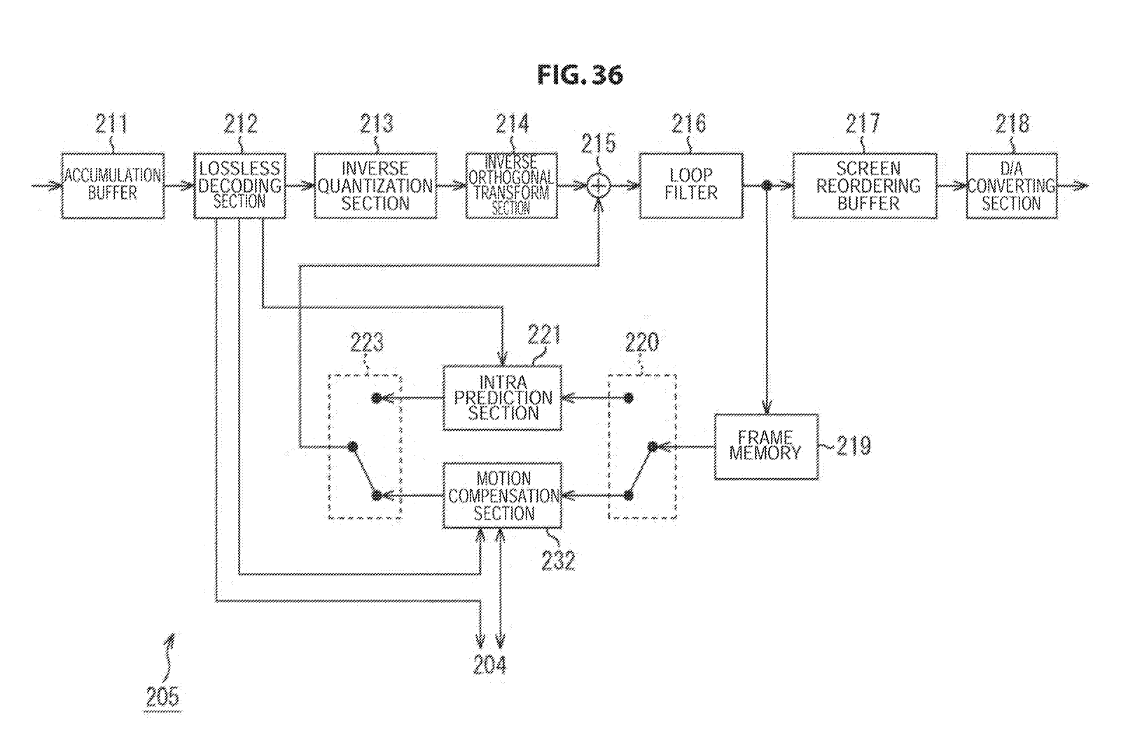

FIG. 36 is a block diagram illustrating a main configuration example of the enhancement layer image decoding section 205 of FIG. 34. As illustrated in FIG. 36, the enhancement layer image decoding section 205 basically has the same configuration as the base layer image decoding section 203 of FIG. 35.

However, respective sections of the enhancement layer image decoding section 205 perform processes for decoding enhancement layer encoded data rather than the base layer. In other words, the accumulation buffer 211 of the enhancement layer image decoding section 205 stores the enhancement layer encoded data, and the D/A converting section 218 of the enhancement layer image decoding section 205 outputs enhancement layer image information to, for example, a recording device (recording medium) provided in the later stage but not illustrated, a transmission path, or the like.

In addition, the enhancement layer image decoding section 205 has a motion compensation section 232 instead of the motion compensation section 222.

The motion compensation section 232 decodes the encoded motion information transmitted from the encoding side using the motion information decoding section 204. In other words, while the motion compensation section 222 decodes the encoded motion information of the current block using only the peripheral motion information of the base layer, the motion compensation section 232 can decode the encoded motion information of the current block using not only the peripheral motion information of the enhancement layer but also the peripheral motion information of the base layer.

Motion information is transmitted from the encoding side as the difference of predictive motion information (differential motion information). The motion compensation section 232 supplies the differential motion information to the motion information decoding section 204 to reconstruct motion information. The motion compensation section 232 acquires the reconstructed motion information and performs motion compensation using the motion information.

<Motion Information Decoding Section>

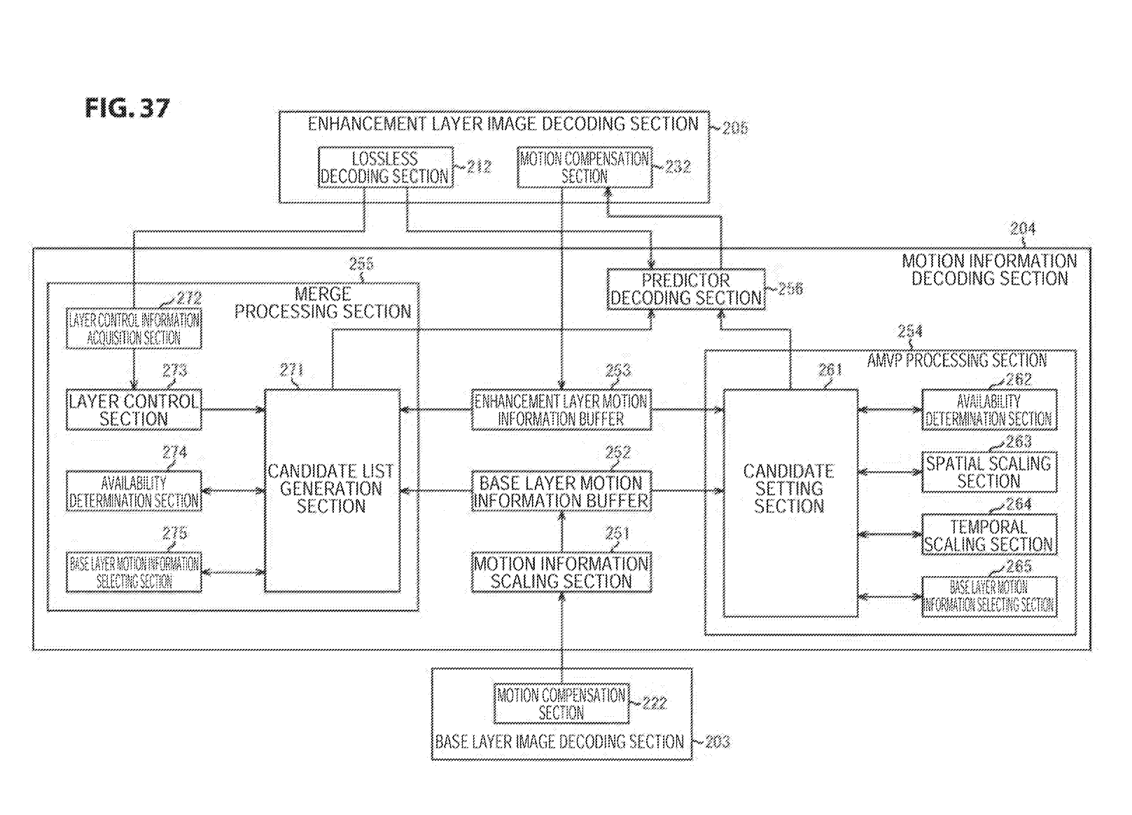

FIG. 37 is a block diagram illustrating a main configuration example of the motion information decoding section 204 of FIG. 34.

As illustrated in FIG. 37, the motion information decoding section 204 has a motion information scaling section 251, a base layer motion information buffer 252, an enhancement layer motion information buffer 253, an AMVP processing section 254, a merge processing section 255, and a predictor decoding section 256.

The motion information scaling section 251 acquires the motion information of the base layer from the motion compensation section 222 of the base layer image decoding section 203, and performs a scaling process on the motion information in the space direction according to a scaling ratio between the base layer and the enhancement layer in the space direction (for example, a resolution ratio). The motion information scaling section 251 supplies the scaling-processed motion information to the base layer motion information buffer 252.

The base layer motion information buffer 252 stores the scaling-processed motion information of the base layer supplied from the motion information scaling section 251. The base layer motion information buffer 252 appropriately supplies the stored motion information of the base layer to the AMVP processing section 254 (a candidate setting section 261) or the merge processing section 255 (a candidate list generation section 271) as the motion information of the base layer.

The enhancement layer motion information buffer 253 acquires and stores the motion information of the current block supplied from the motion compensation section 232 of the enhancement layer image decoding section 205. The enhancement layer motion information buffer 253 appropriately supplies the stored motion information of the enhancement layer to the AMVP processing section 254 (the candidate setting section 261) or the merge processing section 255 (the candidate list generation section 271) as peripheral motion information of the enhancement layer.

The AMVP processing section 254 sets a candidate for predictive motion information corresponding to the motion information of the current block of the enhancement layer in the AMVP mode. At this time, the AMVP processing section 254 acquires the motion information of the enhancement layer stored in the enhancement layer motion information buffer 253 as peripheral motion information when necessary. In addition, the AMVP processing section 254 acquires the motion information of the base layer stored in the base layer motion information buffer 252 as peripheral motion information when necessary. The AMVP processing section 254 sets candidates for predictive motion information using the peripheral motion information. The AMVP processing section 254 supplies the set candidates for predictive motion information to the predictor decoding section 256.

The merge processing section 255 generates a candidate list of predictive motion information that corresponds to the motion information of the current block of the enhancement layer in the merge mode. At this time, the merge processing section 255 acquires the motion information of the enhancement layer stored in the enhancement layer motion information buffer 253 as peripheral motion information when necessary. In addition, the merge processing section 255 acquires the motion information of the base layer stored in the base layer motion information buffer 252 as peripheral motion information when necessary. The merge processing section 255 generates a candidate list using the peripheral motion information. The merge processing section 255 supplies the generated candidate list to the predictor decoding section 256.

The predictor decoding section 256 reconstructs the predictive motion information of the current block of the enhancement layer supplied from the motion compensation section 232 of the enhancement layer image decoding section 205 from the candidate for the predictive motion information supplied from the AMVP processing section 254 and the candidate list supplied from the merge processing section 255 based on information related to inter prediction supplied from the motion compensation section 232 of the enhancement layer image decoding section 205, and reconstructs motion information by adding the reconstructed predictive motion information to differential motion information supplied from the motion compensation section 232 of the enhancement layer image decoding section 205.

The predictor decoding section 256 supplies the motion information of the current block of the enhancement layer obtained as described above to the motion compensation section 232.

As illustrated in FIG. 37, the AMVP processing section 254 has a candidate setting section 261, an availability determination section 262, a spatial scaling section 263, a temporal scaling section 264, and a base layer motion information selecting section 265.

The candidate setting section 261 sets a candidate for predictive motion information of a current block of the enhancement layer. The candidate setting section 261 acquires peripheral motion information of the enhancement layer from the enhancement layer motion information buffer 253 and sets the peripheral motion information as a candidate for predictive motion information.

The candidate setting section 261 supplies the peripheral motion information of the enhancement layer to the availability determination section 262 to cause the availability of the peripheral motion information to be determined, and then acquires the result of the determination. When the peripheral motion information of the enhancement layer is unavailable, the candidate setting section 261 acquires peripheral motion information of the base layer from the base layer motion information buffer 252, and sets the peripheral motion information of the base layer as a candidate for predictive motion information, instead of the motion information of the enhancement layer.

The candidate setting section 261 supplies the peripheral motion information to the spatial scaling section 263 when a scaling process in the space direction is necessary to cause the spatial scaling section to perform the scaling process in the space direction, and thereby acquires scaling-processed peripheral motion information.

The candidate setting section 261 supplies the peripheral motion information to the temporal scaling section 264 when a scaling process in the time direction is necessary to cause the temporal scaling section to perform the scaling process in the time direction, and thereby acquires scaling-processed peripheral motion information.

The candidate setting section 261 uses the motion information of the base layer selected by the base layer motion information selecting section 265 when the motion information of the base layer is used for co-located motion information, instead of the motion information of the enhancement layer.

The candidate setting section 261 supplies the set candidate for predictive motion information to the predictor decoding section 256.

The availability determination section 262 determines the availability of the motion information supplied from the candidate setting section 261 and then supplies the result of the determination to the candidate setting section 261.

The spatial scanning section 263 performs a scaling process on the motion information supplied from the candidate setting section 261 in the space direction, and supplies the scaling-processed motion information to the candidate setting section 261.

The temporal scaling section 264 performs a scaling process on the motion information supplied from the candidate setting section 261 in the time direction, and supplies the scaling-processed motion information to the candidate setting section 261.

The base layer motion information selecting section 265 selects the motion information of the base layer used by the candidate setting section 261 as co-located motion information according to the result of decoding of the base layer performed by the base layer image decoding section 203. To be more specific, the base layer motion information selecting section 265 selects the motion information of the base layer that is not being used as co-located motion information in decoding of the base layer as co-located motion information of the enhancement layer. For example, when the motion information of the peripheral block CR6 of the base layer has been used as co-located motion information in decoding of the base layer, the base layer motion information selecting section 265 selects the motion information of the peripheral block H6 of the base layer as co-located motion information for decoding of the enhancement layer. In addition, for example, when the motion information of the peripheral block H6 of the base layer has been used as co-located motion information in decoding of the base layer, the base layer motion information selecting section 265 selects the motion information of the peripheral block CR6 of the base layer as co-located motion information for decoding of the enhancement layer.

As described above, the candidate setting section 261 uses the motion information of the base layer selected by the base layer motion information selecting section 265 as above when the motion information of the base layer is used instead of the motion information of the enhancement layer as co-located motion information in decoding of the enhancement layer.

In addition, as illustrated in FIG. 37, the merge processing section 255 has a candidate list generation section 271, a layer control information acquisition section 272, a layer control section 273, an availability determination section 274, and a base layer motion information selecting section 275.

The candidate list generation section 271 generates a candidate list of the merge mode for obtaining predictive motion information of a current block of the enhancement layer by the enhancement layer image decoding section 205.

The candidate list generation section 271 acquires the peripheral motion information of the enhancement layer from the enhancement layer motion information buffer 253 and generates a candidate list using the peripheral motion information.

When being controlled by the layer control section 273 to generate a candidate list using the motion information of the base layer, the candidate list generation section 271 acquires the peripheral motion information of the base layer from the base layer motion information buffer 252, and thereby generates a candidate list using the peripheral motion information. For example, when generating a candidate list using a base layer predictor rather than a temporal predictor under control of the layer control section 273, the candidate list generation section 271 acquires the peripheral motion information of the base layer from the base layer motion information buffer 252.

The candidate list generation section 271 supplies the peripheral motion information of the enhancement layer to the availability determination section 274 to cause the availability of the peripheral motion information to be determined, and acquires the result of the determination. When the peripheral motion information of the enhancement layer is unavailable, the candidate list generation section 271 acquires the peripheral motion information of the base layer from the base layer motion information buffer 152, and fills a missing number in the candidate list with the peripheral motion information of the base layer.

When the motion information of the base layer is used for co-located motion information, instead of the motion information of the enhancement layer, the candidate list generation section 271 uses the motion information of the base layer selected by the base layer motion information selecting section 275.

The candidate list generation section 271 supplies the generated candidate list to the predictor decoding section 256.

The layer control information acquisition section 272 acquires the layer control information transmitted from the encoding side (for example, sps_col_mvp_indicator, slice_col_mvp_indicator, or the like) from the lossless decoding section 212. The layer control information acquisition section 272 supplies the layer control information acquired in this manner to the layer control section 273.

The layer control section 273 controls a layer of peripheral motion information used by the candidate list generation section 271 in generation of the candidate list based on the layer control information supplied from the layer control information acquisition section 272. To be more specific, the layer control section 273 controls whether the peripheral motion information of the enhancement layer is to be used or the peripheral motion information of the base layer is to be used in generation of the candidate list. As described above, the candidate list generation section 271 acquires the peripheral motion information under control of the layer control section 273.

The availability determination section 274 determines the availability of the motion information supplied from the candidate list generation section 271, and supplies the result of the determination to the candidate list generation section 271.

The base layer motion information selecting section 275 selects the motion information of the base layer used by the candidate list generation section 271 as co-located motion information according to the result of decoding of the base layer by the base layer image decoding section 203. To be more specific, the base layer motion information selecting section 275 selects the motion information of the base layer that is not being used as co-located motion information in decoding of the base layer as co-located motion information of the enhancement layer. For example, when the motion information of the peripheral block CR6 of the base layer has been used as co-located motion information in decoding of the base layer, the base layer motion information selecting section 275 selects the motion information of the peripheral block H6 of the base layer as co-located motion information for decoding of the enhancement layer. In addition, for example, when the motion information of the peripheral block H6 of the base layer has been used as co-located motion information in decoding of the base layer, the base layer motion information selecting section 275 selects the motion information of the peripheral block CR6 of the base layer as co-located motion information for decoding of the enhancement layer.

As described above, the candidate list generation section 271 uses the motion information of the base layer selected by the base layer motion information selecting section 275 as above when the motion information of the base layer is used as co-located motion information in decoding of the enhancement layer, instead of the motion information of the enhancement layer.

As described above, when the peripheral motion information of the enhancement layer is unavailable for decoding of motion information in decoding of the enhancement layer, the scalable decoding device 200 obtains predictive motion information using the peripheral motion information of the base layer instead of the motion information of the enhancement layer, and thus can correctly decode the motion information. Accordingly, the scalable decoding device 200 can suppress deterioration in prediction accuracy and suppress a decrease in encoding efficiency. Therefore, the scalable encoding device 100 can suppress deterioration in image quality resulting from encoding and decoding.

<Flow of the Decoding Process>

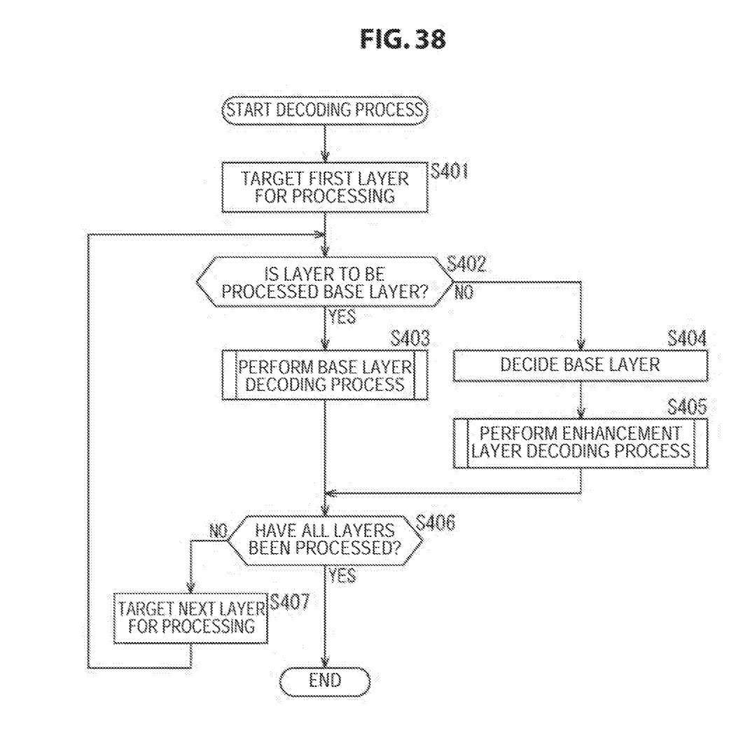

Next, the flow of each process executed by the scalable decoding device 200 as above will be described. First, an example of the flow of the decoding process will be described with reference to the flow chart of FIG. 38. The scalable decoding device 200 executes this decoding process for each picture.

When the decoding process starts, the decoding control section 202 of the scalable decoding device 200 targets a first layer for processing in Step S401.

In Step S402, the decoding control section 202 determines whether or not a current layer to be processed is a base layer. When the current layer is determined to be the base layer, the process proceeds to Step S403.

In Step S403, the base layer image decoding section 203 performs a base layer decoding process. When the process of Step S403 ends, the process proceeds to Step S406.

In addition, when the current layer is determined to be the enhancement layer in Step S402, the process proceeds to Step S404. In Step S404, the decoding control section 202 decides the base layer corresponding to the current layer (in other words, to be a reference destination).

In Step S405, the enhancement layer image decoding section 205 performs an enhancement layer decoding process. When the process of Step S405 ends, the process proceeds to Step S406.

In step S406, the decoding control section 202 determines whether or not all the layers have been processed. When it is determined that there is a non-processed layer, the process proceeds to step S407.

In step S407, the decoding control section 202 sets a next non-processed layer as a processing target (current layer). When the process of step S407 ends, the process returns to step S402. The process of steps S402 to S407 is repeatedly performed to decode the layers.

Then, when all the layers are determined to have been processed in step S406, the decoding process ends.

<Flow of Base Layer Decoding Process>

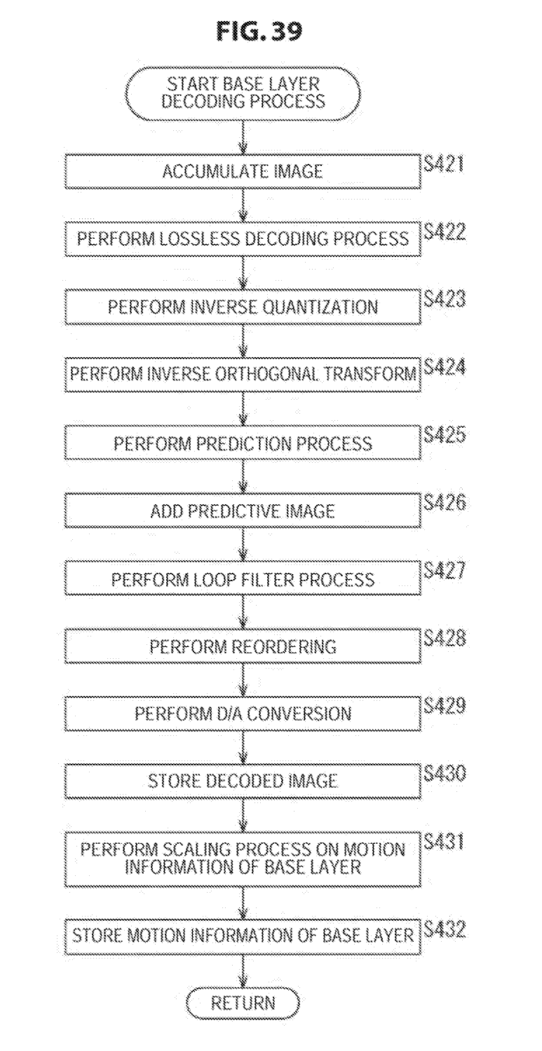

Next, an example of the flow of the base layer decoding process performed in step S403 of FIG. 38 will be described with reference to a flowchart of FIG. 39.

When the base layer decoding process starts, in step S421, the accumulation buffer 211 of the base layer image decoding section 203 accumulates the bitstreams of the base layer transmitted from the encoding side. In step S422, the lossless decoding section 212 decodes the bitstream (the encoded differential image information) of the base layer supplied from the accumulation buffer 211. In other words, the I picture, the P picture, and the B picture encoded by the lossless encoding section 116 are decoded. At this time, various kinds of information other than the differential image information included in the bitstream, such as the header information, are also decoded.

In step S423, the inverse quantization section 213 inversely quantizes the quantized coefficients obtained in the process of step S422.

In step S424, the inverse orthogonal transform section 214 performs the inverse orthogonal transform on a current block (a current TU).

In step S425, the intra prediction section 221 or the motion compensation section 222 performs the prediction process, and generates the predictive image. In other words, the prediction process is performed in the prediction mode that is determined to have been applied at the time of encoding in the lossless decoding section 212. More specifically, for example, when the intra prediction is applied at the time of encoding, the intra prediction section 221 generates the predictive image in the intra prediction mode recognized to be optimal at the time of encoding. Further, for example, when the inter prediction is applied at the time of encoding, the motion compensation section 222 generates the predictive image in the inter prediction mode recognized to be optimal at the time of encoding.

In step S426, the operation section 215 adds the predictive image generated in step S425 to the differential image information generated by the inverse orthogonal transform process of step S424. As a result, the original image is decoded.

In step S427, the loop filter 216 appropriately performs the loop filter process on the decoded image obtained in step S426.

In step S428, the screen reordering buffer 217 reorders the image that has been subjected to the filter process in step S427. In other words, the order of the frames reordered for encoding through the screen reordering buffer 112 is reordered in the original display order.

In step S429, the D/A converting section 218 performs D/A conversion on the image in which the order of the frames is reordered in step S428. The image is output to a display (not illustrated), and the image is displayed.

In step S430, the frame memory 219 stores the image that has been subjected to the loop filter process in step S427.

In Step S431, the motion information scaling section 251 of the motion information decoding section 204 performs a scaling process on the motion information of the base layer obtained from the prediction process of Step S425 according to the scaling ratio between the base layer and the enhancement layer in the space direction.

In Step S432, the base layer motion information buffer 252 of the motion information decoding section 204 stores the scaling-processed motion information of the base layer in Step S431.

When the process of Step S431 ends, the base layer decoding process ends, and the process returns to the process of FIG. 38. The base layer decoding process is executed in, for example, units of pictures. In other words, the base layer decoding process is executed for each picture of a current layer. However, each process included in the enhancement layer encoding process is performed in the processing unit thereof.

<Flow of the Enhancement Layer Decoding Process>

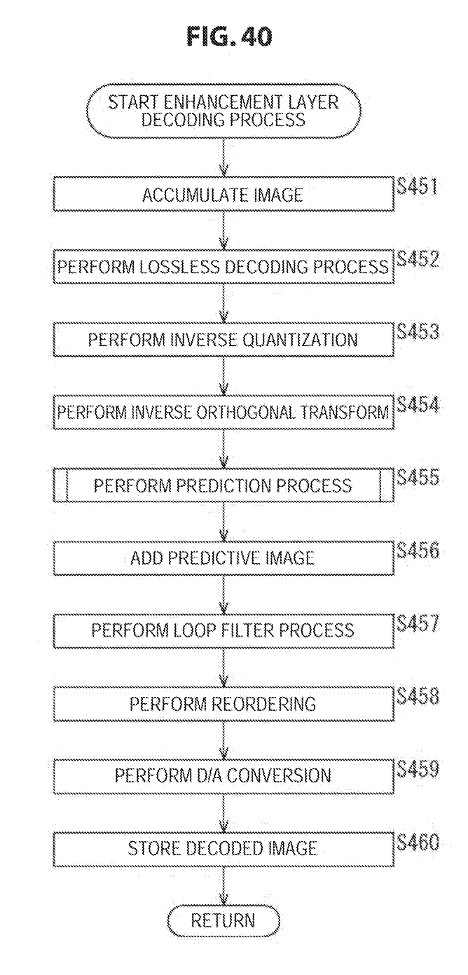

Next, an example of the flow of the enhancement layer decoding process executed in Step S405 of FIG. 38 will be described with reference to the flow chart of FIG. 40.

The respective processes of Steps S451 to S454 and Steps S456 to S460 of the enhancement layer decoding process are executed in the same manner as the respective processes of Steps S421 to S424 and Steps S426 to S430 of the base layer decoding process. The respective processes of the enhancement layer decoding process, however, are performed on enhancement layer encoded data by the respective processing units of the enhancement layer image decoding section 205.

Note that, in Step S455, the intra prediction section 221 and the motion compensation section 232 perform the prediction process on the enhancement layer encoded data.

When the process of Step S460 ends, the enhancement layer decoding process ends, and the process returns to the process of FIG. 38. The enhancement layer decoding process is executed in, for example, units of pictures. In other words, the enhancement layer decoding process is performed on each picture of a current layer. However, each process included in the enhancement layer encoding process is performed in the processing unit thereof.

<Flow of the Prediction Process>

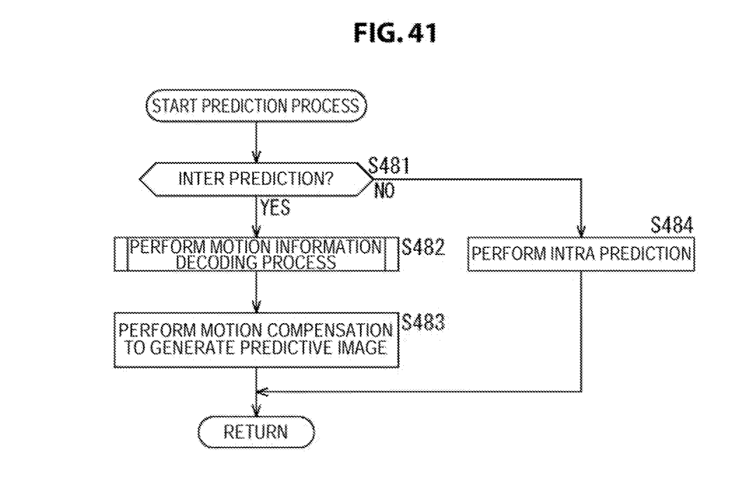

Next, an example of the flow of the prediction process executed in Step S455 of FIG. 40 will be described with reference to the flow chart of FIG. 41.

When the prediction process starts, the motion compensation section 232 determines whether or not the prediction mode is inter prediction in Step S481. When it is determined to be inter prediction, the process proceeds to Step S482.

In Step S482, the motion information decoding section 204 performs a motion information decoding process to reconstruct the motion information of the current block.

In Step S483, the motion compensation section 232 performs motion compensation using the motion information obtained from the process of Step S482 to generate a predictive image. When the predictive image is generated, the prediction process ends, and the process returns to the process of FIG. 40.

In addition, when it is determined to be intra prediction in Step S481, the process proceeds to Step S484. In Step S484, the intra prediction section 221 generates a predictive image in an optimal intra prediction mode that is an intra prediction mode employed in the encoding. When the process of Step S484 ends, the prediction process ends, and the process returns to the process of FIG. 40.

<Flow of the Motion Information Decoding Process>

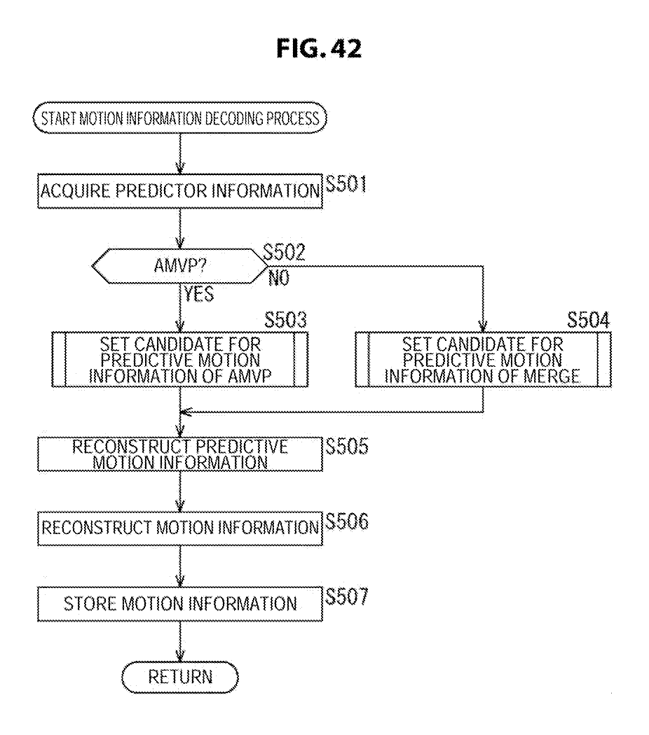

Next, an example of the flow of the motion information decoding process executed in Step S482 of FIG. 41 will be described with reference to the flow chart of FIG. 42.

When the motion information decoding process starts, the predictor decoding section 256 acquires predictor information that is information related to encoding and decoding of the motion information of the enhancement layer transmitted from the encoding side from the lossless decoding section 212 in Step S501.

In Step S502, the predictor decoding section 256 determines whether or not the employed predictive motion information is of the AMVP mode based on the predictor information. When it is determined to be the AMVP mode, the process proceeds to Step S503.

In Step S503, the AMVP processing section 254 sets a candidate for the predictive motion information of AMVP by performing the same AMVP process as on the encoding side as described with reference to the flow charts of FIGS. 25 to 30. When the AMVP process ends, the process proceeds to Step S505.

In addition, when it is determined not to be the AMVP mode in Step S502, the process proceeds to Step S504.

In Step S504, the merge processing section 255 performs the same merge process as on the encoding side as described with reference to the flow chart of FIG. 31 and the like to set a candidate for predictive motion information of the merge mode. When the merge process ends, the process proceeds to Step S505.

In Step S505, the predictor decoding section 256 reconstructs the predictive motion information of the current block using the result of the process of Step S503 or Step S504.

In Step S506, the predictor decoding section 256 reconstructs the motion information of the current block using the predictive motion information obtained in Step S505 or differential motion information acquired from the lossless decoding section 212. The predictor decoding section 256 supplies the motion information to the motion compensation section 232 to cause the section to generate a predictive image.

In Step S507, the enhancement layer motion information buffer 253 stores the motion information of the current block of the enhancement layer.

When the process of Step S507 ends, the motion information decoding process ends, and the process returns to the process of FIG. 41.

By executing each of the processes described above, the scalable decoding device 200 can suppress a decrease in encoding efficiency and deterioration in image quality resulting from encoding and decoding.

### 3. Other

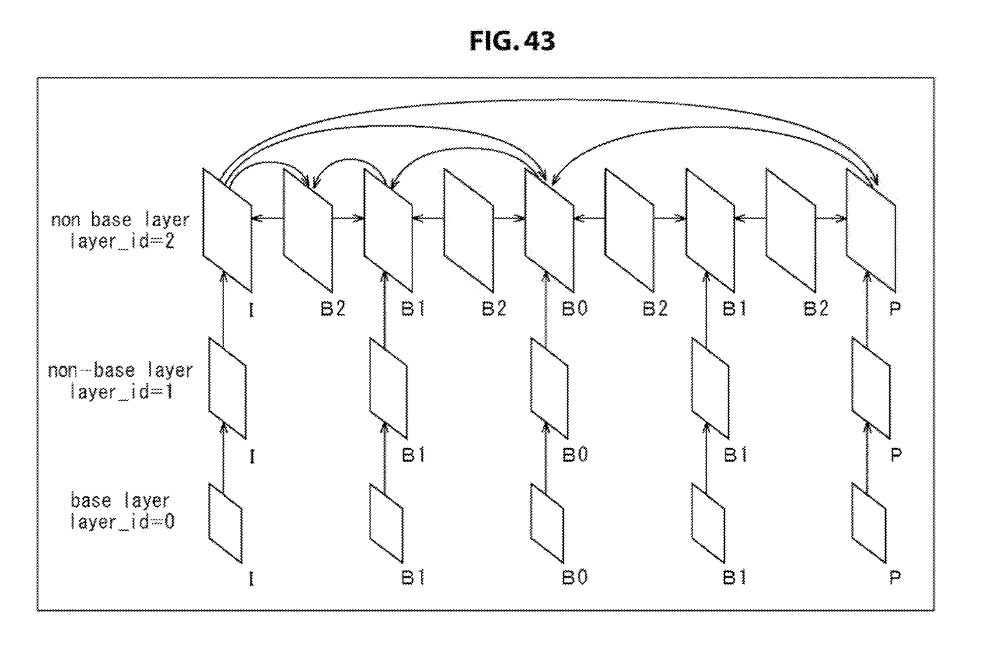

Although the example in which image data is hierarchized into a plurality of layers by scalable video coding has been described above, the number of layers is arbitrary. For example, some pictures may be hierarchized as illustrated in the example of FIG. 43. Further, although the example in which the enhancement layer is processed using information of the base layer at the time of encoding and decoding has been described above, the present technology is not limited to this example, and the enhancement layer may be processed using information of any other processed enhancement layer.

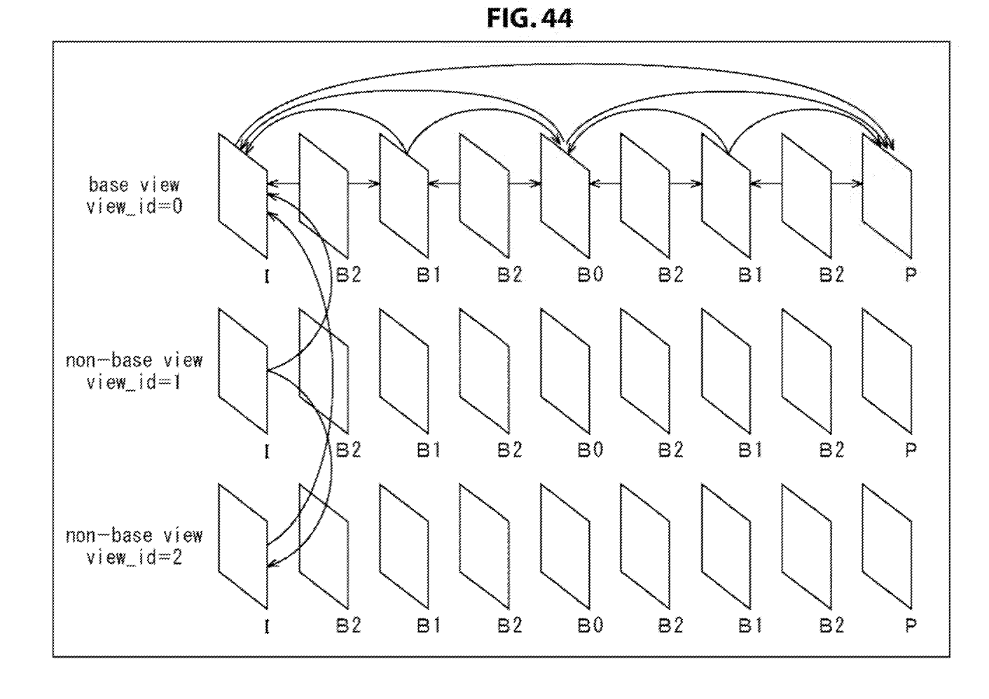

Further, a view in multi-view image encoding and decoding is also included as a layer described above. In other words, the present technology can be applied to multi-view image encoding and multi-view image decoding. FIG. 44 illustrates an example of a multi-view image encoding scheme.

As illustrated in FIG. 44, a multi-view image includes images of a plurality of views, and an image of one predetermined view among the plurality of views is designated as an image of a base view. Images of respective views other than the image of the base view are treated as image of non-base views.

When a multi-view image as in FIG. 44 is encoded and decoded, images of respective views are encoded and decoded, but the above-described method may be applied to encoding and decoding of the respective views. In other words, motion information and the like may be set to be shared for a plurality of views in such multi-view encoding and decoding.

For example, for the base view, a candidate for predictive motion information may be set to be generated using only motion information of the very view, and for non-base views, predictive motion information may be set to be generated also using motion information of the base view.

With the operation, a decrease in encoding efficiency can be suppressed also in multi-view encoding and decoding as in the above described hierarchical encoding and decoding.

As described above, the present technology can be applied to all image encoding devices and all image decoding devices based on scalable encoding and decoding.

For example, the present technology can be applied to an image encoding device and an image decoding device used when image information (bitstream) compressed by an orthogonal transform such as a discrete cosine transform and motion compensation as in MPEG and H.26x is received via a network medium such as satellite broadcasting, cable television, the Internet, or a mobile telephone. Further, the present technology can be applied to an image encoding device and an image decoding device used when processing is performed on a storage medium such as an optical disc, a magnetic disk, or a flash memory.

### 4. Third Embodiment

### Computer

The above described series of processes can be executed by hardware or can be executed by software. When the series of processes are to be performed by software, the programs forming the software are installed into a computer. Here, a computer includes a computer which is incorporated in dedicated hardware or a general-purpose personal computer (PC) which can execute various functions by installing various programs into the computer, for example.

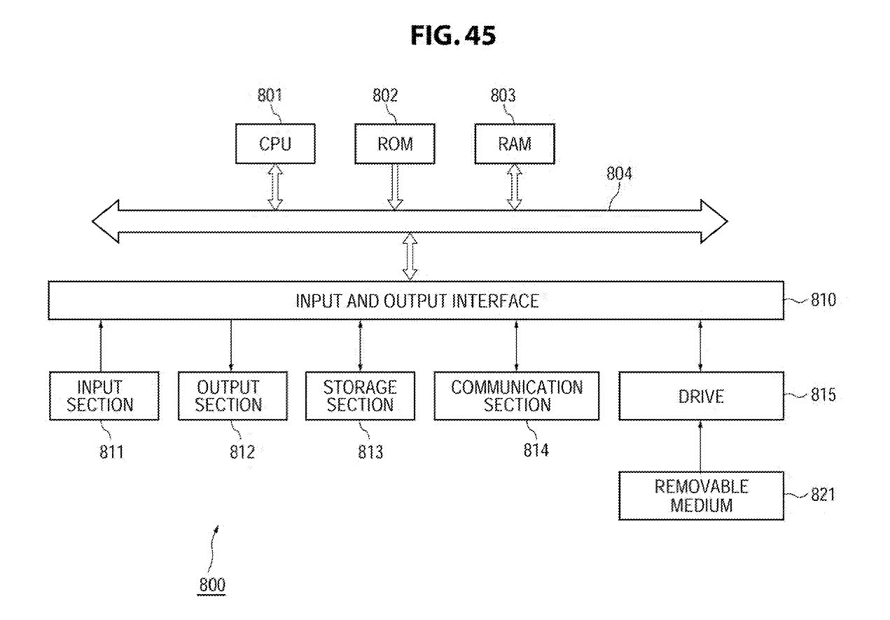

FIG. 45 is a block diagram illustrating a configuration example of hardware of a computer for executing the above-described series of processes through a program.

In a computer 800 shown in FIG. 45, a central processing unit (CPU) 801, a read only memory (ROM) 802, and a random access memory (RAM) 803 are connected to one another by a bus 804.

An input and output interface (I/F) 810 is further connected to the bus 804. An input section 811, an output section 812, a storage section 813, a communication section 814, and a drive 815 are connected to the input and output I/F 810.

The input section 811 is formed with a keyboard, a mouse, a microphone, a touch panel, an input terminal, and the like. The output section 812 is formed with a display, a speaker, an output terminal, and the like. The storage section 813 is formed with a hard disk, a nonvolatile memory, or the like. The communication section 814 is formed with a network interface or the like. The drive 815 drives a removable medium 821 such as a magnetic disk, an optical disk, a magneto-optical disk, or a semiconductor memory.

In the computer configured as described above, the CPU 801 loads the programs stored in the storage section 813 into the RAM 803 via the input and output I/F 810 and the bus 804, and executes the programs, so that the above described series of processes are performed. The RAM 803 also stores data necessary for the CPU 801 to execute the various processes.

The program executed by the computer 800 (the CPU 801) may be provided by being recorded on the removable medium 821 as a packaged medium or the like. The program can also be applied via a wired or wireless transfer medium, such as a local area network, the Internet, or a digital satellite broadcast.

In the computer, by loading the removable medium 821 into the drive 815, the program can be installed into the storage section 813 via the input and output I/F 810. It is also possible to receive the program from a wired or wireless transfer medium using the communication section 814 and install the program into the storage section 813. As another alternative, the program can be installed in advance into the ROM 802 or the storage section 813.

It should be noted that the program executed by a computer may be a program that is processed in time series according to the sequence described in this specification or a program that is processed in parallel or at necessary timing such as upon calling.

In the present disclosure, steps of describing the program to be recorded on the recording medium may include processing performed in time-series according to the description order and processing not processed in time-series but performed in parallel or individually.

In addition, in this disclosure, a system means a set of a plurality of elements (devices, modules (parts), or the like) regardless of whether or not all elements are arranged in a single housing. Thus, both a plurality of devices that are accommodated in separate housings and connected via a network and a single device in which a plurality of modules are accommodated in a single housing are systems.

Further, an element described as a single device (or processing unit) above may be divided and configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same.

The preferred embodiments of the present disclosure have been described above with reference to the accompanying drawings, whilst the present invention is not limited to the above examples, of course. A person skilled in the art may find various alterations and modifications within the scope of the appended claims, and it should be understood that they will naturally come under the technical scope of the present disclosure.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

The image encoding device and the image decoding device according to the embodiment may be applied to various electronic devices such as transmitters and receivers for satellite broadcasting, cable broadcasting such as cable TV, distribution on the Internet, distribution to terminals via cellular communication and the like, recording devices that record images in a medium such as optical discs, magnetic disks and flash memory, and reproduction devices that reproduce images from such storage medium. Four applications will be described below.

### 5. Applications

<First Application: Television Receivers>

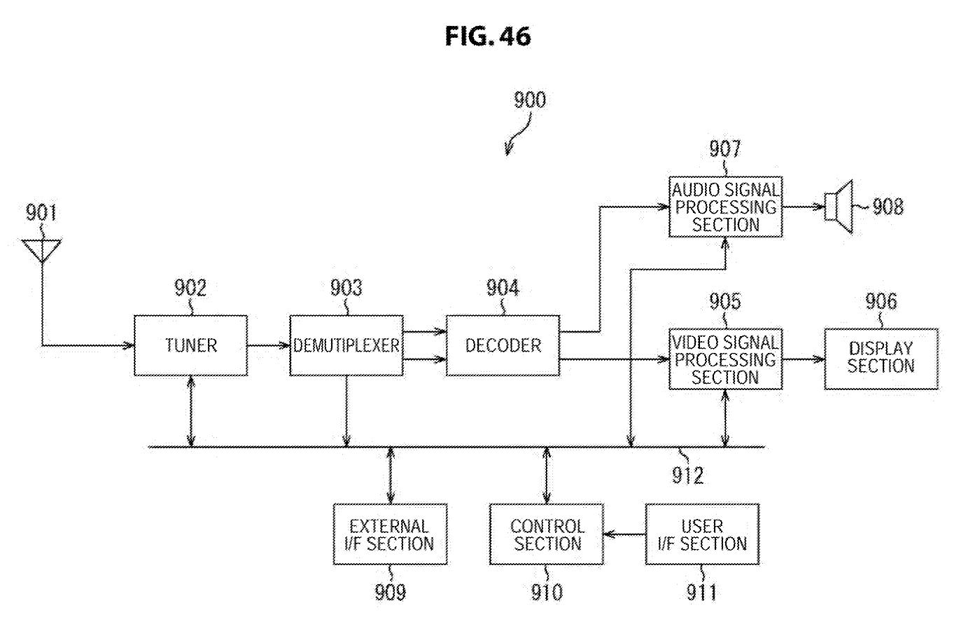

FIG. 46 illustrates an example of a schematic configuration of a television device to which the embodiment is applied. A television device 900 includes an antenna 901, a tuner 902, a demultiplexer 903, a decoder 904, an video signal processing section 905, a display section 906, an audio signal processing section 907, a speaker 908, an external I/F 909, a control section 910, a user I/F 911, and a bus 912.

The tuner 902 extracts a signal of a desired channel from broadcast signals received via the antenna 901, and demodulates the extracted signal. The tuner 902 then outputs an encoded bitstream obtained through the demodulation to the demultiplexer 903. That is, the tuner 902 serves as a transmission unit of the television device 900 for receiving an encoded stream in which an image is encoded.

The demultiplexer 903 demultiplexes the encoded bitstream to obtain a video stream and an audio stream of a program to be viewed, and outputs each stream obtained through the demultiplexing to the decoder 904. The demultiplexer 903 also extracts auxiliary data such as electronic program guides (EPGs) from the encoded bitstream, and supplies the extracted data to the control section 910. Additionally, the demultiplexer 903 may perform descrambling when the encoded bitstream has been scrambled.

The decoder 904 decodes the video stream and the audio stream input from the demultiplexer 903. The decoder 904 then outputs video data generated in the decoding process to the video signal processing section 905. The decoder 904 also outputs the audio data generated in the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data in accordance with the setting. Furthermore, the video signal processing section 905 may generate an image of a graphical user I/F (GUI) such as a menu, a button and a cursor, and superimpose the generated image on an output image.

The display section 906 is driven by a drive signal supplied from the video signal processing section 905, and displays a video or an image on a video screen of a display device (e.g. liquid crystal display, plasma display, organic electrioluminescence display (OLED), etc.).

The audio signal processing section 907 performs a reproduction process such as D/A conversion and amplification on the audio data input from the decoder 904, and outputs a sound from the speaker 908. The audio signal processing section 907 may also perform an additional process such as noise removal on the audio data.

The external I/F 909 is an I/F for connecting the television device 900 to an external device or a network. For example, a video stream or an audio stream received via the external I/F 909 may be decoded by the decoder 904. That is, the external I/F 909 also serves as a transmission unit of the television device 900 for receiving an encoded stream in which an image is encoded.

The control section 910 includes a processor such as a central processing unit (CPU), and a memory such as random access memory (RAM) and read only memory (ROM). The memory stores a program to be executed by the CPU, program data, EPG data, data acquired via a network, and the like. The program stored in the memory is read out and executed by the CPU at the time of activation of the television device 900, for example. The CPU controls the operation of the television device 900, for example, in accordance with an operation signal input from the user I/F 911 by executing the program.

The user I/F 911 is connected to the control section 910. The user I/F 911 includes, for example, a button and a switch used for a user to operate the television device 900, and a receiving section for a remote control signal. The user I/F 911 detects an operation of a user via these structural elements, generates an operation signal, and outputs the generated operation signal to the control section 910.

The bus 912 connects the tuner 902, the demultiplexer 903, the decoder 904, the video signal processing section 905, the audio signal processing section 907, the external I/F 909, and the control section 910 to each other.

The decoder 904 has a function of the scalable decoding device 200 according to the embodiment in the television device 900 configured in this manner. Therefore, when images are decoded in the television device 900, suppression of a decrease in encoding efficiency and deterioration in image quality resulting from encoding and decoding can be realized.

<Second Application: Mobile Phones>

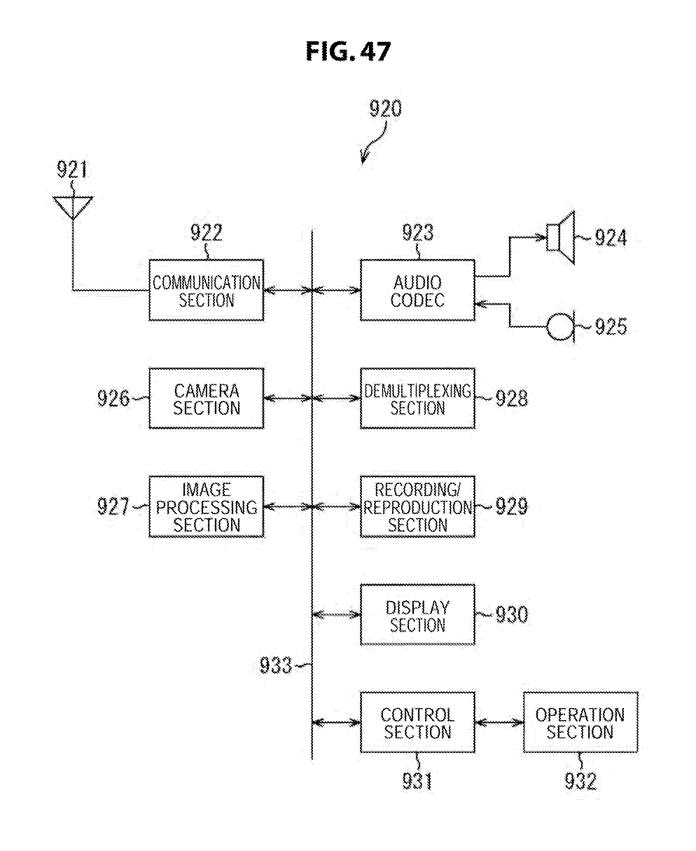

FIG. 47 illustrates an example of a schematic configuration of a mobile phone to which the embodiment is applied. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 connects the communication section 922, the audio codec 923, the camera section 926, the image processing section 927, the demultiplexing section 928, the recording/reproduction section 929, the display section 930, and the control section 931 to each other.

The mobile phone 920 performs an operation such as transmission and reception of an audio signal, transmission and reception of email or image data, image capturing, and recording of data in various operation modes including an audio call mode, a data communication mode, an image capturing mode, and a videophone mode.

An analogue audio signal generated by the microphone 925 is supplied to the audio codec 923 in the audio call mode. The audio codec 923 converts the analogue audio signal into audio data, has the converted audio data subjected to the A/D conversion, and compresses the converted data. The audio codec 923 then outputs the compressed audio data to the communication section 922. The communication section 922 encodes and modulates the audio data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal, generates audio data, and outputs the generated audio data to the audio codec 923. The audio codec 923 extends the audio data, has the audio data subjected to the D/A conversion, and generates an analogue audio signal. The audio codec 923 then supplies the generated audio signal to the speaker 924 to output a sound.

The control section 931 also generates text data in accordance with an operation made by a user via the operation section 932, the text data, for example, composing email. Moreover, the control section 931 causes the display section 930 to display the text. Furthermore, the control section 931 generates email data in accordance with a transmission instruction from a user via the operation section 932, and outputs the generated email data to the communication section 922. The communication section 922 encodes and modulates the email data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal to restore the email data, and outputs the restored email data to the control section 931. The control section 931 causes the display section 930 to display the content of the email, and also causes the storage medium of the recording/reproduction section 929 to store the email data.

The recording/reproduction section 929 includes a readable and writable storage medium. For example, the storage medium may be a built-in storage medium such as RAM and flash memory, or an externally mounted storage medium such as hard disks, magnetic disks, magneto-optical disks, optical discs, unallocated space bitmap (USB) memory, and memory cards.

Furthermore, the camera section 926, for example, captures an image of a subject to generate image data, and outputs the generated image data to the image processing section 927 in the image capturing mode. The image processing section 927 encodes the image data input from the camera section 926, and causes the storage medium of the storage/reproduction section 929 to store the encoded stream.

Furthermore, the demultiplexing section 928, for example, multiplexes a video stream encoded by the image processing section 927 and an audio stream input from the audio codec 923, and outputs the multiplexed stream to the communication section 922 in the videophone mode. The communication section 922 encodes and modulates the stream, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. These transmission signal and received signal may include an encoded bitstream. The communication section 922 then demodulates and decodes the received signal to restore the stream, and outputs the restored stream to the demultiplexing section 928. The demultiplexing section 928 demultiplexes the input stream to obtain a video stream and an audio stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends the audio stream, has the audio stream subjected to the D/A conversion, and generates an analogue audio signal. The audio codec 923 then supplies the generated audio signal to the speaker 924, and causes a sound to be output.

The image processing section 927 has functions of the scalable encoding device 100 and the scalable decoding device 200 according to the embodiment in the mobile phone 920 configured in this manner. Therefore, when images are encoded and decoded in the mobile phone 920, a decrease in encoding efficiency and deterioration in image quality resulting from encoding and decoding can be suppressed.

<Third Application: Recording/Reproduction Device>

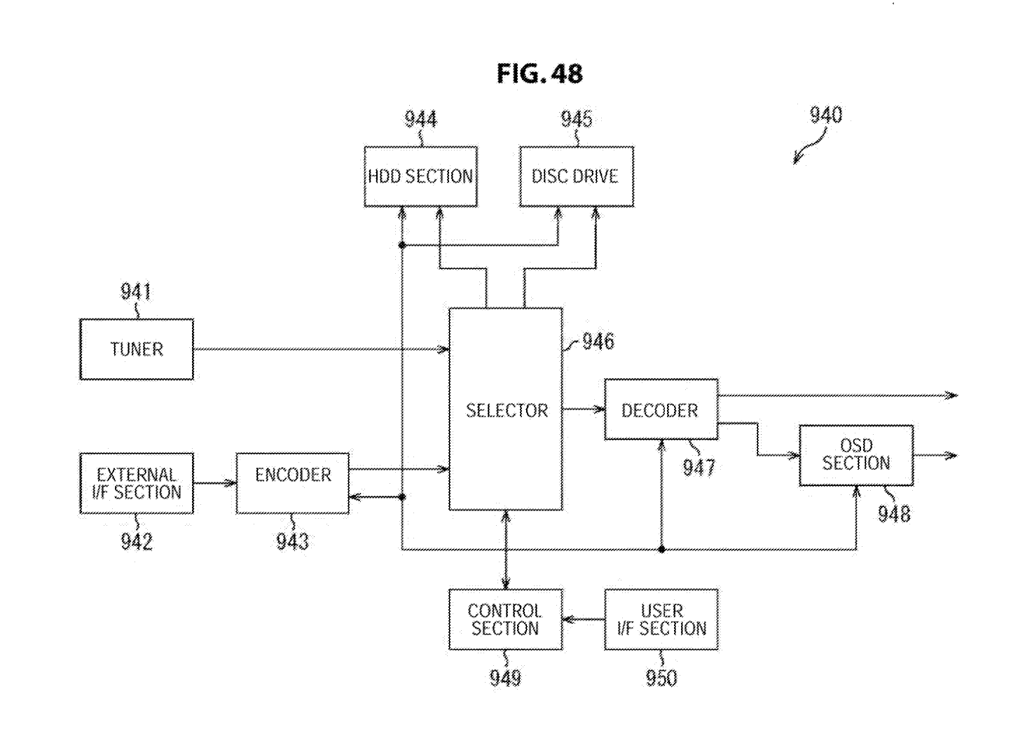

FIG. 48 illustrates an example of a schematic configuration of a recording/reproduction device to which the embodiment is applied. A recording/reproduction device 940, for example, encodes audio data and video data of a received broadcast program and records the encoded audio data and the encoded video data in a recording medium. For example, the recording/reproduction device 940 may also encode audio data and video data acquired from another device and record the encoded audio data and the encoded video data in a recording medium. Furthermore, the recording/reproduction device 940, for example, uses a monitor or a speaker to reproduce the data recorded in the recording medium in accordance with an instruction of a user. At this time, the recording/reproduction device 940 decodes the audio data and the video data.

The recording/reproduction device 940 includes a tuner 941, an external I/F 942, an encoder 943, a hard disk drive (HDD) 944, a disc drive 945, a selector 946, a decoder 947, an on-screen display (OSD) 948, a control section 949, and a user I/F 950.

The tuner 941 extracts a signal of a desired channel from broadcast signals received via an antenna (not shown), and demodulates the extracted signal. The tuner 941 then outputs an encoded bitstream obtained through the demodulation to the selector 946. That is, the tuner 941 serves as a transmission unit of the recording/reproduction device 940.

The external I/F 942 is an I/F for connecting the recording/reproduction device 940 to an external device or a network. For example, the external I/F 942 may be an Institute of Electrical and Electronics Engineers (IEEE) 1394 I/F, a network I/F, an USB I/F, a flash memory I/F, or the like. For example, video data and audio data received via the external I/F 942 are input to the encoder 943. That is, the external I/F 942 serves as a transmission unit of the recording/reproduction device 940.

When the video data and the audio data input from the external I/F 942 have not been encoded, the encoder 943 encodes the video data and the audio data. The encoder 943 then outputs an encoded bitstream to the selector 946.

The HDD 944 records, in an internal hard disk, the encoded bitstream in which content data of a video and a sound is compressed, various programs, and other pieces of data. The HDD 944 also reads out these pieces of data from the hard disk at the time of reproducing a video or a sound.

The disc drive 945 records and reads out data in a recording medium that is mounted. The recording medium that is mounted on the disc drive 945 may be, for example, a DVD disc (DVD-Video, DVD-RAM, DVD-R, DVD-RW, a DVD+R, DVD+RW, etc.), a Blu-ray (registered trademark) disc, or the like.

The selector 946 selects, at the time of recording a video or a sound, an encoded bitstream input from the tuner 941 or the encoder 943, and outputs the selected encoded bitstream to the HDD 944 or the disc drive 945. The selector 946 also outputs, at the time of reproducing a video or a sound, an encoded bitstream input from the HDD 944 or the disc drive 945 to the decoder 947.

The decoder 947 decodes the encoded bitstream, and generates video data and audio data. The decoder 947 then outputs the generated video data to the OSD 948. The decoder 904 also outputs the generated audio data to an external speaker.

The OSD 948 reproduces the video data input from the decoder 947, and displays a video. The OSD 948 may also superimpose an image of a GUI such as a menu, a button, and a cursor on a displayed video.

The control section 949 includes a processor such as a CPU, and a memory such as RAM and ROM. The memory stores a program to be executed by the CPU, program data, and the like. For example, a program stored in the memory is read out and executed by the CPU at the time of activation of the recording/reproduction device 940. The CPU controls the operation of the recording/reproduction device 940, for example, in accordance with an operation signal input from the user I/F 950 by executing the program.

The user I/F 950 is connected to the control section 949. The user I/F 950 includes, for example, a button and a switch used for a user to operate the recording/reproduction device 940, and a receiving section for a remote control signal. The user I/F 950 detects an operation made by a user via these structural elements, generates an operation signal, and outputs the generated operation signal to the control section 949.

The encoder 943 has a function of the scalable encoding device 100 according to the embodiment in the recording/reproduction device 940 configured in this manner. The decoder 947 also has a function of the scalable decoding device 200 according to the embodiment. Therefore, when images are encoded and decoded in the recording/reproduction device 940, a decrease in encoding efficiency and deterioration in image quality resulting from encoding and decoding can be suppressed.

<Fourth Application: Image Capturing Device>

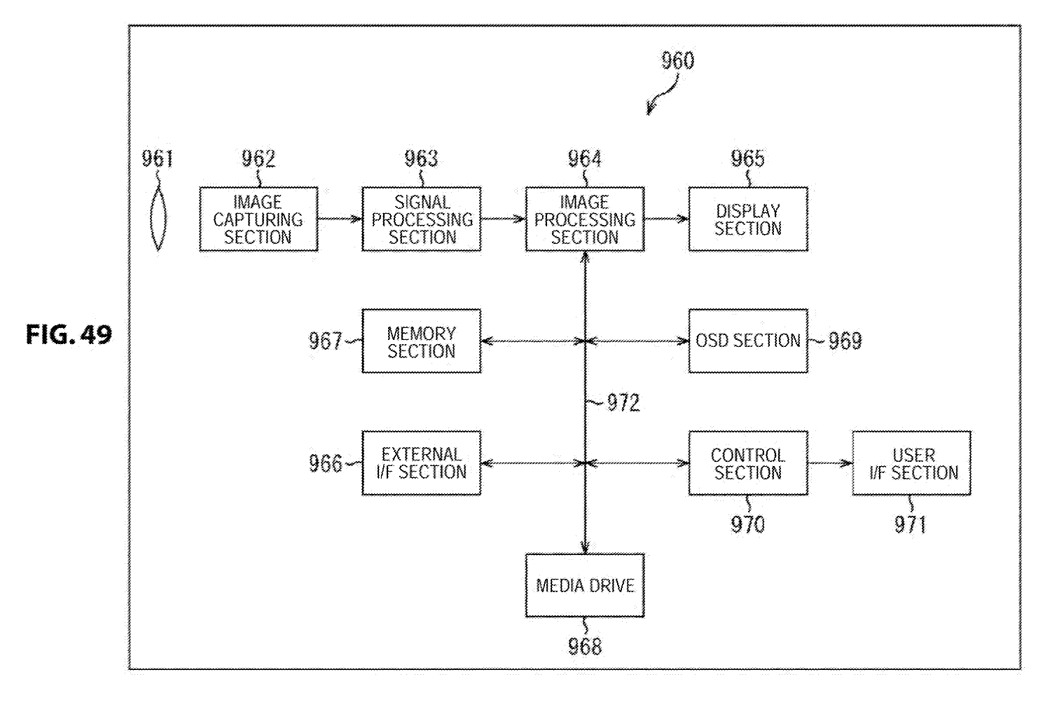

FIG. 49 illustrates an example of a schematic configuration of an image capturing device to which the embodiment is applied. An image capturing device 960 captures an image of a subject to generate an image, encodes the image data, and records the image data in a recording medium.

The image capturing device 960 includes an optical block 961, an image capturing section 962, a signal processing section 963, an image processing section 964, a display section 965, an external I/F 966, a memory 967, a media drive 968, an OSD 969, a control section 970, a user I/F 971, and a bus 972.

The optical block 961 is connected to the image capturing section 962. The image capturing section 962 is connected to the signal processing section 963. The display section 965 is connected to the image processing section 964. The user I/F 971 is connected to the control section 970. The bus 972 connects the image processing section 964, the external I/F 966, the memory 967, the media drive 968, the OSD 969, and the control section 970 to each other.

The optical block 961 includes a focus lens, an aperture stop mechanism, and the like. The optical block 961 forms an optical image of a subject on an image capturing surface of the image capturing section 962. The image capturing section 962 includes an image sensor such as a charge coupled device (CCD) and a complementary metal oxide semiconductor (CMOS), and converts the optical image formed on the image capturing surface into an image signal which is an electrical signal through photoelectric conversion. The image capturing section 962 then outputs the image signal to the signal processing section 963.

The signal processing section 963 performs various camera signal processes such as knee correction, gamma correction, and color correction on the image signal input from the image capturing section 962. The signal processing section 963 outputs the image data subjected to the camera signal process to the image processing section 964.

The image processing section 964 encodes the image data input from the signal processing section 963, and generates encoded data. The image processing section 964 then outputs the generated encoded data to the external I/F 966 or the media drive 968. The image processing section 964 also decodes encoded data input from the external I/F 966 or the media drive 968, and generates image data. The image processing section 964 then outputs the generated image data to the display section 965. The image processing section 964 may also output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI such as a menu, a button, and a cursor, and outputs the generated image to the image processing section 964.

The external I/F 966 is configured, for example, as an USB input and output terminal. The external I/F 966 connects the image capturing device 960 and a printer, for example, at the time of printing an image. A drive is further connected to the external I/F 966 as needed. A removable medium such as magnetic disks and optical discs is mounted on the drive, and a program read out from the removable medium may be installed in the image capturing device 960. Furthermore, the external I/F 966 may be configured as a network I/F to be connected to a network such as a LAN and the Internet. That is, the external I/F 966 serves as a transmission unit of the image capturing device 960.

A recording medium to be mounted on the media drive 968 may be a readable and writable removable medium such as magnetic disks, magneto-optical disks, optical discs, and semiconductor memory. The recording medium may also be fixedly mounted on the media drive 968, configuring a non-transportable storage section such as built-in hard disk drives or a solid state drives (SSDs).

The control section 970 includes a processor such as a CPU, and a memory such as RAM and ROM. The memory stores a program to be executed by the CPU, program data, and the like. A program stored in the memory is read out and executed by the CPU, for example, at the time of activation of the image capturing device 960. The CPU controls the operation of the image capturing device 960, for example, in accordance with an operation signal input from the user I/F 971 by executing the program.

The user I/F 971 is connected to the control section 970. The user I/F 971 includes, for example, a button, a switch, and the like used for a user to operate the image capturing device 960. The user I/F 971 detects an operation made by a user via these structural elements, generates an operation signal, and outputs the generated operation signal to the control section 970.

The image processing section 964 has a function of the scalable encoding device 100 and the scalable decoding device 200 according to the embodiment in the image capturing device 960 configured in this manner. Therefore, when images are encoded and decoded in the image capturing device 960, a decrease in encoding efficiency and deterioration in image quality resulting from encoding and decoding can be suppressed.

### 6. Application Example of Scalable Video Coding

<First System>

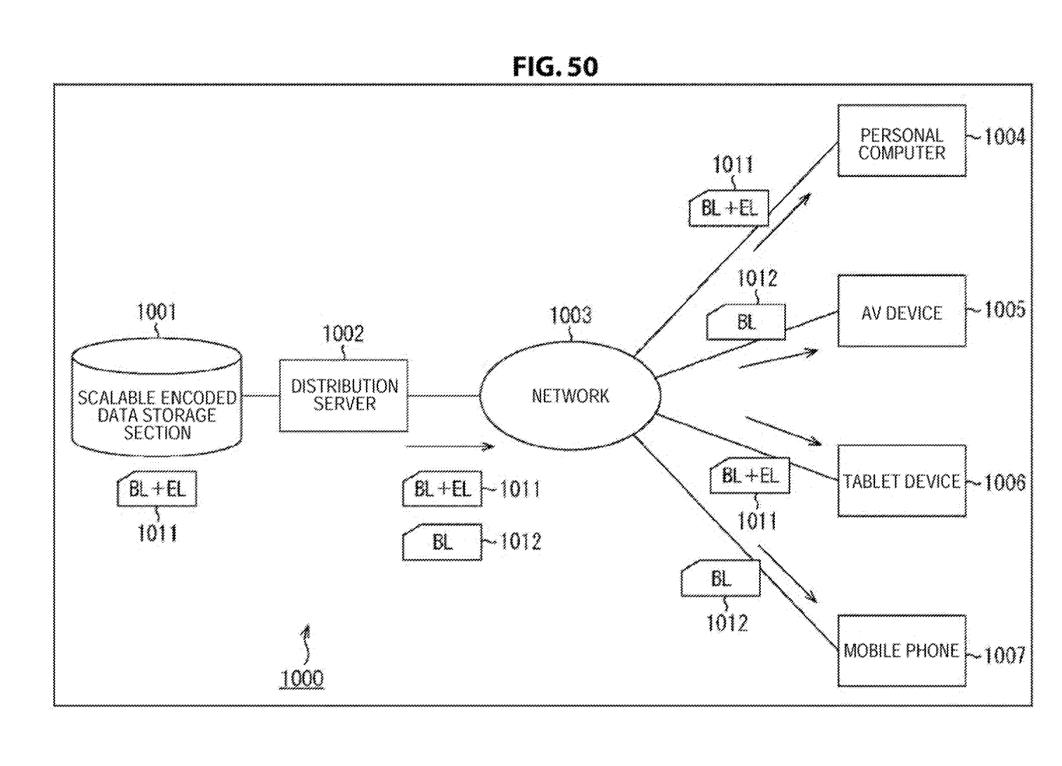

Next, a specific example of using scalable encoded data, in which a scalable video coding (hierarchical coding) is performed, will be described. The scalable video coding, for example, is used for selection of data to be transmitted as examples illustrated in FIG. 50.

In a data transmission system 1000 illustrated in FIG. 50, a distribution server 1002 reads scalable encoded data stored in a scalable encoded data storage section 1001, and distributes the scalable encoded data to a terminal device such as a PC 1004, an AV device 1005, a tablet device 1006, or a mobile phone 1007 via a network 1003.

At this time, the distribution server 1002 selects and transmits encoded data having proper quality according to capability of the terminal device, communication environment, or the like. Even when the distribution server 1002 transmits unnecessarily high-quality data, a high-quality image is not necessarily obtainable in the terminal device and it may be a cause of occurrence of a delay or an overflow. In addition, a communication band may be unnecessarily occupied or a load of the terminal device may be unnecessarily increased. In contrast, even when the distribution server 1002 transmits unnecessarily low quality data, an image with a sufficient quality may not be obtained. Thus, the distribution server 1002 appropriately reads and transmits the scalable encoded data stored in the scalable encoded data storage section 1001 as the encoded data having a proper quality according to the capability of the terminal device, the communication environment, or the like.

For example, the scalable encoded data storage section 1001 is configured to store scalable encoded data (BL+EL) 1011 in which the scalable video coding is performed. The scalable encoded data (BL+EL) 1011 is encoded data including both a base layer and an enhancement layer, and is data from which a base layer image and an enhancement layer image can be obtained by performing decoding.

The distribution server 1002 selects an appropriate layer according to the capability of the terminal device for transmitting data, the communication environment, or the like, and reads the data of the selected layer. For example, with respect to the PC 1004 or the tablet device 1006 having high processing capability, the distribution server 1002 reads the scalable encoded data (BL+EL) 1011 from the scalable encoded data storage section 1001, and transmits the scalable encoded data (BL+EL) 1011 without change. On the other hand, for example, with respect to the AV device 1005 or the mobile phone 1007 having low processing capability, the distribution server 1002 extracts the data of the base layer from the scalable encoded data (BL+EL) 1011, and transmits the extracted data of the base layer as low quality scalable encoded data (BL) 1012 that is data having the same content as the scalable encoded data (BL+EL) 1011 but has lower quality than the scalable encoded data (BL+EL) 1011.

Because an amount of data can easily be adjusted by employing the scalable encoded data, the occurrence of the delay or the overflow can be suppressed or the unnecessary increase of the load of the terminal device or the communication media can be suppressed. In addition, because a redundancy between the layers is reduced in the scalable encoded data (BL+EL) 1011, it is possible to further reduce the amount of data than when the encoded data of each layer is treated as the individual data. Therefore, it is possible to more efficiently use the storage region of the scalable encoded data storage section 1001.

Because various devices such as the PC 1004 to the mobile phone 1007 are applicable as the terminal device, the hardware performance of the terminal devices differs according to the device. In addition, because there are various applications which are executed by the terminal device, the software performance thereof also varies. Further, because all the communication networks including a wired, wireless, or both such as the Internet and the local area network (LAN) are applicable as the network 1003 serving as a communication medium, the data transmission performance thereof varies. Further, the data transmission performance may vary by other communications, or the like.

Therefore, the distribution server 1002 may perform communication with the terminal device which is the data transmission destination before starting the data transmission, and then obtain information related to the terminal device performance such as hardware performance of the terminal device, or the application (software) performance which is executed by the terminal device, and information related to the communication environment such as an available bandwidth of the network 1003. Then, distribution server 1002 may select an appropriate layer based on the obtained information.

Also, the extraction of the layer may be performed in the terminal device. For example, the PC 1004 may decode the transmitted scalable encoded data (BL+EL) 1011 and display the image of the base layer or display the image of the enhancement layer. In addition, for example, the PC 1004 may be configured to extract the scalable encoded data (BL) 1012 of the base layer from the transmitted scalable encoded data (BL+EL) 1011, store the extracted scalable encoded data (BL) 1012 of the base layer, transmit to another device, or decode and display the image of the base layer.

Of course, the number of the scalable encoded data storage sections 1001, the distribution servers 1002, the networks 1003, and the terminal devices are optional. In addition, although the example of the distribution server 1002 transmitting the data to the terminal device is described above, the example of use is not limited thereto. The data transmission system 1000 is applicable to any system which selects and transmits an appropriate layer according to the capability of the terminal device, the communication environment, or the like when the scalable encoded data is transmitted to the terminal device.

In addition, as the present technology is applied to the data transmission system 1000 described above in the same manner as the application to the hierarchical encoding and hierarchical decoding described above in the first and second embodiments, the same effects as those of the first and second embodiments can be obtained.

<Second System>

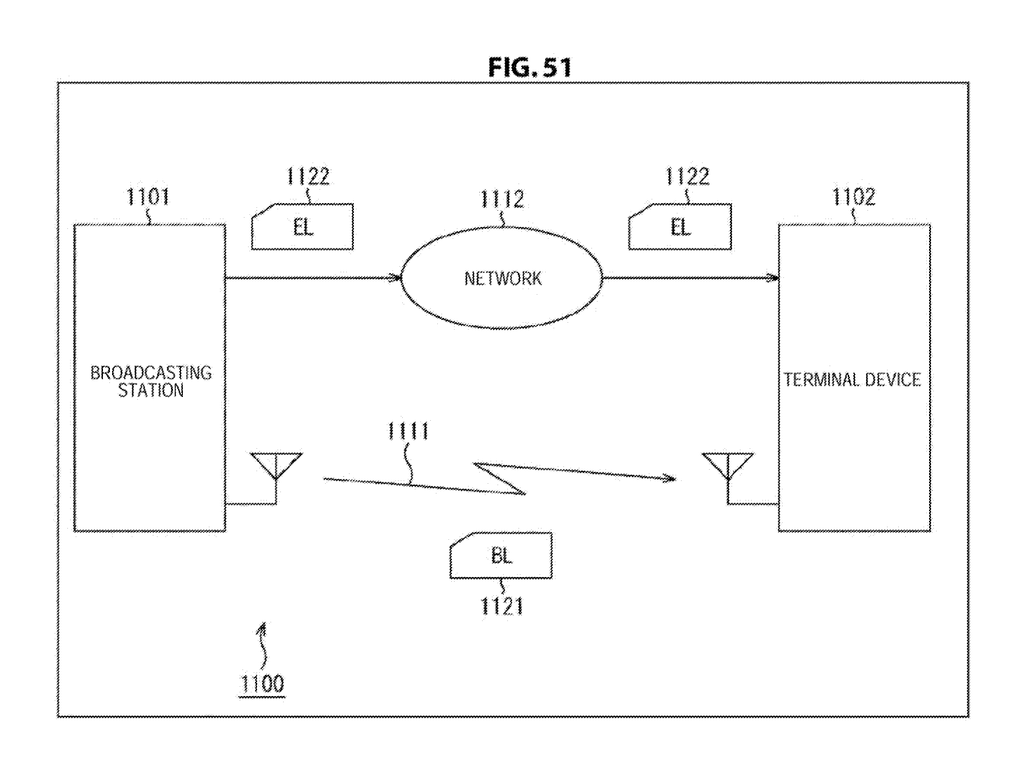

In addition, the scalable video coding, for example, is used for transmission via a plurality of communication media as in an example illustrated in FIG. 51.

In a data transmission system 1100 illustrated in FIG. 51, a broadcasting station 1101 transmits scalable encoded data (BL) 1121 of the base layer by terrestrial broadcasting 1111. In addition, the broadcasting station 1101 transmits scalable encoded data (EL) 1122 of the enhancement layer via any arbitrary network 1112 made of a communication network that is wired, wireless, or both (for example, the data is packetized and transmitted).

A terminal device 1102 has a function of receiving the terrestrial broadcasting 1111 that is broadcast by the broadcasting station 1101 and receives the scalable encoded data (BL) 1121 of the base layer transmitted via the terrestrial broadcasting 1111. In addition, the terminal device 1102 further has a communication function by which the communication is performed via the network 1112, and receives the scalable encoded data (EL) 1122 of the enhancement layer transmitted via the network 1112.

For example, according to a user's instruction or the like, the terminal device 1102 decodes the scalable encoded data (BL) 1121 of the base layer acquired via the terrestrial broadcasting 1111, thereby obtaining or storing the image of the base layer or transmitting the image of the base layer to other devices.

In addition, for example, according to the user's instruction, the terminal device 1102 combines the scalable encoded data (BL) 1121 of the base layer acquired via the terrestrial broadcasting 1111 and the scalable encoded data (EL) 1122 of the enhancement layer acquired via the network 1112, thereby obtaining the scalable encoded data (BL+EL), obtaining or storing the image of the enhancement layer by decoding the scalable encoded data (BL+EL), or transmitting the image of the enhancement layer to other devices.

As described above, the scalable encoded data, for example, can be transmitted via the different communication medium for each layer. Therefore, it is possible to disperse the load and suppress the occurrence of the delay or the overflow.

In addition, according to the situation, the communication medium used for the transmission for each layer may be configured to be selected. For example, the scalable encoded data (BL) 1121 of the base layer in which the amount of data is comparatively large may be transmitted via the communication medium having a wide bandwidth, and the scalable encoded data (EL) 1122 of the enhancement layer in which the amount of data is comparatively small may be transmitted via the communication media having a narrow bandwidth. In addition, for example, whether the communication medium that transmits the scalable encoded data (EL) 1122 of the enhancement layer is the network 1112 or the terrestrial broadcasting 1111 may be switched according to the available bandwidth of the network 1112. Of course, the same is true for data of an arbitrary layer.

By controlling in this way, it is possible to further suppress the increase of the load in the data transmission.

Of course, the number of the layers is optional, and the number of communication media used in the transmission is also optional. In addition, the number of terminal devices 1102 which are the destination of the data distribution is also optional. Further, although the example of the broadcasting from the broadcasting station 1101 has been described above, the use example is not limited thereto. The data transmission system 1100 can be applied to any system which divides the scalable encoded data using a layer as a unit and transmits the scalable encoded data via a plurality of links.

In addition, as the present technology is applied to the data transmission system 1100 described above in the same manner as the application to the hierarchical encoding and hierarchical decoding described above in the first and second embodiments, the same effects as those of the first and second embodiments can be obtained.

<Third System>

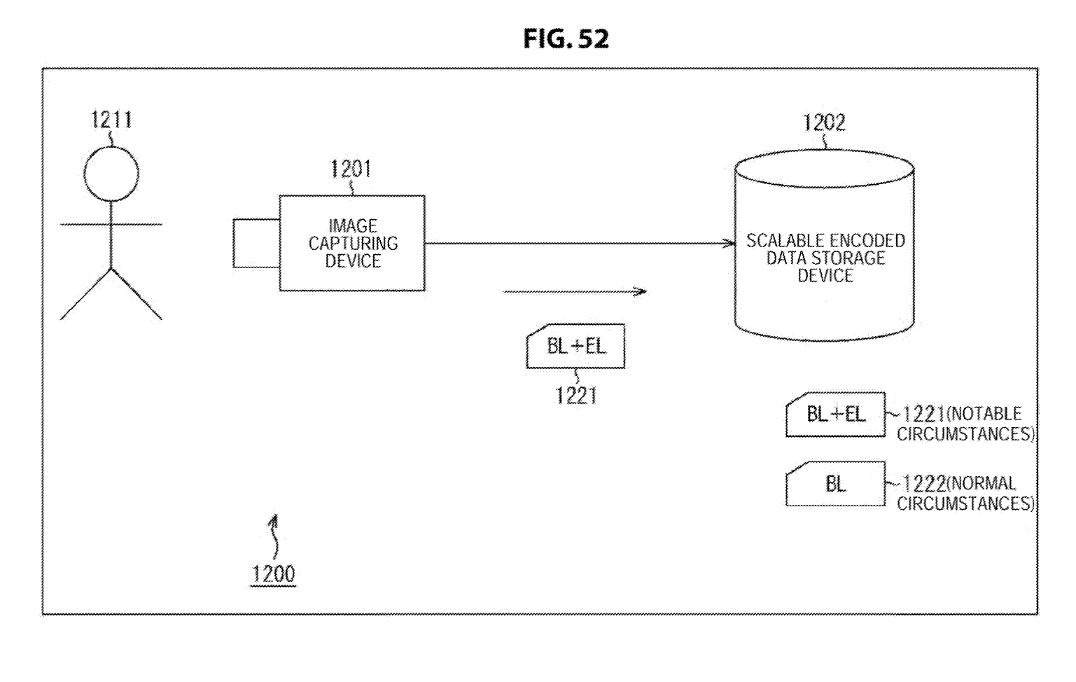

In addition, the scalable video coding is used in the storage of the encoded data as an example illustrated in FIG. 52.

In an image capturing system 1200 illustrated in FIG. 52, an image capturing device 1201 performs scalable video coding on image data obtained by capturing an image of a subject 1211, and supplies a scalable video result as the scalable encoded data (BL+EL) 1221 to a scalable encoded data storage device 1202.

The scalable encoded data storage device 1202 stores the scalable encoded data (BL+EL) 1221 supplied from the image capturing device 1201 in quality according to the situation. For example, in the case of normal circumstances, the scalable encoded data storage device 1202 extracts data of the base layer from the scalable encoded data (BL+EL) 1221, and stores the extracted data as scalable encoded data (BL) 1222 of the base layer having a small amount of data at low quality. On the other hand, for example, in the case of notable circumstances, the scalable encoded data storage device 1202 stores the scalable encoded data (BL+EL) 1221 having a large amount of data at high quality without change.

In this way, because the scalable encoded data storage device 1202 can save the image at high quality only in a necessary case, it is possible to suppress the decrease of the value of the image due to the deterioration of the image quality and suppress the increase of the amount of data, and it is possible to improve the use efficiency of the storage region.

For example, the image capturing device 1201 is assumed to be a motoring camera. Because content of the captured image is unlikely to be important when a monitoring subject (for example, an invader) is not shown in the imaged image (in the case of the normal circumstances), the priority is on the reduction of the amount of data, and the image data (scalable encoded data) is stored at low quality. On the other hand, because the content of the imaged image is likely to be important when a monitoring target is shown as the subject 1211 in the imaged image (in the case of the notable circumstances), the priority is on the image quality, and the image data (scalable encoded data) is stored at high quality.

For example, whether the case is the case of the normal circumstances or the notable circumstances may be determined by the scalable encoded data storage device 1202 by analyzing the image. In addition, the image capturing device 1201 may be configured to make the determination and transmit the determination result to the scalable encoded data storage device 1202.

A determination criterion of whether the case is the case of the normal circumstances or the notable circumstances is optional and the content of the image which is the determination criterion is optional. Of course, a condition other than the content of the image can be designated as the determination criterion. For example, switching may be configured to be performed according to the magnitude or waveform of recorded sound, by a predetermined time interval, or by an external instruction such as the user's instruction.

In addition, although the two states of the normal circumstances and the notable circumstances have been described above, the number of the states is optional, and for example, switching may be configured to be performed among three or more states such as normal circumstances, slightly notable circumstances, notable circumstances, and highly notable circumstances. However, the upper limit number of states to be switched depends upon the number of layers of the scalable encoded data.

In addition, the image capturing device 1201 may determine the number of layers of the scalable video coding according to the state. For example, in the case of the normal circumstances, the image capturing device 1201 may generate the scalable encoded data (BL) 1222 of the base layer having a small amount of data at low quality and supply the data to the scalable encoded data storage device 1202. In addition, for example, in the case of the notable circumstances, the image capturing device 1201 may generate the scalable encoded data (BL+EL) 1221 of the base layer having a large amount of data at high quality and supply the data to the scalable encoded data storage device 1202.

Although the monitoring camera has been described above as the example, the usage of the image capturing system 1200 is optional and is not limited to the monitoring camera.

In addition, as the present technology is applied to the image capturing system 1200 described above in the same manner as the application to the hierarchical encoding and hierarchical decoding described above in the first and second embodiments, the same effects as those of the first and second embodiments can be obtained.

Further, the present technology can also be applied to HTTP streaming such as MPEG-DASH in which appropriate encoded data is selected in units of segments from among a plurality of pieces of encoded data having different solutions that are prepared in advance and used. In other words, a plurality of pieces of encoded data can share information related to encoding or decoding.

Further, in this specification, the example in which various kinds of information are multiplexed into an encoded stream and transmitted from the encoding side to the decoding side has been described. However, a technique of transmitting the information is not limited to this example. For example, the information may be transmitted or recorded as individual data associated with an encoded bitstream without being multiplexed in the encoded stream. Here, the term “associate” refers to that an image included in the bitstream (which may be part of an image such a slice or a block) and information corresponding to the image is configured to be linked at the time of decoding. That is, the information may be transmitted on a separate transmission path from an image (or bitstream). In addition, the information may be recorded on a separate recording medium (or a separate recording area of the same recording medium) from the image (or bitstream). Further, the information and the image (or the bitstream), for example, may be associated with each other in an arbitrary unit such as a plurality of frames, one frame, or a portion within the frame.

The preferred embodiments of the present disclosure have been described above with reference to the accompanying drawings, whilst the present invention is not limited to the above examples, of course. A person skilled in the art may find various alterations and modifications within the scope of the appended claims, and it should be understood that they will naturally come under the technical scope of the present disclosure.

Additionally, the present technology may also be configured as below.

(1)

An image processing device including:

a receiving section configured to receive hierarchical image encoded data in which image data that is hierarchized into a plurality of layers is encoded and motion information encoded data in which motion information used in encoding of the image data is encoded;

a motion information decoding section configured to decode, when motion information of a peripheral block in a same layer as a current block is unavailable, the motion information encoded data received by the receiving section using motion information of a peripheral block in a different layer from the current block; and

a decoding section configured to decode the hierarchical image encoded data received by the receiving section using motion information obtained by the motion information decoding section decoding the motion information encoded data.

(2)

The image processing device according to any one of (1) and (3) to (9),

wherein, when the motion information of the peripheral block in the same layer as the current block is available, the motion information decoding section reconstructs predictive motion information used in encoding of the motion information used in encoding of the image data using the motion information of the peripheral block, and decodes the motion information encoded data using the reconstructed predictive motion information, and

wherein, when the motion information of the peripheral block in the same layer as the current block is unavailable, the motion information decoding section reconstructs predictive motion information used in encoding of the motion information used in encoding of the image data using the motion information of the peripheral block in the different layer from the current block, and decodes the motion information encoded data using the reconstructed predictive motion information.

(3)

The image processing device according to any one of (1), (2), and (4) to (9), wherein the motion information decoding section sets available motion information of a peripheral block corresponding to the peripheral block in the different layer from the current block as a candidate for the predictive motion information, instead of the unavailable motion information of the peripheral block in the same layer as the current block in an advanced motion vector prediction (AMVP) mode.

(4)

The image processing device according to any one of (1) to (3) and (5) to (9),

wherein the motion information decoding section sets available motion information, which is subject to a scaling process in a time axis direction, of the peripheral block corresponding to the peripheral block in the different layer from the current block as a candidate for the predictive motion information, instead of unavailable motion information, which is subject to the scaling process in the time axis direction, of the peripheral block in the same layer as the current block, and

wherein the motion information decoding section sets available motion information, which is not subject to the scaling process in the time axis direction, of the peripheral block corresponding to the peripheral block in the different layer from the current block as a candidate for the predictive motion information, instead of unavailable motion information, which is not subject to the scaling process in the time axis direction, of the peripheral block in the same layer as the current block.

(5)

The image processing device according to any one of (1) to (4) and (6) to (9), wherein the motion information decoding section performs a scaling process on the motion information of the peripheral block in the different layer from the current block in a space direction according to a resolution ratio between the layers.

(6)

The image processing device according to any one of (1) to (5) and (7) to (9), wherein the motion information decoding section fills a missing number in a candidate list of the predictive motion information with available motion information of a peripheral block corresponding to the peripheral block in the different layer from the current block in a merge mode.

(7)

The image processing device according to any one of (1) to (6), (8), and (9), wherein the receiving section further receives control information for designating whether motion information of a block in the same layer as the current block is to be used in the candidate list and whether motion information of a block in the different layer from the current block is to be used in the candidate list.

(8)

The image processing device according to any one of (1) to (7) and (9),

wherein, when the motion information of the block in the same layer as the current block is used in the candidate list, the motion information decoding section uses the motion information of the block in the different layer from the current block to fill the missing number in the candidate list, based on the control information received by the receiving section, and

wherein, when the motion information of the block in the different layer from the current block is used in the candidate list, the motion information decoding section uses the motion information of the block in the same layer as the current block to fill the missing number in the candidate list, based on the control information received by the receiving section.

(9)

The image processing device according to any one of (1) to (8), wherein the motion information decoding section fills the missing number in the candidate list with motion information of a block different from the peripheral block set as a co-located block in the different layer from the current block.

(10)

An image processing method including:

receiving hierarchical image encoded data in which image data that is hierarchized into a plurality of layers is encoded and motion information encoded data in which motion information used in encoding of the image data is encoded;

decoding, when motion information of a peripheral block in a same layer as a current block is unavailable, the received motion information encoded data using motion information of a peripheral block in a different layer from the current block; and

decoding the received hierarchical image encoded data using motion information obtained by decoding the motion information encoded data.

(11)

An image processing device including:

an encoding section configured to encode image data that is hierarchized into a plurality of layers using motion information;

a motion information encoding section configured to encode, when motion information of a peripheral block in a same layer as a current block is unavailable, the motion information used by the encoding section in encoding of the image data using motion information of a peripheral block in a different layer from the current block; and

a transmitting section configured to transmit hierarchical image encoded data obtained by the encoding section encoding the image data and motion information encoded data obtained by the motion information encoding section encoding the motion information.

(12)

The image processing device according to any one of (11) and (13) to (19),

wherein, when the motion information of the peripheral block in the same layer as the current block is available, the motion information encoding section generates predictive motion information using the motion information of the peripheral block and encodes the motion information using the generated predictive motion information, and

wherein, when the motion information of the peripheral block in the same layer as the current block is unavailable, the motion information encoding section generates predictive motion information using the motion information of the peripheral block in the different layer from the current block and encodes the motion information using the generated predictive motion information.

(13)

The image processing device according to any one of (11), (12), and (14) to (19), wherein the motion information encoding section sets available motion information of a peripheral block corresponding to the peripheral block in the different layer from the current block as a candidate for the predictive motion information, instead of the unavailable motion information of the peripheral block in the same layer as the current block in an advanced motion vector prediction (AMVP) mode.

(14)

The image processing device according to any one of (11) to (13) and (15) to (19),

wherein the motion information encoding section sets available motion information, which is subject to a scaling process in a time axis direction, of the peripheral block corresponding to the peripheral block in the different layer from the current block as a candidate for the predictive motion information, instead of unavailable motion information, which is subject to the scaling process in the time axis direction, of the peripheral block in the same layer as the current block, and

wherein the motion information encoding section sets available motion information, which is not subject to the scaling process in the time axis direction, of the peripheral block corresponding to the peripheral block in the different layer from the current block as a candidate for the predictive motion information, instead of unavailable motion information, which is not subject to the scaling process in the time axis direction, of the peripheral block in the same layer as the current block.

(15)

The image processing device according to any one of (11) to (14) and (16) to (19), wherein the motion information encoding section performs a scaling process on the motion information of the peripheral block in the different layer from the current block in a space direction according to a resolution ratio between the layers.

(16)

The image processing device according to any one of (11) to (15) and (17) to (19), wherein the motion information encoding section fills a missing number in a candidate list of the predictive motion information with available motion information of a peripheral block corresponding to the peripheral block in the different layer from the current block in a merge mode.

(17)

The image processing device according to any one of (11) to (16), (18), and (19), wherein the transmitting section further transmits control information for designating whether motion information of a block in the same layer as the current block is to be used in the candidate list and whether motion information of a block in the different layer from the current block is to be used in the candidate list.

(18)

The image processing device according to any one of (11) to (17) and (19),

wherein, when the motion information of the block in the same layer as the current block is used in the candidate list, the motion information encoding section uses the motion information of the block in the different layer from the current block to fill the missing number in the candidate list, and

wherein, when the motion information of the block in the different layer from the current block is used in the candidate list, the motion information encoding section uses the motion information of the block in the same layer as the current block to fill the missing number in the candidate list.

(19)

The image processing device according to any one of (11) to (18), wherein the motion information encoding section fills the missing number in the candidate list with motion information of a block different from the peripheral block set as a co-located block in the different layer from the current block.

(20)

An image processing method including:

encoding image data that is hierarchized into a plurality of layers using motion information;

encoding, when motion information of a peripheral block in a same layer as a current block is unavailable, the motion information used in encoding of the image data using motion information of a peripheral block in a different layer from the current block; and

transmitting hierarchical image encoded data obtained by encoding the image data and motion information encoded data obtained by encoding the motion information.

### REFERENCE SIGNS LIST

100 scalable encoding device
101 common information generation section
102 encoding control section
103 base layer image encoding section
104 motion information encoding section
105 enhancement layer image encoding section
116 lossless encoding section
125 motion prediction/compensation section
135 motion prediction/compensation section
151 motion information scaling section
152 base layer motion information buffer
153 enhancement layer motion information buffer
154 AMVP processing section
155 merge processing section
156 optimal predictor setting section
161 candidate setting section
162 availability determination section
163 spatial scaling section
164 temporal scaling section
165 base layer motion information selecting section
171 candidate list generation section
172 layer control information setting section
173 layer control section
174 availability determination section
175 base layer information selecting section
200 scalable decoding device
201 common information acquisition section
202 decoding control section
203 base layer image decoding section
204 motion information decoding section
205 enhancement layer image decoding section
212 lossless decoding section
222 motion compensation section
232 motion compensation section
251 motion information scaling section
252 base layer motion information buffer
253 enhancement layer motion information buffer
254 AMVP processing section
255 merge processing section
256 predictor decoding section
261 candidate setting section
262 availability determination section
263 spatial scaling section
264 temporal scaling section
265 base layer motion information selecting section
271 candidate list generation section
272 layer control information acquisition section
273 layer control section
274 availability determination section
275 base layer motion information selecting section

1. An image processing device comprising:
a receiving section configured to receive hierarchical image encoded data in which image data that is hierarchized into a plurality of layers is encoded and motion information encoded data in which motion information used in encoding of the image data is encoded;
a motion information decoding section configured to decode, when motion information of a peripheral block in a same layer as a current block is unavailable, the motion information encoded data received by the receiving section using motion information of a peripheral block in a different layer from the current block; and
a decoding section configured to decode the hierarchical image encoded data received by the receiving section using motion information obtained by the motion information decoding section decoding the motion information encoded data.

2. The image processing device according to claim 1,
wherein, when the motion information of the peripheral block in the same layer as the current block is available, the motion information decoding section reconstructs predictive motion information used in encoding of the motion information used in encoding of the image data using the motion information of the peripheral block, and decodes the motion information encoded data using the reconstructed predictive motion information, and
wherein, when the motion information of the peripheral block in the same layer as the current block is unavailable, the motion information decoding section reconstructs predictive motion information used in encoding of the motion information used in encoding of the image data using the motion information of the peripheral block in the different layer from the current block, and decodes the motion information encoded data using the reconstructed predictive motion information.

3. The image processing device according to claim 2, wherein the motion information decoding section sets available motion information of a peripheral block corresponding to the peripheral block in the different layer from the current block as a candidate for the predictive motion information, instead of the unavailable motion information of the peripheral block in the same layer as the current block in an advanced motion vector prediction (AMVP) mode.

4. The image processing device according to claim 3,
wherein the motion information decoding section sets available motion information, which is subject to a scaling process in a time axis direction, of the peripheral block corresponding to the peripheral block in the different layer from the current block as a candidate for the predictive motion information, instead of unavailable motion information, which is subject to the scaling process in the time axis direction, of the peripheral block in the same layer as the current block, and
wherein the motion information decoding section sets available motion information, which is not subject to the scaling process in the time axis direction, of the peripheral block corresponding to the peripheral block in the different layer from the current block as a candidate for the predictive motion information, instead of unavailable motion information, which is not subject to the scaling process in the time axis direction, of the peripheral block in the same layer as the current block.

5. The image processing device according to claim 2, wherein the motion information decoding section performs a scaling process on the motion information of the peripheral block in the different layer from the current block in a space direction according to a resolution ratio between the layers.

6. The image processing device according to claim 2, wherein the motion information decoding section fills a missing number in a candidate list of the predictive motion information with available motion information of a peripheral block corresponding to the peripheral block in the different layer from the current block in a merge mode.

7. The image processing device according to claim 6, wherein the receiving section further receives control information for designating whether motion information of a block in the same layer as the current block is to be used in the candidate list and whether motion information of a block in the different layer from the current block is to be used in the candidate list.

8. The image processing device according to claim 7,
wherein, when the motion information of the block in the same layer as the current block is used in the candidate list, the motion information decoding section uses the motion information of the block in the different layer from the current block to fill the missing number in the candidate list, based on the control information received by the receiving section, and
wherein, when the motion information of the block in the different layer from the current block is used in the candidate list, the motion information decoding section uses the motion information of the block in the same layer as the current block to fill the missing number in the candidate list, based on the control information received by the receiving section.

9. The image processing device according to claim 6, wherein the motion information decoding section fills the missing number in the candidate list with motion information of a block different from the peripheral block set as a co-located block in the different layer from the current block.

10. An image processing method comprising:
receiving hierarchical image encoded data in which image data that is hierarchized into a plurality of layers is encoded and motion information encoded data in which motion information used in encoding of the image data is encoded;
decoding, when motion information of a peripheral block in a same layer as a current block is unavailable, the received motion information encoded data using motion information of a peripheral block in a different layer from the current block; and
decoding the received hierarchical image encoded data using motion information obtained by decoding the motion information encoded data.

11. An image processing device comprising:
an encoding section configured to encode image data that is hierarchized into a plurality of layers using motion information;
a motion information encoding section configured to encode, when motion information of a peripheral block in a same layer as a current block is unavailable, the motion information used by the encoding section in encoding of the image data using motion information of a peripheral block in a different layer from the current block; and
a transmitting section configured to transmit hierarchical image encoded data obtained by the encoding section encoding the image data and motion information encoded data obtained by the motion information encoding section encoding the motion information.

12. The image processing device according to claim 11,
wherein, when the motion information of the peripheral block in the same layer as the current block is available, the motion information encoding section generates predictive motion information using the motion information of the peripheral block and encodes the motion information using the generated predictive motion information, and
wherein, when the motion information of the peripheral block in the same layer as the current block is unavailable, the motion information encoding section generates predictive motion information using the motion information of the peripheral block in the different layer from the current block and encodes the motion information using the generated predictive motion information.

13. The image processing device according to claim 12, wherein the motion information encoding section sets available motion information of a peripheral block corresponding to the peripheral block in the different layer from the current block as a candidate for the predictive motion information, instead of the unavailable motion information of the peripheral block in the same layer as the current block in an advanced motion vector prediction (AMVP) mode.

14. The image processing device according to claim 13,
wherein the motion information encoding section sets available motion information, which is subject to a scaling process in a time axis direction, of the peripheral block corresponding to the peripheral block in the different layer from the current block as a candidate for the predictive motion information, instead of unavailable motion information, which is subject to the scaling process in the time axis direction, of the peripheral block in the same layer as the current block, and
wherein the motion information encoding section sets available motion information, which is not subject to the scaling process in the time axis direction, of the peripheral block corresponding to the peripheral block in the different layer from the current block as a candidate for the predictive motion information, instead of unavailable motion information, which is not subject to the scaling process in the time axis direction, of the peripheral block in the same layer as the current block.

15. The image processing device according to claim 12, wherein the motion information encoding section performs a scaling process on the motion information of the peripheral block in the different layer from the current block in a space direction according to a resolution ratio between the layers.

16. The image processing device according to claim 12, wherein the motion information encoding section fills a missing number in a candidate list of the predictive motion information with available motion information of a peripheral block corresponding to the peripheral block in the different layer from the current block in a merge mode.

17. The image processing device according to claim 16, wherein the transmitting section further transmits control information for designating whether motion information of a block in the same layer as the current block is to be used in the candidate list and whether motion information of a block in the different layer from the current block is to be used in the candidate list.

18. The image processing device according to claim 17,
wherein, when the motion information of the block in the same layer as the current block is used in the candidate list, the motion information encoding section uses the motion information of the block in the different layer from the current block to fill the missing number in the candidate list, and
wherein, when the motion information of the block in the different layer from the current block is used in the candidate list, the motion information encoding section uses the motion information of the block in the same layer as the current block to fill the missing number in the candidate list.

19. The image processing device according to claim 16, wherein the motion information encoding section fills the missing number in the candidate list with motion information of a block different from the peripheral block set as a co-located block in the different layer from the current block.

20. An image processing method comprising:
encoding image data that is hierarchized into a plurality of layers using motion information;
encoding, when motion information of a peripheral block in a same layer as a current block is unavailable, the motion information used in encoding of the image data using motion information of a peripheral block in a different layer from the current block; and
transmitting hierarchical image encoded data obtained by encoding the image data and motion information encoded data obtained by encoding the motion information.
